(19) United States
(12) Patent Application Publication
(10) Pub. No.: US 2021/0171883 A1
(43) Pub. Date: Jun. 10, 2021

(54) ANTIVIRAL WIPER

(71) Applicant: FUJIFILM Corporation, Tokyo (JP)

(72) Inventor: Miyoko HARA, Kanagawa (JP)

(73) Assignee: FUJIFILM Corporation, Tokyo (JP)

(21) Appl. No.: 17/178,348

(22) Filed: Feb. 18, 2021

Related U.S. Application Data
(63) Continuation of application No. PCT/JP2019/033617, filed on Aug. 28, 2019.

(30) Foreign Application Priority Data
Aug. 29, 2018 (JP) 2018-160225

(51) Int. Cl. C11D 17/04; A01N 31/02; A01N 25/34; C11D 3/48; C11D 3/37; C11D 3/20; A47L 13/17; D04H 1/425; D04H 1/4291; D04H 1/435

(52) U.S. Cl. CPC C11D 17/049; A01N 31/02; A01N 25/34; C11D 3/48; C11D 3/3719; C11D 3/3715; D10B 2509/026; C11D 3/2017; A47L 13/17; D04H 1/425; D04H 1/4291; D04H 1/435; C11D 3/3749

(57) ABSTRACT

An object of the present invention is to provide an antiviral wiper having excellent antiviral activity and excellent storage stability.

The antiviral wiper according to an embodiment of the present invention is an antiviral wiper having a base fabric and a liquid agent with which the base fabric is impregnated.

The content of a cellulosic fiber in the base fabric is equal to or lower than 70% by mass with respect to the total mass of fibers constituting the base fabric.

The liquid agent is alkaline and contains a compound X having a pKa of 7.0 to 15.0 and a solvent containing at least an alcohol, and the content of the alcohol is 40% to 100% by mass with respect to the total mass of the solvent.

### CROSS-REFERENCE TO RELATED APPLICATIONS

This application is a Continuation of PCT International Application No. PCT/JP2019/033617 filed on Aug. 28, 2019, which claims priority under 35 U.S.C. § 119(a) to Japanese Patent Application No. 2018-160225 filed on Aug. 29, 2018. The above application is hereby expressly incorporated by reference, in its entirety, into the present application.

### BACKGROUND OF THE INVENTION

### 1. Field of the Invention

The present invention relates to an antiviral wiper.

### 2. Description of the Related Art

Norovirus is a virus classified into the genus Norovirus belonging to the family Caliciviridae, and is known as a pathogen that causes food poisoning and the like. Recently, for preventing norovirus infection, the development of a wiper obtained by impregnating a base fabric such as a non-woven fabric with a liquid agent having anti-norovirus activity has been required.

For example, JP2013-047196A describes a norovirucidal liquid agent containing proanthocyanidin (compound having a phenolic hydroxyl group).

### SUMMARY OF THE INVENTION

The inventors of the present invention prepared an antiviral liquid agent containing a compound having a phenolic hydroxyl group with reference to JP2013-047196A, prepared a wiper by impregnating a base fabric (for example, a non-woven fabric) with the liquid agent, and examined the wiper. As a result, the inventors have found that sometimes the antiviral activity of the wiper deteriorates after long-term storage depending on the material of the base fabric. In other words, it has been revealed that the storage stability of the antiviral wiper needs to be further improved.

Furthermore, there is also a constant demand for further improvement of the antiviral activity of the antiviral wiper.

An object of the present invention is to provide an antiviral wiper having excellent antiviral activity and excellent storage stability.

In order to achieve the object, the inventors of the present invention conducted intensive studies. As a result, they have found that the object can be achieved by adjusting the content of a cellulosic fiber in the base fabric, and have accomplished the present invention.

That is, it has been found that the above object can be achieved by the following constitution.

[1] An antiviral wiper comprising a base fabric and a liquid agent with which the base fabric is impregnated,

in which a content of a cellulosic fiber in the base fabric is equal to or lower than 70% by mass with respect to a total mass of fibers constituting the base fabric,

the liquid agent is alkaline and contains a compound X having a pKa of 7.0 to 15.0 and a solvent containing at least an alcohol, and a content of the alcohol is 40% to 100% by mass with respect to a total mass of the solvent.

[2] The antiviral wiper described in [1], in which the compound X is a compound having a phenolic hydroxyl group.

[3] The antiviral wiper described in [1] or [2], in which the content of the cellulosic fiber is equal to or lower than 30% by mass with respect to the total mass of the fibers.

[4] The antiviral wiper described in any one of [1] to [3], in which the base fabric substantially does not contain the cellulosic fiber.

[5] The antiviral wiper described in any one of [1] to [4], in which the base fabric contains one or more kinds of synthetic fibers selected from the group consisting of a polyolefin fiber, a polyester fiber, a vinylon fiber, and a nylon fiber.

[6] The antiviral wiper described in any one of [1] to [5], in which the fibers constituting the base fabric are synthetic fibers selected from the group consisting of a polyolefin fiber, a polyester fiber, and a vinylon fiber.

[7] The antiviral wiper described in any one of [1] to [6], in which the fibers constituting the base fabric are synthetic fibers selected from the group consisting of a polyolefin fiber and a polyester fiber.

[8] The antiviral wiper described in any one of [5] to [7], in which a content of the synthetic fibers is equal to or higher than 95% by mass with respect to the total mass of the fibers.

[9] The antiviral wiper described in any one of [1] to [8], in which the alcohol includes an alcohol having 2 or less carbon atoms and an alcohol having 3 or more carbon atoms.

[10] The antiviral wiper described in [9], in which the alcohol having 2 or les carbon atoms includes ethanol, and the alcohol having 3 or more carbon atoms includes isopropanol.

[11] The antiviral wiper described in any one of [1] to [10], in which the liquid agent further contains a surfactant.

[12] The antiviral wiper described in any one of ([1] to [11], in which the liquid agent further contains a chelating agent.

According to an aspect of the present invention, it is possible to provide an antiviral wiper having excellent antiviral activity and excellent storage stability.

### DESCRIPTION OF THE PREFERRED EMBODIMENTS

Hereinafter, the present invention will be specifically described.

The following constituents will be described based on typical embodiments of the present invention in some cases, but the present invention is not limited to the embodiments.

In the present specification, the rage of numerical values described using “to” means a range including the numerical values listed before and after “to” as the lower limit and the upper limit.

In the present specification, in a case where a plurality of substituents, linking groups, and the like (hereinafter, also called substituents and the like) are represented by a specific reference or in a case where a plurality of substituents and the like is collectively specified, the substituents and the like may be the same as or different from each other respectively. The same is true of a case where the number of substituents and the like is specified.

Furthermore, in the present specification, in a case where there is no description regarding whether a group (atomic group) is substituted or unsubstituted, the group includes a group having no substituent and a group having a substituent. For example, “alkyl group” includes not only an alkyl group having no substituent (unsubstituted alkyl group) but also an alkyl group having a substituent (substituted alkyl group).

[Antiviral Wiper]

The antiviral wiper according to an embodiment of the present invention (hereinafter, also called “wiper”) is an antiviral wiper having a base fabric and a liquid agent with which the base fabric is impregnated.

The content of a cellulosic fiber in the base fabric is equal to or lower than 70% by mass with respect to the total mass of fibers constituting the base fabric.

The liquid agent is alkaline and contains a compound X having a pKa of 7.0 to 15.0 and a solvent containing at least an alcohol, and the content of the alcohol is 40% to 100% by mass with respect to the total mass of the solvent.

Due to the presence of the compound X having a pKa of 7.0 to 15.0, the wiper has remarkably excellent antiviral activity (particularly, antiviral activity against feline calicivirus (norovirus-related species)). In addition, the antiviral activity of the wiper hardly deteriorates even after long-term storage (in other words, the wiper has excellent storage stability).

Furthermore, it has been confirmed that the wiper has excellent antimicrobial activity against other viruses and microorganisms such as bacteria and fungi (for example, adenoviruses, influenza viruses, herpes viruses, Trichophyton, Candida Albicans, Aspergillus, Escherichia coli, Staphylococcus, and the like).

Details of the mechanism of action of the present invention are unclear, but are assumed to be as below by the inventors of the present invention.

In the above liquid agent, the compound X having a pKa of 7.0 to 15.0 functions as an active component (antiviral component). Presumably, in a case where the liquid agent is alkaline, anions formed by the dissociation of hydrogen ions from the compound X (hereinafter, also called “compound X-derived anions”; for example, in a case where the compound X is a compound having a phenolic hydroxyl group, phenoxide anions can be generated by the dissociation of hydrogen ions) may cause the deprotonation of acid groups present on the surface of viruses, and hence the viruses may be inactivated. In addition, the inventors of the present invention consider that a predetermined amount of alcohol contained in the solvent may be one of the factors enabling the liquid agent to have excellent antiviral activity (and enabling the wiper to have excellent antiviral activity).

Furthermore, by the inventors of the present invention, it has been revealed that the antiviral activity of a wiper formed using a base fabric containing a large amount of cellulosic fiber seriously deteriorates after long-term storage. The reason is assumed to be as below. The hydroxyl groups in the cellulosic fiber may interact with each other by forming hydrogen bonds and adsorb the compound X-derived anions. Furthermore, a pH adjuster (for example, a base such as sodium hydroxide) that can be contained in the liquid agent may be substituted with hydrogen atoms in the hydroxyl groups in the cellulosic fiber, and hence the pH of the liquid agent may change. Consequently, the amount of compound X-derived anions generated in the liquid agent may be relatively reduced.

Regarding this problem, by the inventors of the present invention, it has been revealed that in a case where the content of the cellulosic fiber in the base fabric is equal to or lower than 70% by mass with respect to the total mass of fibers, the deterioration of antiviral activity can be inhibited even after the long-term storage.

Hereinafter, first, the formulation of the liquid agent contained in the wiper will be described.

[Liquid Agent]

<Compound X>

The liquid agent contains a compound X.

The compound X is a compound which has a pKa of 7.0 to 15.0 and is in an anionic state under alkaline conditions by the dissociation of hydrogen ions. In a case where the compound X has a plurality of pKa values (that is, in a case where the compound X is an acid that undergoes multi-stage dissociation), at least one of the plurality of pKa values may be 7.0 to 15.0.

The pKa of the compound X is preferably 7.0 to 12.0.

Examples of the compound X include compounds having a phenolic hydroxyl group, a mercapto group, or an amine group as a functional group. Among these, a compound having a phenolic hydroxyl group is preferable because this compound is stable in an anionic state and is a safe material.

In a case where the compound X is a compound having a phenolic hydroxyl group, a mercapto group, or an amine group as a functional group, it is preferable that the pKa of the phenolic hydroxyl group, the mercapto group, or the amine group is 7.0 to 15.0.

In a case where the compound X is a compound having a phenolic hydroxyl group, a mercapto group, or an amine group as a functional group, the number of the above functional groups in the compound X is not particularly limited and may be 1 or equal to or greater than 2.

“pKa value” in the present specification is “pKa value” calculated using software (Chem Bio Draw Ultra ver. 12.0. (CambridgeSoft Corporation, USA)).

The content of the compound X (particularly, the compound having a phenolic hydroxyl group) in the above liquid agent is not particularly limited. In view of further improving the antiviral activity of the wiper, the content of the compound X with respect to the total mass of the liquid agent is preferably equal to or higher than 0.05% by mass, more preferably equal to or higher than 0.1% by mass, and even more preferably equal to or higher than 0.2% by mass. The upper limit thereof is not particularly limited, but is preferably equal to or lower than 5.0% by mass, more preferably equal to or lower than 1.0% by mass, and even more referably equal to or lower than 0.5% by mass.

One kind of compound X (particularly, the compound having a phenolic hydroxyl group) may be used singly, or two or more kinds of compounds X may be used in combination. In a case where two or more kinds of compounds X (particularly, the compounds having phenolic hydroxyl groups) are used in combination, the total content thereof is preferably within the above range.

Hereinafter, specific examples of the compound X will be described in detail.

<<Compound Having Phenolic Hydroxyl Group>>

The compound having a phenolic hydroxyl group may have one phenolic hydroxyl group or two or more phenolic hydroxyl groups in one molecule.

In the present specification, the phenolic hydroxyl group represents a hydroxyl group substituting a hydrogen atom of an aromatic ring. The phenolic hydroxyl group is preferably a hydroxyl group substituting a hydrogen atom of a benzene ring.

In the present specification, among the compounds having a phenolic hydroxyl group, a compound having one hydroxyl group substituting a hydrogen atom of an aromatic ring is called “monophenol compound”, and a compound having two or more hydroxyl groups substituting hydrogen atoms of an aromatic ring is called “polyphenol compound”. Examples of the monophenol compound include a compound E which will be described later, a compound represented by Formula (1H), and a compound represented by a compound (2Ai). In addition, examples of the polyphenol compound include compounds A to D, a compound F, and a compound G which will be described later.

Examples of the forms of the compound having a phenolic hydroxyl group include the following compounds A to D.

(Compound A)

The compound A is a compound having two or more residues (hereinafter, also called “residues of Formula (1A)”) each of which remains after one or more hydrogen atoms excluding a hydrogen atom in a hydroxyl group are removed from a compound represented by Formula (1A).

In the compound A, the plurality of residues of Formula (1A) may be bonded to each other directly or through a linking group.

The two or more residues of Formula (1A) that the compound A has may be the same or different from each other.

The molecular weight of the compound A is not particularly limited, but is preferably 218 to 2,000 and more preferably 218 to 1,500.

The number of residues of Formula (1A) that the compound A has is preferably 2 to 10, and more preferably 1 to 6.

The compound A may be a polymer.

It is preferable that the compound A as a polymer has a repeating unit having the residues of Formula (1A).

The weight-average molecular weight of the compound A as a polymer is, for example, preferably 1,000 to 1,000,000, and more preferably 5,000 to 1,000,000.

In the present specification, in a case where a specific compound is a polymer, the weight-average molecular weight (Mw) thereof is defined as a value expressed in terms of polystyrene by Gel Permeation Chromatography (GPC).

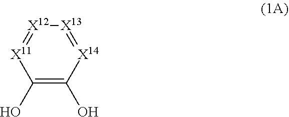

In Formula (1A), X¹¹ to X¹⁴ each independently represent a nitrogen atom or —CR¹¹═, R¹¹ represents a hydrogen atom or a substituent.

It is preferable that X¹¹ to X¹⁴ represent —CR¹¹═.

At least one of X¹¹, X¹², X¹³, or X¹⁴ preferably represents —CR¹¹═ in which R¹¹ is a hydrogen atom or a group having a hydrogen atom.

In a case where the compound has a plurality of structures represented by —CR¹¹═, the plurality of R¹¹'s may be the same or different from each other.

Examples of the substituent represented by R¹¹ include a hydroxyl group, an alkyl group, an aryl group, a heterocyclic group (such as a non-aromatic heterocycle and an aromatic heterocycle, the heteroatom is preferably a nitrogen atom, a sulfur atom, or an oxygen atom, specifically, a pyrylium ring, a benzopyrylium ring, a chromanone ring, and the like), a halogen atom (such as a fluorine atom, a chlorine atom, a bromine atom, and an iodine atom), a nitro group, a sulfo group, a phosphoric acid group, a cyano group, an amino group, an alkali metal oxy group (such as a sodium oxy group and a potassium oxy group), a sulfonate group (such as a sodium sulfonate group), a sugar group, a group having a vinylene group (*—C═C—*), a group having an ethynylene group (*—C≡C—*), a group having an ether group (*—O—*) a group having an imino group (*—C(═N—*)—*), a group having an ester group (*—CO—O—* and *—O—CO—*), a group having carbonyl group (*—CO—*), a group having a phosphine oxide group (*—P(═O)(—*)₂), a group having a phosphonic acid ester group (*—P(═O)(—O—*)₂), a group having a phosphoric acid ester group (*—OP(═O)(—O—*)₂), a group having a sulfinyl group (*—S(═O)—*), a group having a sulfonyl group (*—S(═O)₂—*), a group having an amide group (*—CO—NH—* and *—NH—CO—*), a group having a sulfonamide group (*—SO₂—NH—* and *—NH—SO₂—*), a group having an azo group (*—N═N—*), a group having a trialkoxysilyl group (*—Si(OR^{S1}₃)), a group having an ammonium group (*—N*(—*)₃), a group having a sulfonium group (*—S⁺(—*)₂), a group having a phosphonium group (*—P⁺(—*), a group having an oxonium group (*—O⁺(—*)₂), a group having a carbonium group (*—C⁺(—*)₂), a group having a halonium group (*—X⁺—*; X is a halogen atom), and a group obtained by combining these.

* in the above groups represents a binding position.

In the above examples, R^{S1} represents an alkyl group. In a case where one group has a plurality of R^{S1}'s, the plurality of R^{S1}'s may be the same or different from each other.

Furthermore, in a case where the above substituent can have a substituent, it may further have a substituent.

The alkyl group may be linear or branched or may have a cyclic structure. The number of carbon atoms in the alkyl group is preferably 1 to 20.

The number of carbon atoms in the aryl group is preferably 6 to 15, and more preferably 6.

R¹¹ is, for example, preferably a hydrogen atom or a substituent having a Hammett substituent constant σₚ higher than 0.

Regarding the Hammett substituent constant σₚ, Chem. Rev. 1991, 91, p 165-195 can be referred to.

For example, just as —CH═CH—CO—O—CH₂CH₃ (σₚ=0.03), it is preferable that the substituent having a Hammett substituent constant σₚ higher than 0 is bonded to another substituent having a Hammett substituent constant σₚ higher than 0 through a conjugate group such as a vinylene group, an ethynylene group, an imino group, an azo group, an aryl group, or a heteroaryl group.

Particularly, R¹¹ is preferably a hydrogen atom or any of the substituents belonging to a substituent T group consisting of an allyloxy group, an aryl azo group, a heteroaryl azo group, a halogen atom, a nitro group, a sulfo group, an alkanesulfonyl group, an arylsulfonyl group, an alkanesulfonyloxy group, an arylsulfonyloxy group, a cyano group, an alkynyl group, a perfluoroalkyloxy group, a perfluoroalkyl group, —CO—R^{T1}, —CO—O—R^{T1}, —O—CO—R^{T1}, —NH—CO—R^{T1}, —CO—NH—R^{T1}, —SO₂—NH—R^{T1}, —NH—SO₂—R^{T1}, —C(═NR^{T1})R^{T2}, —CH═CH—R^{T1}, and —P(═O)R^{T1}R^{T2}.

In the substituent T group, R^{T1} and R^{T2} each independently represent a hydrogen atom or a substituent (for example, a group having an alkyl group (the alkyl group may be linear or branched or may have a cyclic structure, and the number of carbon atoms in the alkyl group is preferably 1 to 20)) or an ester group (for example, an alkyl group which may have -ester group-substituent, as the substituent of the alkyl group, either or both of a hydroxyl group and a carboxyl group are preferable), and the like).

R^{T1} and R^{T2} may be bonded to each other to form a ring.

It is preferable that the compound represented by Formula (1A) has at least one structure represented by —CR¹¹═ in which R¹¹ is any of the substituents belonging to the substituent T group.

Furthermore, the compound A preferably has at least one residue of Formula (1A) having R¹¹ which is any of the substituents belonging to the substituent T group, and more preferably has two or more such residues. All the residues of Formula (1A) in the compound A are even more preferably residues of the compound represented by Formula (1A) having R¹¹ which is any of the substituents belonging to the substituent T group.

In a case where there is a plurality of X¹¹ to X¹⁴, which each represent —CR¹¹═, in Formula (1A), the plurality of R¹¹'s may be the same as or different from each other. Furthermore, the plurality of R¹¹'s (for example, R¹¹'s adjacent to each other in a case where X¹¹ and X¹² represent —CR¹¹═, R¹¹'s adjacent to each other in a case where X¹² and X¹³ represent —CR¹¹═, and R¹¹'s adjacent to each other in a case where X¹³ and X¹⁴ represent —CR¹¹═) may be bonded to each other to form a ring.

The ring formed by the bonding of a plurality of R¹¹'s may be an aromatic ring (for example, an aromatic hydrocarbon ring and an aromatic heterocycle) or a non-aromatic ring (for example, a non-aromatic hydrocarbon ring and a non-aromatic heterocycle).

Furthermore, another ring may be fused with the formed ring so that a fused ring structure is formed.

The formed ring is preferably a 5- or 6-membered monocyclic ring or a polycyclic ring as a combination of the monocyclic rings. In a case where each ring is a heterocycle, the number of heteroatoms is preferably 1 to 5.

Examples of the heteroatom of the heterocycle include a nitrogen atom, a sulfur atom, an oxygen atom, a selenium atom, a tellurium atom, a phosphorus atom, a silicon atom, and a boron atom. Among these, a nitrogen atom, a sulfur atom, or an oxygen atom is preferable.

Examples of the formed ring include a benzene ring, a naphthalene ring, a chromane ring, a quinoline ring, a quinoxaline ring, an anthraquinone ring, a 3-cyclobutene-1,2-dione ring, a dihydrofuran ring, a crotonolactone ring, a 4-cyclopentene-1,2,3-trione ring, a 2,4,6-cycloheptatrien−1-one ring, and a benzoquinone ring.

These rings may further have substituents (such as an alkyl group, a hydroxyl group, a cyano group, a carboxyl group, a sulfonate group, an alkyl ester alkylene group, and a residue remaining after one hydrogen atom is removed from a hydroxyl group of saccharide (for example, disaccharide such as rutinose); in a case where these groups can have substituents, they may further have substituents).

Furthermore, in a case where the compound A has a residue (residue of Formula (1A)) remaining after one or more hydrogen atoms excluding a hydrogen atoms in a hydroxyl group are removed from the compound represented by Formula (1A), it is preferable that at least one of X¹¹, X¹², X¹³, or X¹⁴ has —CR¹¹═ having R¹¹ from which a hydrogen atom is to be removed. That is, at least one of X¹¹, X¹², X¹³, or X¹⁴ preferably represents —CR¹¹═ in which R¹¹ is a hydrogen atom or a group having a hydrogen atom.

Where the removed hydrogen atom was in R¹¹ becomes the binding position of the residue of Formula (1A) and another group. In a case where R¹¹ from which a hydrogen atom is to be removed is a hydrogen atom, R¹¹ itself is removed.

R¹¹ from which a hydrogen atom is to be removed is preferably a hydrogen atom or any of the groups having a hydrogen atom in the substituent T group, and more preferably —CO—O—R^{T1} or —O—CO—R^{T1} (in these structures, R^{T1} is a hydrogen atom or a substituent having a hydrogen atom).

As the residue of Formula (1A), a group represented by Formula (1-2A) is preferable.

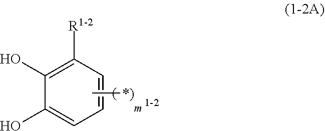

In Formula (1-2A), R¹⁻² represents a hydrogen atom, a hydroxyl group, or an alkoxy group (the alkoxy group may be linear or branched or may have a cyclic structure, and the number of carbon atoms in the alkoxy group is preferably 10 to 20).
m¹⁻² represents an integer of 1 to 3. m is preferably 1.
* represents a binding position.

As the compound A, a compound represented by Formula (1-3A) is preferable.

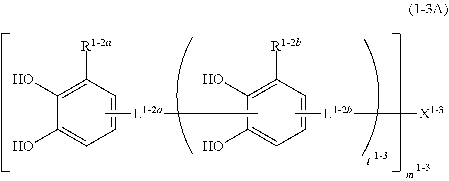

In Formula (1-3A), R^{1-2a} and R^{1-2b} have the same definition as R¹⁻² in Formula (1-2A). R^{1-2a} and R^{1-2b} may be the same or different from each other.

L^{1-2a} and L^{1-2b} each independently represent a single bond or a divalent linking group. Examples of the divalent linking group include an ether group, a carbonyl group, an ester group, a thioester group, an amide group, a sulfonamide group, a thioether group, —SO₂—, and —NR^{A}— (R^{A} represents a hydrogen atom, an alkyl group, an aryl group, or a heteroaryl group), a divalent hydrocarbon group (for example, an alkylene group, an alkenylene group, an alkynylene group, and an arylene group), a heteroarylene group, an azo group, and a group obtained by combining these.

L^{1-2a} and L^{1-2b} preferably each independently represent a single bond, an ester group, a vinylene group, or a group obtained by combining these, (for example, -vinylene group-ester group-).

l¹⁻³ represents 0 or 1.

m³ represents an integer equal to or greater than 2. m¹⁻³ is, for example, preferably 2 to 10, and more preferably 2 to 6.

In a case where m¹⁻³ is 2, X¹⁻³ represents a single bond or a divalent linking group. In a case where m¹⁻³ is greater than 2, X¹⁻³ represents an m¹⁻³-valent linking group.

In Formula (1-3A), the number of each group other than X¹⁻³ may be equal to or greater than 2, and groups represented by the same reference may be the same as or different from each other.

Particularly, in a case where m¹⁻³ is 2, X¹⁻³ is preferably a single bond or a divalent linking group represented by the following formula. In the formula, Rx² represents a hydrogen atom, a halogen atom, or an alkyl group (the alkyl group may be linear or branched or may have a cyclic structure, and the number of carbon atoms in the alkyl group is preferably 1 to 20). Ar represents an arylene group (the number of carbon atoms in the arylene group is preferably 1 to 20, the arylene group is preferably a phenylene group, a naphthylene group, or an anthracenylidene group, and more preferably an anthracenylene group). * represents a position bonded to L^{1-2a} or L^{1-2b}.

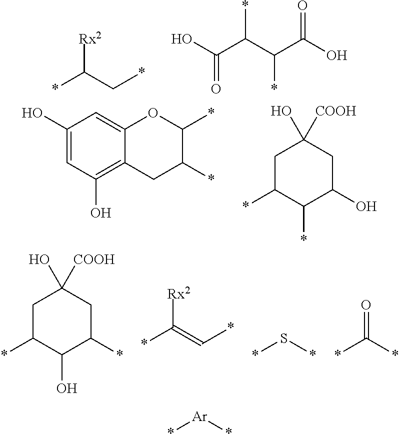

in a case where m¹⁻³ is 3. X¹⁻³ is preferably any of the trivalent linking groups represented by the following formulas. In the formulas, Rx³ represents a hydrogen atom, a halogen atom, or an alkyl group (the alkyl group may be linear or branched or may have a cyclic structure, the number of carbon atoms in the alkyl group is preferably 1 to 20, and the alkyl group is more preferably a methyl group). * represents a position bonded to L^{1-2a} or L^{1-2b}.

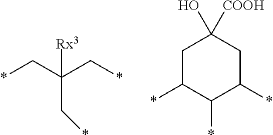

In a case where m¹⁻³ is 4, X¹⁻³ is preferably a tetravalent linking group represented by the following formula. * represents a position bonded to L^{1-2a} or L^{1-2b}.

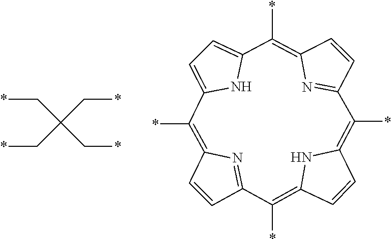

In a case where m¹⁻³ is 5, X¹⁻³ is preferably a pentavalent linking group represented by Formula. * represents a position bonded to L^{1-2a} or L^{1-2b}.

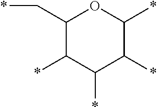 [SMILES: *CC1OC(*)C(*)C(*)C1*]

In a case where m¹⁻³ is 6, X¹⁻³ is preferably a hexavalent linking group represented by the following formula. * represents a position bonded to L^{1-2a} or L^{1-2b}.

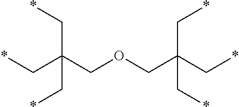 [SMILES: *CC(C*)(C*)COCC(C*)(C*)C*]

In a case where compound A is a polymer and has a repeating unit having the residue of Formula (1A), the compound A preferably has a repeating unit represented by the following formula.

The polymer may have a repeating unit other than the repeating unit represented by the following formula.

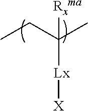

In the formula, Rx^{ma} represents a hydrogen atom, a halogen atom, an alkyl group (the alkyl group may be linear or branched or may have a cyclic structure, the number of carbon atoms in the alkyl group is preferably 1 to 20, and the alkyl group is more preferably a methyl group), or a perfluoroalkyl group (the perfluoroalkyl group may be linear or branched or may have a cyclic structure, the number of carbon atoms in the perfluoroalkyl group is preferably 1 to 20, and the perfluoroalkyl group is more preferably a trifluoromethyl group).

Lx represents a single bond or a divalent linking group, lire divalent linking group has the same definition as the divalent linking group represented by L¹⁻².

X represents the residue of Formula (l A).

(Compound B)

The compound B is a compound represented by Formula (2B).

Furthermore, the compound B is a compound other than the compound A.

Specifically, the compound B does not include a compound having two or more residues of Formula (1A).

The molecular weight of the compound B is preferably 110 to 2,000, and more preferably 120 to 1,500.

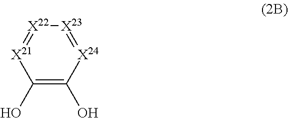

In Formula (2B), X²¹ to X²⁴ each independently represent a nitrogen atom or —CR²¹═.

It is preferable that X²¹ to X²⁴ are —CR²¹═.

R²¹ in —CR²¹═ represents a hydrogen atom, a halogen atom, a hydroxyl group, a cyano group, a nitro group, or a group represented by Formula (5B).

In a case where the compound has a plurality of structures represented by —CR²¹═, the plurality of R²¹'s may be the same or different from each other.

*-L²-R^{2x} (5B)

In Formula (5B), L² represents an arylene group which may have a substituent, a heteroarylene group which may have a substituent, or a divalent linking group represented by any of Formulas (6B) to (9B). R^{2x} represents a hydrogen atom or a substituent. * represents a binding position. In a case where —CR²¹═, has a plurality of groups represented by Formula (5B), the plurality of groups represented by Formula (5B) may be tire same as or different from each other.

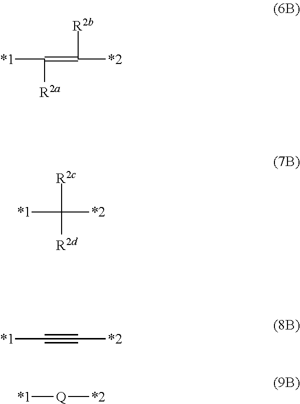

In Formulas (6B) to (9B), R^{2a} to R^{2d} each independently represent a hydrogen atom or a substituent *1 is the same as * in Formula (5B). *2 represents a position bonded to R^{2x}.

In Formula (9B), Q represents —CO—, —S(═O)—, S(═O)₂—, —O—, —S—, —SiR^{2e}R^{2f}—, —NR^{2g}—, —N—CR^{2h}—, —CR²ⁱ═N—, —N═N—, or —P(═O)R^{2l}—. R^{2e} to R^{2l} each independently represent a hydrogen atom or a substituent.

Examples of the substituent represented by R^{2x} and R^{2a} to R^{2j} include the groups exemplified above to describe the substituent represented by R¹¹.

Among these, examples of R^{2x} and R^{2a} to R^{2j} include a hydrogen atom, a halogen atom, a hydroxyl group, a cyano group, a carboxyl group, a nitro group, an alkyl group, an alkoxy group, an alkylamino group, an aryl group, an arylamide group, a nitroarylene group, an alkyl ester group, an aminoalkylene group, an alkylaminoalkylene group, an alkali metal oxy group (such as —ONa and OK), and a group obtained by combining these (for example, an alkyl ester group having a hydroxyl group and a carboxyl group in the portion of the alkyl group).

The substituents in the group represented by Formula (5B) may be linked to each other to form a ring.

The formed ring may be an aromatic ring (for example, an aromatic hydrocarbon ring and an aromatic heterocycle) or a non-aromatic ring (for example, a non-aromatic hydrocarbon ring and a non-aromatic heterocycle).

Furthermore, another ring may be fused with the formed ring so that a fused ring structure is formed.

The formed ring is preferably a 5- or 6-membered monocyclic ring or a polycyclic ring as a combination of the monocyclic rings. In a case where each ring is a heterocycle, the number of heteroatoms is preferably 1 to 5.

As the heteroatom of the heterocyclic, a nitrogen atom, a sulfur atom, or an oxygen atom is preferable. Examples of the formed ring include a chromanone ring and the like.

In a case where there is a plurality of X²¹ to X²⁴, which each represent —CR²¹═, in Formula (2B), the plurality of R²¹'s (for example, R²¹'s adjacent to each other in a case where X²¹ and X²² represent —CR²¹═, R²¹'s adjacent to each other in a case where X²² and X²³ represent —CR²¹═, and R²¹'s adjacent to each other in a case where X²³ and X²⁴ represent —CR²¹═) may be bonded to each other to form a ring.

Examples of the aspect in which the groups represented by Formula (5B) are linked to each other to form a ring include an aspect in which the compound B forms a fused ring structure.

The fused ring structure may be a structure in which an aromatic ring or a non-aromatic ring is fused with a ring having consecutively arranged hydroxyl groups in Formula (2B).

Examples of the ring to be fused include the rings described above as rings formed by the bonding of R¹¹'s.

R²¹ is, for example, preferably a hydrogen atom or a substituent having a Hammett substituent constant σₚ higher than 0.

Furthermore, R²¹ is preferably a hydrogen atom or any of the substituents belonging to the substituent T group described above.

It is preferable that the compound B has at least one R²ⁱ which is any of the substituents belonging to the substituent T group described above.

The compound B is preferably a compound in which one of X²¹ to X²⁴ is —CR²¹═ having a hydroxyl group as R²¹, and more preferably a compound in which either X²¹ or X²⁴ is —CR²¹═ having a hydroxyl group as R²¹.

As the compound B, a compound represented by Formula (2-2B) or a compound represented by Formula (2-3B) is preferable.

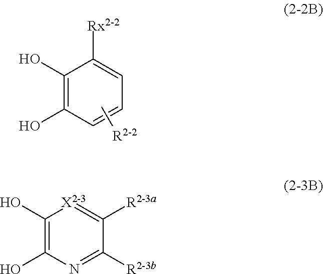

In Formula (2-2B), Rx²⁻² represents a hydrogen atom or a hydroxyl group.

R²⁻² has the same definition as R²¹ described above. R²⁻² is preferably a group having a vinylene group or any of the substituents belonging to the substituent T group, and more preferably —CO—R^{T1}, —CO—O—R^{T1}, or —CO—NH—R^{T1}.

In Formula (2-3B), X²⁻³ represents —CH═ or a nitrogen atom.

Each of R^{2-3a} and R^{2-3b} has the same definition as R²¹ described above. R^{2-3a} and R^{2-3b} preferably each independently represent any of the substituents belonging to the substituent T group, and more preferably each independently represent —CO—R^{T1}, —CO—O—R^{T1}, or —CO—NH—R^{T1}.

In addition, R^{2-3a} and R^{2-3b} may be bonded to each other to form a ring. Examples of the ring formed in this way include the rings formed in a case where a plurality of R¹¹'s are bonded to each other. Among these, a benzene ring is preferable.

(Compound C)

The compound C is a compound represented by Formula (3C).

Furthermore, the compound C is a compound other than the compound A and the compound B.

The molecular weight of compound C is preferably 110 to 2,000, and more preferably 120 to 1,500.

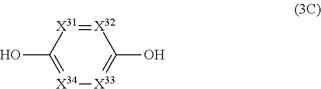

In Formula (3C), X³¹ to X³⁴ each independently represent a nitrogen atom or —CR³¹═. R³¹ represents a substituent other than hydroxyl group or a hydrogen atom.

It is preferable that at least one of X³¹, X³², X³³, or X³⁴ represents —CR³¹═. In a case where the compound has a plurality of R³¹'s, the plurality of R³¹'s may be the same as or different from each other.

It is preferable that X³¹ to X³⁴ are —CR³¹═.

R³¹ does not include a hydroxyl group. Note that a case where the substituent represented by R³¹ further has a hydroxyl group as a substituent (for example, a hydroxyalkyl group) is not excluded.

Examples of the substituent represented by R³¹ include the groups described above as the substituent represented by R¹¹ in Formula (1A) except for a hydroxyl group.

In a case where there is a plurality of structures represented by —CR³¹═ in Formula (3C), the plurality of R³¹'s may be bonded to each other to form a ring.

Examples of the aspect in which R^{3l}'s form a ring include the aforementioned aspect in which R¹¹'s form a ring by being bonded to each other.

R³¹ is, for example, preferably a hydrogen atom or a substituent having a Hammett substituent constant σₚ higher than 0.

Furthermore, R³¹ is preferably a hydrogen atom or any of the substituents belonging to the substituent T group described above.

It is preferable that the compound C has at least one R³¹ which is any of the substituents belonging to the substituent T group described above.

As the compound C, a compound represented by Formula (3-2C) is preferable.

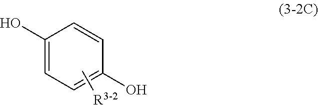

R³⁻² in Formula (3-2C) has the same definition as R³¹ described above. R³⁻² is preferably any of the substituents belonging to the substituent T group, and more preferably —CO—R^{T1}, —CO—O—R^{T1}, or —CO—NH—R^{T1}.

(Compound D)

The compound D is a compound represented by Formula (4D).

Furthermore, the compound D is a compound other than the compounds A to C.

The molecular weight of compound D is preferably 110 to 2,000, and more preferably 120 to 1,500.

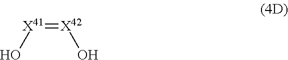

In Formula (4D), X⁴¹ and X⁴² each independently represent —CR⁴¹═. R⁴¹ represents a hydrogen atom or a substituent.

The compound D has two structures represented by —CR⁴¹═. The two structures represented by —CR⁴¹═ may be the same as or different from each other.

At least one of two R⁴ⁱ's represents a substituent

Examples of the substituent represented by R⁴¹ include the groups described above as the substituent represented by R¹¹ in Formula (1A).

The two structures represented by —CR⁴¹═ may be bonded to each other to form a ring.

That is, in a case where X⁴¹ and X⁴² are —CR⁴¹═, two adjacent R⁴¹'s may be bonded to each other to form a ring.

The formed ring contains the vinylene group in Formula (4D). However, the formed ring is limited to non-aromatic rings. In a case where the compound D has a ring formed by the fusion of the formed ring (ring containing a vinylene group) with another ring, the another ring may be an aromatic ring.

R⁴¹ is, for example, preferably a hydrogen atom or a substituent having a Hammett substituent constant σₚ higher than 0.

Furthermore, R⁴¹ is preferably a hydrogen atom or any of the substituents belonging to the substituent T group described above.

It is preferable that the compound D has at least one R⁴¹ which is any of the substituents belonging to the substituent T group described above.

As the compound D, a compound represented by Formula (4-20) is preferable.

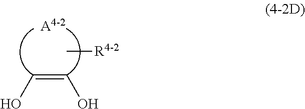

In Formula (4-2D), A⁴⁻² represents an alkylene group which forms a non-aromatic ring by being bonded to a vinylene group in the formula at both ends. One or more methylene groups in the alkylene group may be substituted with an ether group, a carbonyl group, an ester group, or a thioether group. The number of carbon atoms in the alkylene group is preferably 2 to 4. It is preferable that one methylene group in the alkylene group is substituted with an ether group.

R⁴⁻² is a hydrogen atom or a substituent, and has the same definition as R⁴¹ described above. R⁴⁻² is, for example, preferably any of the substituents belonging to the substituent T group or an alkyl group (preferably an alkyl group substituted with two hydroxyl groups).

Specific examples of the compounds A to D will be shown below.

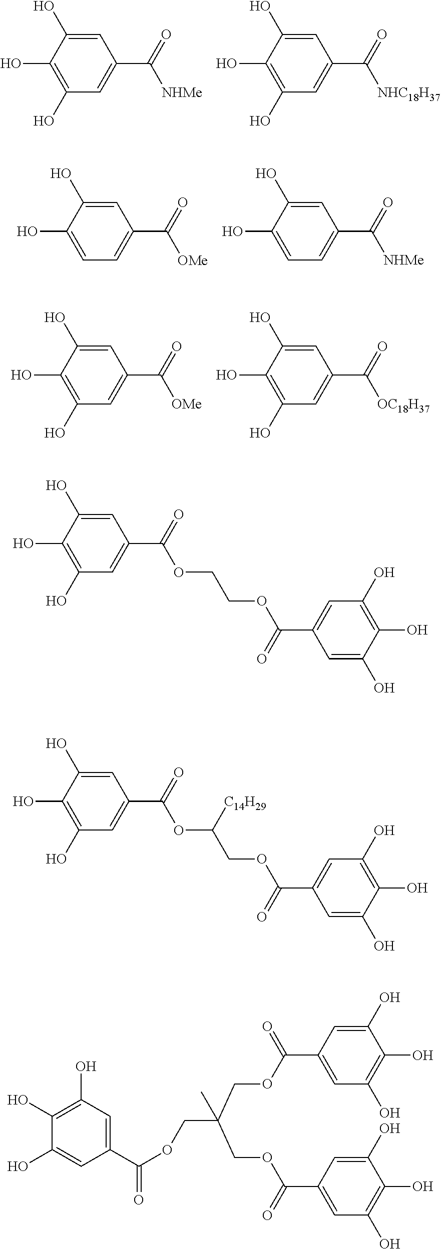

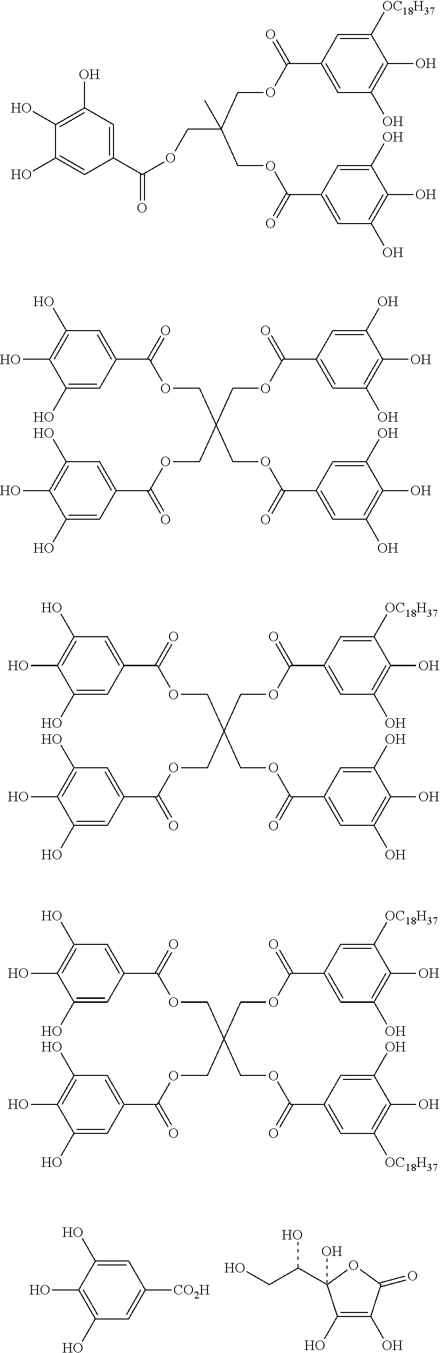

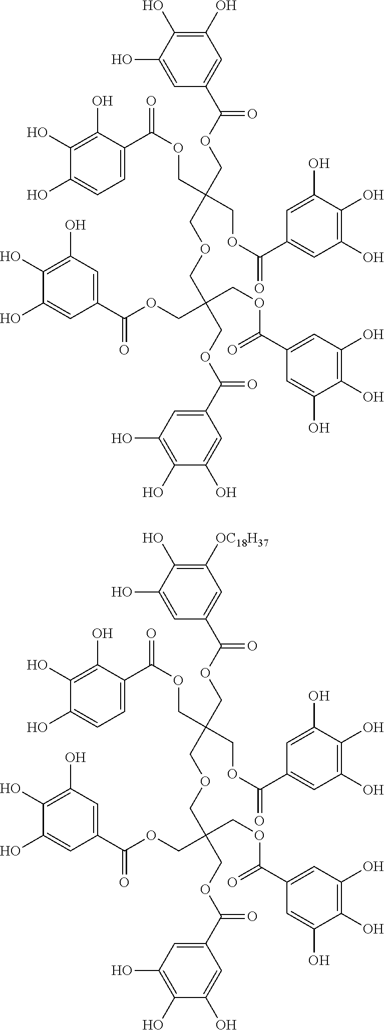

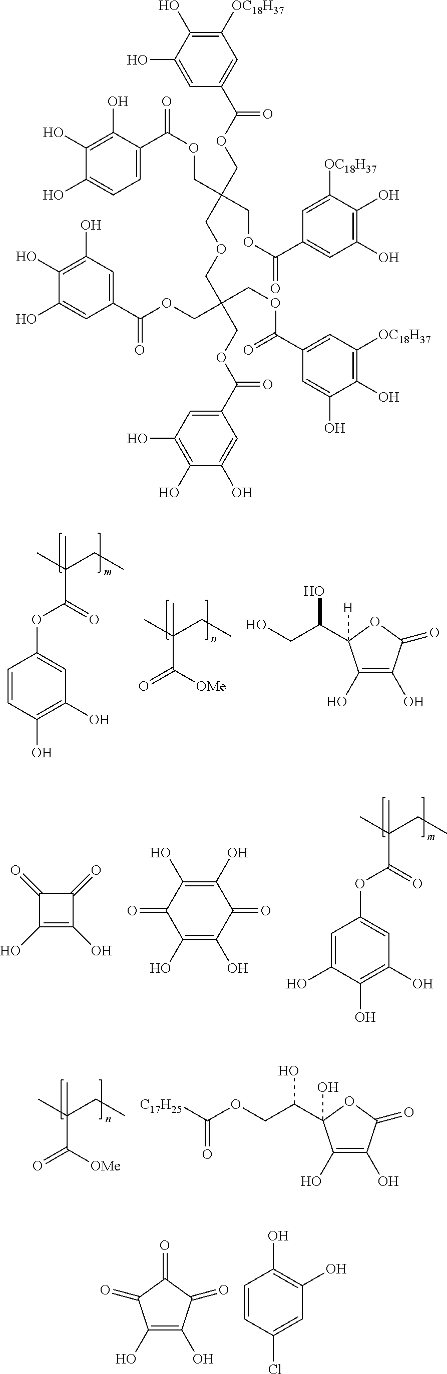

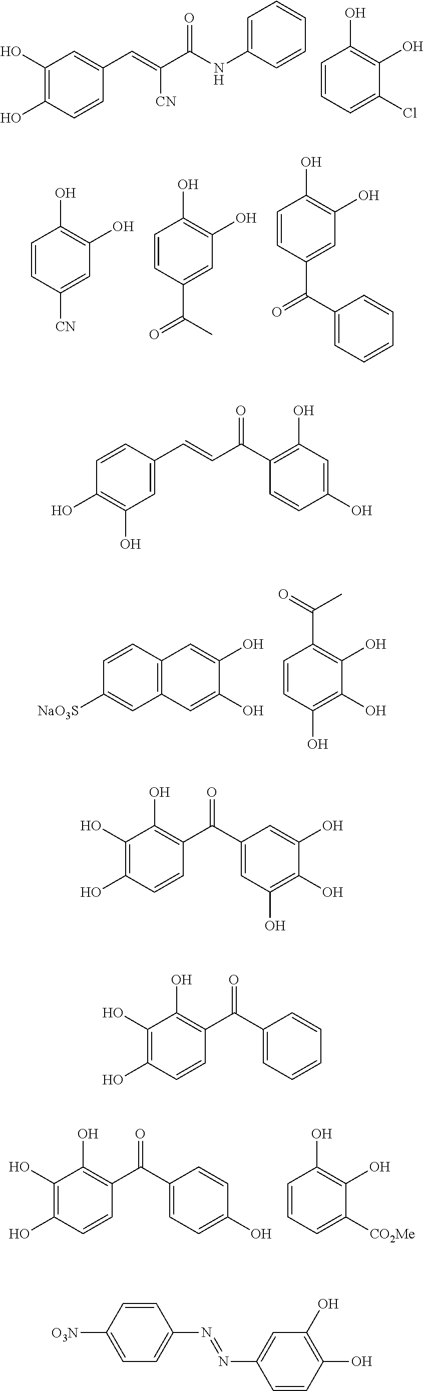

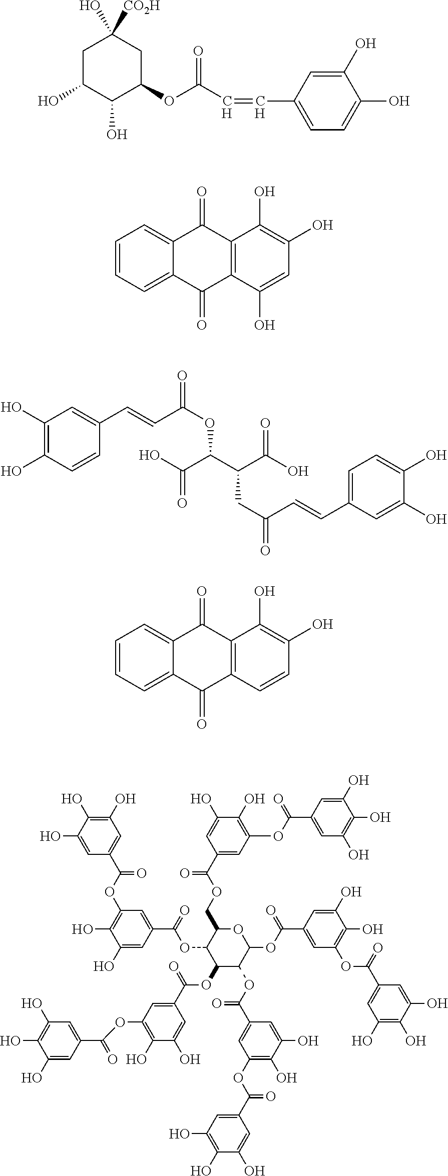

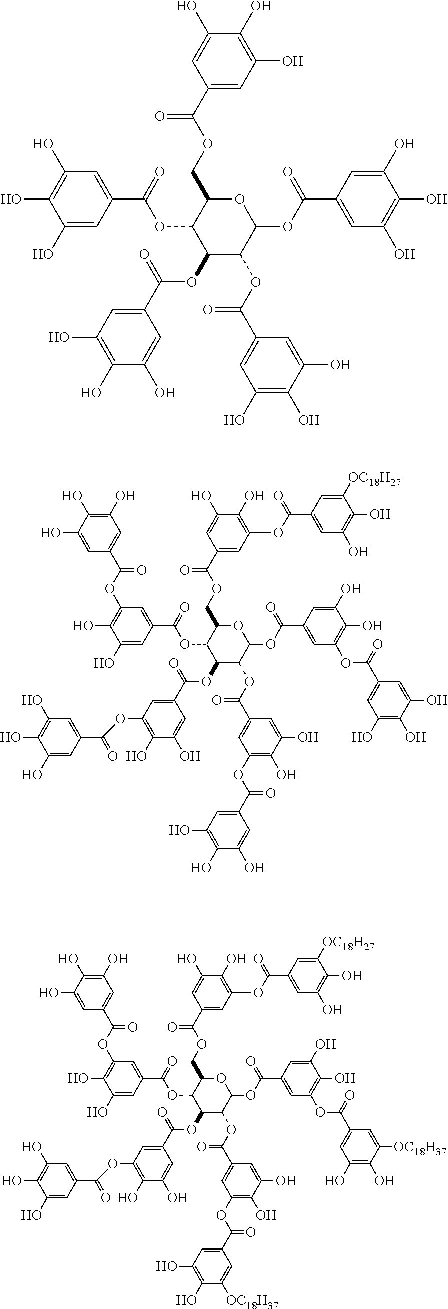

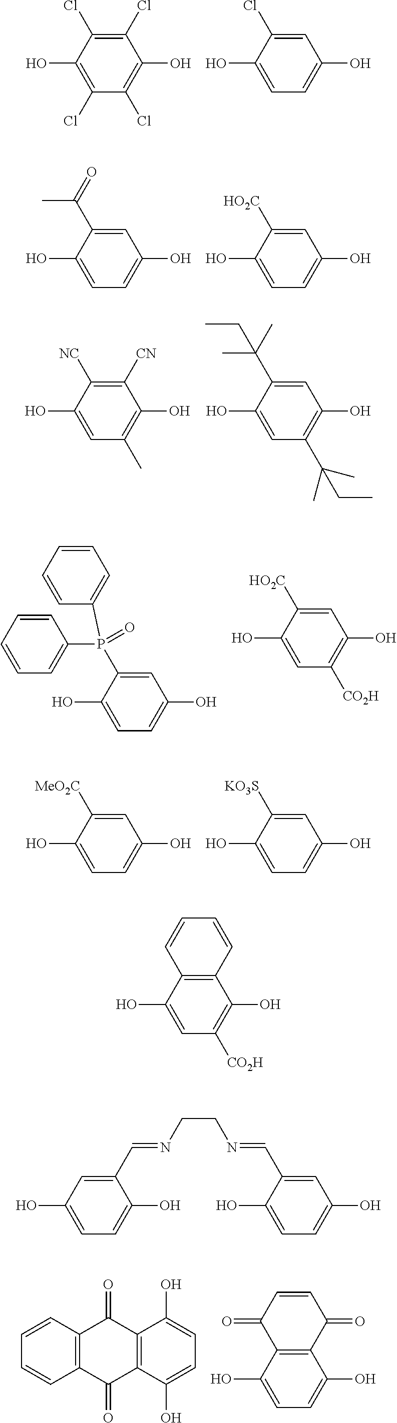

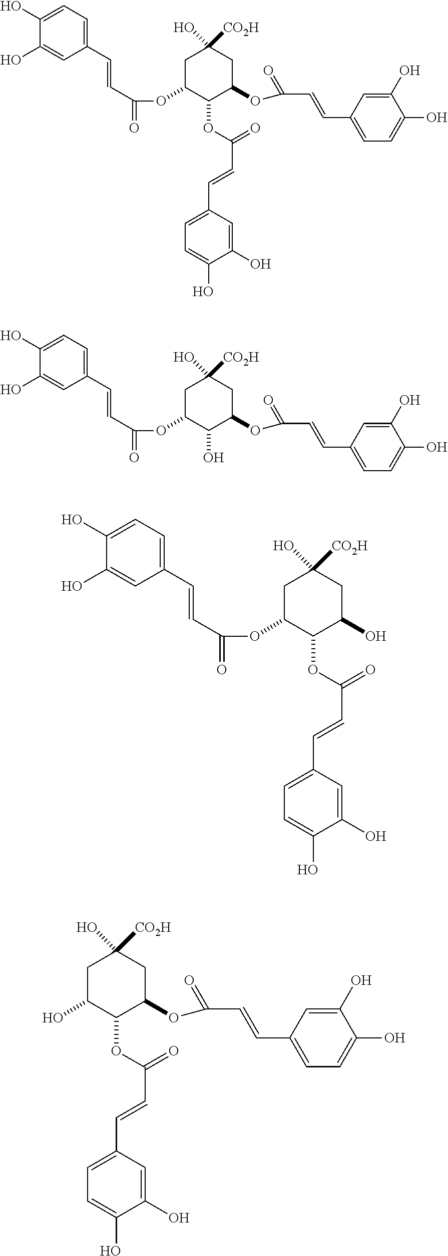

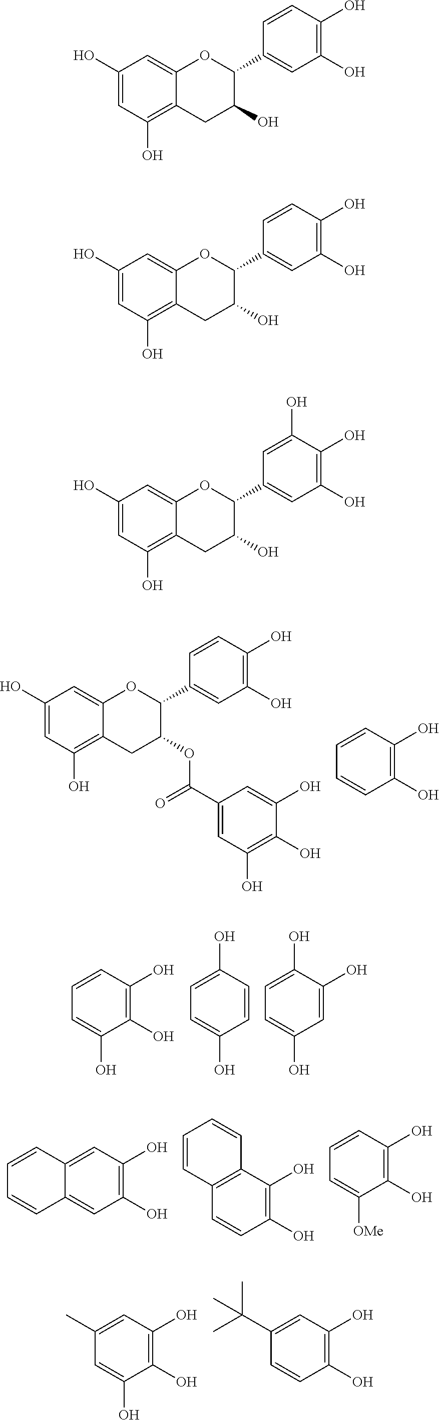

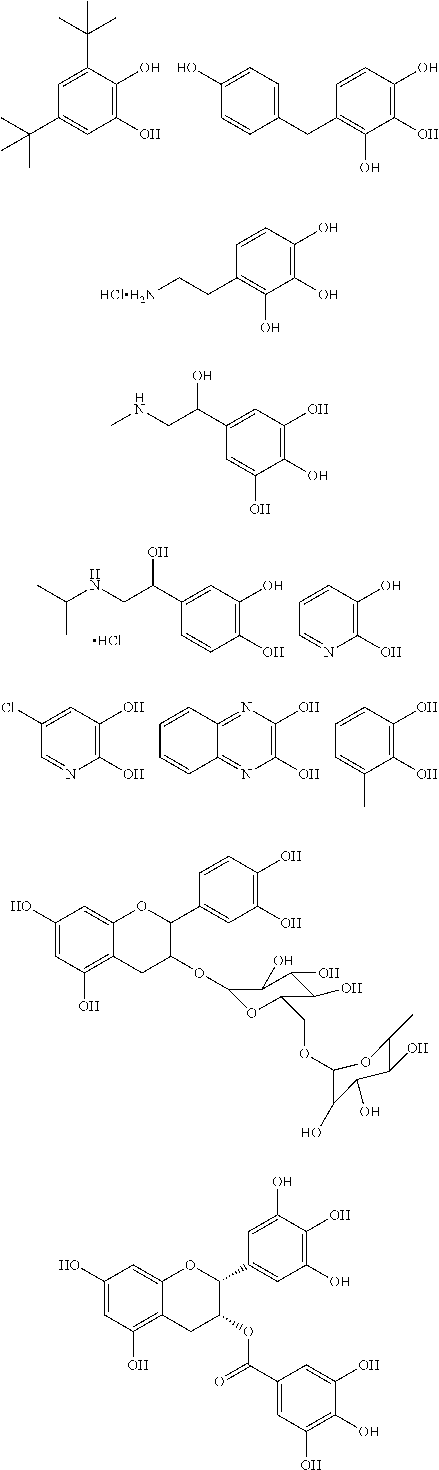

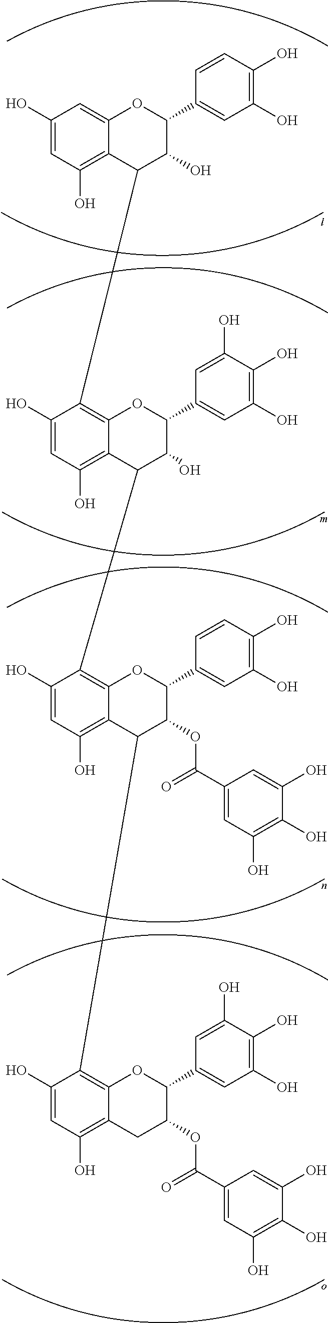

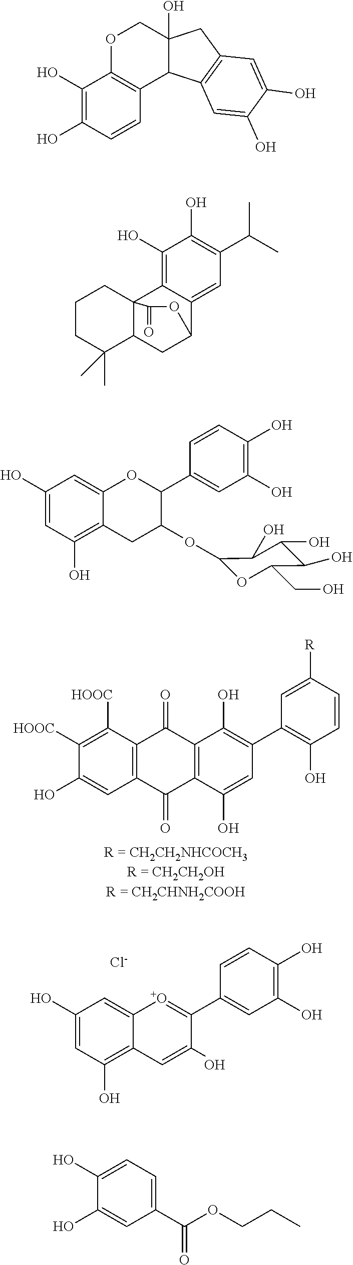

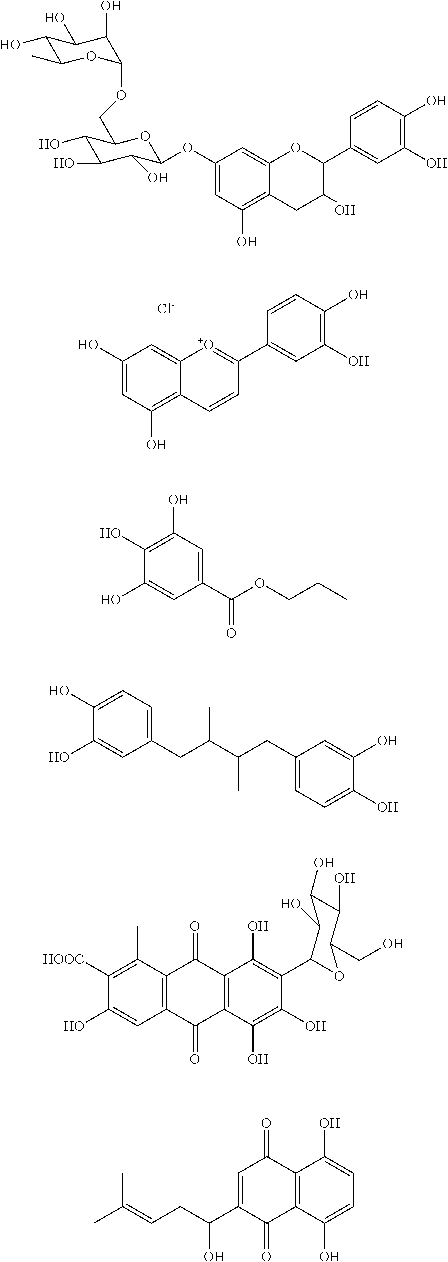

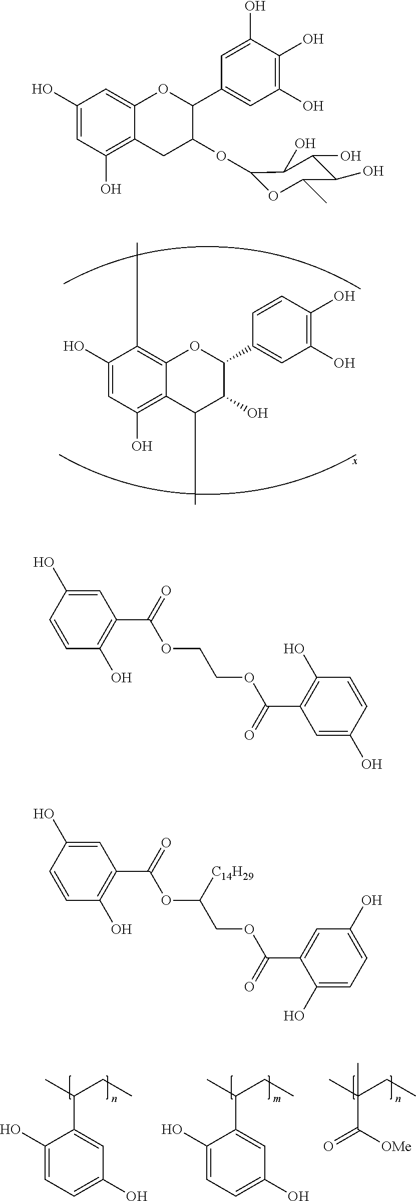

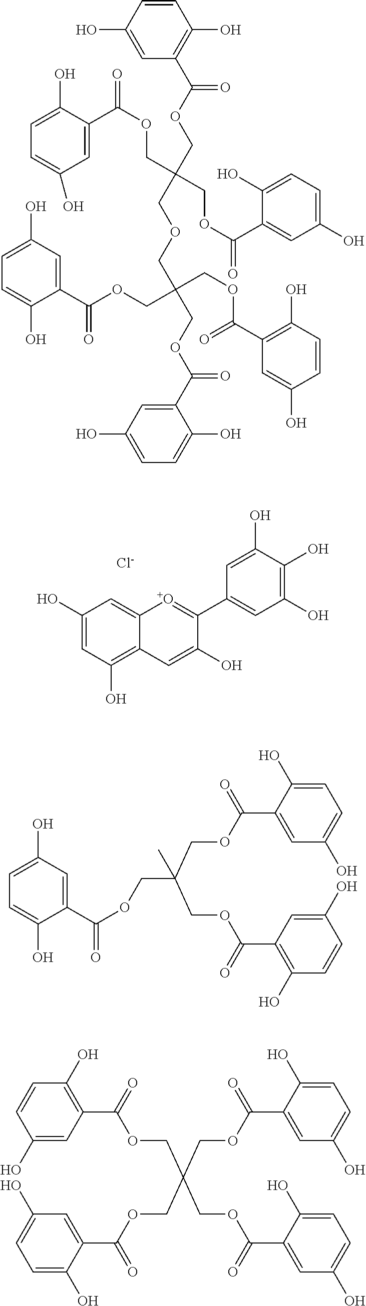 [SMILES: O=C(OCC(COCC(COC(=O)c1cc(O)ccc1O)(COC(=O)c1cc(O)ccc1O)COC(=O)c1cc(O)ccc1O)(COC(=O)c1cc(O)ccc1O)COC(=O)c1cc(O)ccc1O)c1cc(O)ccc1O ; Oc1cc(O)c2cc(O)c(-c3cc(O)c(O)c(O)c3)[o+]c2c1 ; [Cl-] ; CC(COC(=O)c1cc(O)ccc1O)(COC(=O)c1cc(O)ccc1O)COC(=O)c1cc(O)ccc1O ; O=C(OCC(COC(=O)c1cc(O)ccc1O)(COC(=O)c1cc(O)ccc1O)COC(=O)c1cc(O)ccc1O)c1cc(O)ccc1O]

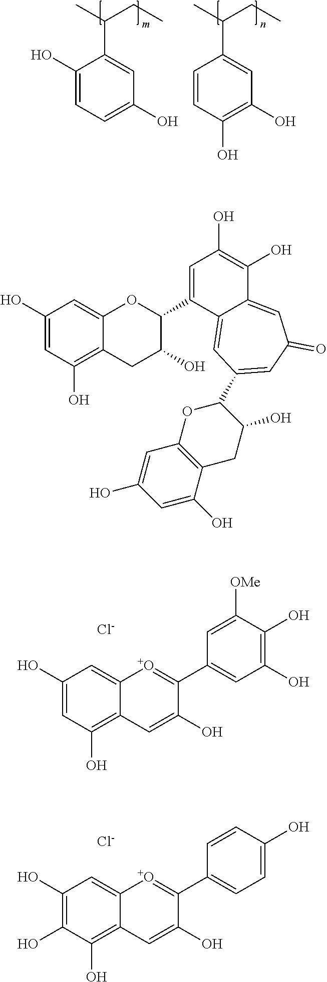

For example, the following compound E is another form of the compound having a phenolic hydroxyl group.

(Compound E)

The compound E is a compound represented by Formula (1E).

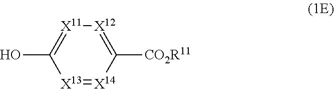

In Formula (1E), R¹¹ represents a monovalent substituent. The monovalent substituent represented by R¹¹ is not particularly limited, and examples thereof include an aliphatic group, an aryl group, a heteroaryl group, and an aralkyl group.

Examples of the aliphatic group include linear and branched alkyl groups having 1 to 30 carbon atoms, linear and branched alkenyl groups having 2 to 30 carbon atoms, linear and branched alkynyl groups having 2 to 30 carbon atoms, and an alicyclic hydrocarbon group having 3 to 30 carbon atoms. In the linear and branched alkyl groups having 1 to 30 carbon atoms, the linear and branched alkenyl groups having 2 to 30 carbon atoms, the linear and branched alkynyl groups having 2 to 30 carbon atoms, and the alicyclic hydrocarbon group having 3 to 30 carbon atoms, —CH₂— may be substituted with a heteroatom. The type of the heteroatom is not particularly limited, and examples thereof include an oxygen atom, a nitrogen atom, a sulfur atom, a selenium atom, and a tellurium atom. Particularly, in view of further improving the antiviral activity of the wiper, it is preferable that the heteroatom is incorporated into the compound in the form of —Y¹—, —N(Ra)-, —C(═Y²)—, —CON(Rb)—, —C(═Y³)Y⁴—, —SOt-, —SO²N(Rc)-, or a group obtained by combining these.

Y¹ to Y⁴ are each independently selected from the group consisting of an oxygen atom, a sulfur atom, a selenium atom, and a tellurium atom. Among these, in view of greater ease of handling, an oxygen atom is preferable, t represents an integer of 1 to 3. Ra, Rb, and Rc described above each independently represent a hydrogen atom, an alkyl group having 1 to 10 carbon atoms, an aryl group, or a heteroaryl group.

The linear and branched alkyl groups having 1 to 30 carbon atoms preferably have 1 to 20 carbon atoms. Specifically, examples thereof include a methyl group, an ethyl group, a n-propy group, an isopropyl group, a n-butyl group, an isobutyl group, a sec-butyl group, a tert-butyl group, a n-pentyl group, an isopentyl group, a neopentyl group, a 1,1-dimethylpropyl group, a n-hexyl group, a 2-ethylhexyl group, an isohexyl group, a heptyl group, an octyl group, a 3,7-dimethyloctyl group, a nonyl group, a decyl group, a undecyl group, a dodecyl group, a tridecyl group, a tetradecyl group, a pentadecyl group, a hexadecyl group, a heptadecyl group, an octadecyl group, a nonadecil group, an icosanyl group, eicosanyl, a henicosanyl group, a heneicosanyl group, a docosanyl group, a tricosanyl group, a tetracosanyl group, a pentacosanyl group, a hexacosanyl group, a heptacosanyl group, an octacosanyl group, a nonacosanyl group, and a triacontanyl group.

The linear and branched alkenyl groups having 2 to 30 carbon atoms preferably have 2 to 20 carbon atoms. Specifically, examples thereof include a vinyl group, a propenyl group, a butenyl group, a pentynyl group, a hexenyl group, a heptenyl group, an octenyl group, a nonenyl group, a decenyl group, a undecenyl group, a dodecenyl group, a tridecenyl group, a tetradecenyl group, a hexadecynyl group, an octadecenyl) group, an octadecadienyl group, a nonadecenyl group, an icosenyl group, an eicosenyl group, a heneicosenyl group, a heneicosenyl group, a docosenyl group, a tricosenyl group, a tetracosenyl group, a pentacosenyl group, a hexacosenyl group, a heptacosenyl group, an octacosenyl group, a nonacocenyl group, a triacontenyl group, an octadecatrienyl group, a butadienyl group, a pentadienyl group, a hexadienyl group, and an octadienyl group.

In the linear and branched alkenyl groups having 2 to 30 carbon atoms, the position of an unsaturated bond is not limited. The alkenyl groups may be cis- or trans isomers. For example, an octadecenyl group includes an oleyl group (a cis-9-octadecenyl group) and an elaidyl group (a trans-9-octadecenyl group), an octadecadienyl group includes a (inoleyl group (a cis,cis-9,12-octadecadienyl group) and an elaidolinoleyl group (a trans,trans-9,12-octadecadienyl group), an octadecatrienyl group includes a linolenyl group (a cis,cis,cis-9,12,15-octadecatrienyl group) and an elaidolinolenyl group (a trans,trans,trans-9,12,15-octadecatrienyl group), and a hexadecene group includes a palmitoleyl group (a cis-9-hexadecene group).

The linear and branched alkynyl groups having 2 to 30 carbon atoms preferably have 2 to 20 carbon atoms. Specifically, examples thereof include an ethynyl group, a propynyl group, a butynyl group, a pentynyl group, a hexynyl group, a heptynyl group, an octynyl group, a nonynyl group, a decynyl group, a undecynyl group, a dodecynyl group, a tridecenyl group, a tetradecynyl group, a pentadecynyl group, a hexadecynyl group, a heptadecynyl group, an octadecynyl group, a nonadecinyl group, an icosynyl group, an eicosynyl group, a henicosynyl group, a heneicosynyl group, a docosynyl group, a tricosynyl group, a tetracosynyl group, a pentacosynyl group, a hexacosyl group, a heptacosynyl group, an octacosynyl group, a nonacosynyl group, and a triacontinyl group.

The alicyclic hydrocarbon group having 3 to 30 carbon atoms may be any of a monocyclic ring, a polycyclic ring, or a crosslinked ring. Specific examples of the ring constituting the alicyclic hydrocarbon group include cyclopropane, cyclobutane, cyclopentane, cyclopentene, cyclopentadiene, cyclohexane, 2-isopropyl-5-methylcyclohexane, cyclohexene, cyctohexadiene, cycloheptane, and cycloheptane, cycloheptadiene, cyclooctane, cyclooctene, cydooctadiene, cyclooctatriene, cyclononane, cyclononene, cyclodecane, cyclodecene, cyclodecadiene, cyclodecatriene, cycloundecane, cyclododecane, bicycloheptane, bicyclohexane, bicyclohexene, tricyclohexene, norcarane, norpinane, norbornane, norbornene, norbornadiene, tricycloheptane, tricycloheptene, decalin, and adamantane.

Examples of the aryl group include an aryl group having 6 to 18 carbon atoms.

The aryl group may be a monocyclic structure or a fused ring structure (condensed ring structure) composed of two or more rings fused with each other.

Examples of the aryl group include a phenyl group, a tolyl group, a xylyl group, a naphthyl group, an anthracenyl group, a phenanthryl group, and a pyrenyl group. Among these, a phenyl group or a naphthyl group is preferable, and a phenyl group is more preferable.

Examples of the heteroaryl group include a heteroaryl group having a monocyclic or polycyclic ring structure containing a heteroatom such as a sulfur atom, an oxygen atom, or a nitrogen atom.

The number of carbon atoms in the heteroaryl group is not particularly limited, but is preferably 3 to 18 and more preferably 3 to 5.

The number of heteroatoms contained in the heteroaryl group is not particularly limited, but is preferably 1 to 10, more preferably 1 to 4, and even more preferably 1 or 2.

The number of members constituting the heteroaryl group is not particularly limited, but is preferably 3 to 8, more preferably 5 to 7, and even more preferably 5 or 6.

Examples of the heteroaryl group include a furyl group, a pyridyl group, a quinolyl group, an isoquinolyl group, an acridinyl group, a phenanthridinyl group, a pteridinyl group, a pyrazinyl group, a quinoxalinyl group, a pyrimidinyl group, a quinazolyl group, a pyridazinyl group, a cinnolinyl group, a phthalazinyl group, a triazinyl group, an oxazolyl group, a benzoxazolyl group, a thiazolyl group, a benzothiazolyl group, an imidazolyl group, a benzimidazolyl group, a pyrazolyl group, an indazolyl group, an isoxazolyl group, a benzisoxazolyl group, an isothiazolyl group, a benzisothiazolyl group, an oxadiazolyl group, a thiadiazolyl group, a triazolyl group, a tetrazolyl group, a benzofuryl group, a thienyl group, a benzothienyl group, a dibenzofuryl group, a dibenzothienyl group, a pyrrolyl group, an indolyl group, an imidazopyridinyl group, and a carbazolyl group.

Examples of the aralkyl group include a group obtained in a case where one hydrogen atom in the linear and branched alkyl groups having 1 to 30 carbon atoms is substituted with the aryl group or heteroaryl group described above. Specific examples of the aralkyl group include a benzyl group, a phenethyl group, and a naphthylmethyl group.

The aliphatic group, aryl group, heteroaryl group, and aralkyl group described above may further have a substituent. The substituent is not particularly limited, and examples thereof include the substituents belonging to a substituent group W which will be described later. As the substituent, an alkyl group (preferably having 1 to 12 carbon atoms for example), an alkoxy group (preferably having 1 to 12 carbon atoms for example), or a hydroxyl group is preferable.

In Formula (1E), X¹¹ to X¹⁴ each independently represent a nitrogen atom or —CR¹²═.

Particularly, in view of high antiviral activity, the compound E is preferably a compound in which X¹¹ to X¹⁴ all represent —CR¹²═ or one or two out of X¹¹ to X¹⁴ represent a nitrogen atoms and others represent —CR¹²═, and more preferably a compound in which X¹¹ to X¹⁴ all represent —CR¹²═.

R¹² represents a hydrogen atom or a monovalent substituent other than a hydroxyl group.

The monovalent substituent represented by R¹² other than a hydroxyl group is not particularly limited, as long as the monovalent substituent is not a hydroxyl group. Examples thereof include the substituents (excluding a hydroxyl group) listed in the substituent group W which will be described later. As the monovalent substituent represented by R¹² other than a hydroxyl group, an alkyl group (preferably having 1 to 12 carbon atoms for example), an alkenyl group (preferably having 2 to 12 carbon atoms for example), an alkynyl group (preferably having 2 to 12 carbon atoms for example), an alkoxy group (preferably having 1 to 12 carbon atoms for example), a nitro group, a halogen atom, a carboxyl group, a cyano group, an alkoxycarbonyl group, an acyl group, an aryl group, a heteroaryl group, an amide group, or a sulfonamide group is preferable, and an alkyl group, an alkenyl group, an alkynyl group, or a halogen atom is more preferable.

Among these, a hydrogen atom is preferable as R¹².

In a case where there is a plurality of R¹²'s in Formula (1), the plurality of R¹²'s may be the same as or different from each other.

(Substituent Group W)

For example, the substituent group W consists of a halogen atom (such as a fluorine atom, a chlorine atom, a bromine atom, or an iodine atom), an alkyl group (including a cycloalkyl group, a bicycloalkyl group, and a tricycloalkyl group), an alkenyl group (including a cycloalkenyl group and a bicycloalkenyl group), an alkynyl group, an aryl group, a heterocyclic group (including a heteroaryl group), a cyano group, a hydroxyl group, a nitro group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group (Including an anilino group), an ammonio group, an acylamino group, an aminocarbonylamino group, an aikoxycarbonylamino group, an aryloxycarbonylamino group, a sulfamoylamino group, an alkyl- or arylsulfonytamino group, a mercapto group, an alkylthio group, an arylthio group, a heterocyclic thio group, an acylthio group, a sulfamoyl group, an alkyl- or arylsulfinyl group, an alkyl- or arylsulfonyl group, an acyl group, an aryloxycarbonyl group, an alkoxycarbonyl group, a carbamoyl group, an aryl- or heterocyclic azo group, an imide group, a phosphino group, phosphinyl group, phosphinyloxy group, phosphinylamino group, phosphono group, silyl group, hydrazino group, a ureide group, a boronic acid group (—B(OH)₂), a sulfonic acid group, a carboxyl group, a phosphoric acid group, and other known substituents.

Furthermore, the groups listed in the substituent group W may be further substituted with the groups exemplified as groups belonging to the substituent group W. For example, an alkyl group may be substituted with a halogen atom.

In a case where X¹¹ and X¹² represent —CR¹²═, R¹² in X¹¹ and R¹² in X¹² may be linked to each other to form an aromatic ring or a non-aromatic ring.

In a case where X¹³ and X¹⁴ represent —CR¹²═, R¹² in X¹³ and R¹² in X¹⁴ may be linked to each other to form an aromatic ring or a non-aromatic ring.

In a case where at least one of X¹² or X¹⁴ represents —CR¹²═, one of R¹² in X¹² or R¹² in X¹⁴ may be linked to R¹¹ to form a non-aromatic ring.

Examples of the non-aromatic ring include a lactone ring.

Examples of the aromatic ring include a benzene ring, a pyridine ring, a pyrrole ring, a furan ring, a thiophene ring, a thiazole ring, an oxazole ring, an imidazole ring, a naphthalene ring, a quinoline ring, an isoquinoline ring, a benzothiophene ring, an indole ring, a benzofuran ring, a benzimidazole ring, a benzothiazole ring, and a benzoxazole ring.

Examples of the compound represented by Formula (1E) will be shown below, but the present invention is not limited thereto.

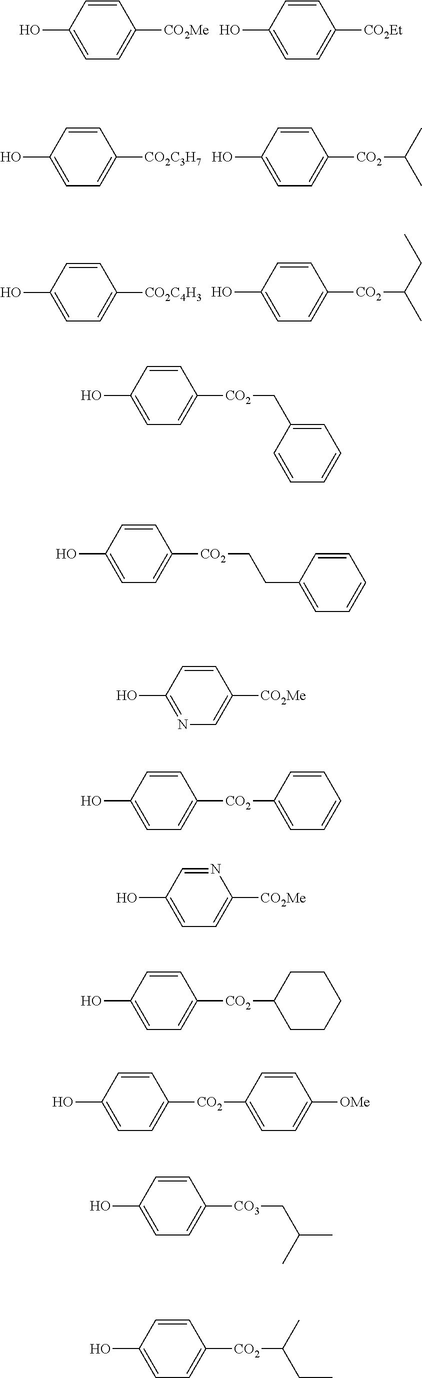

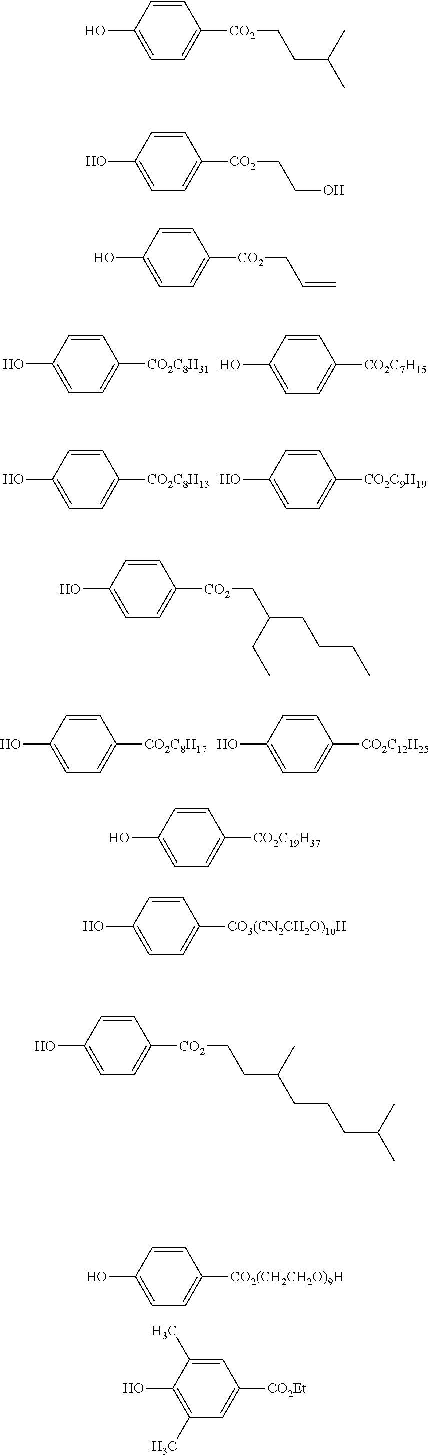

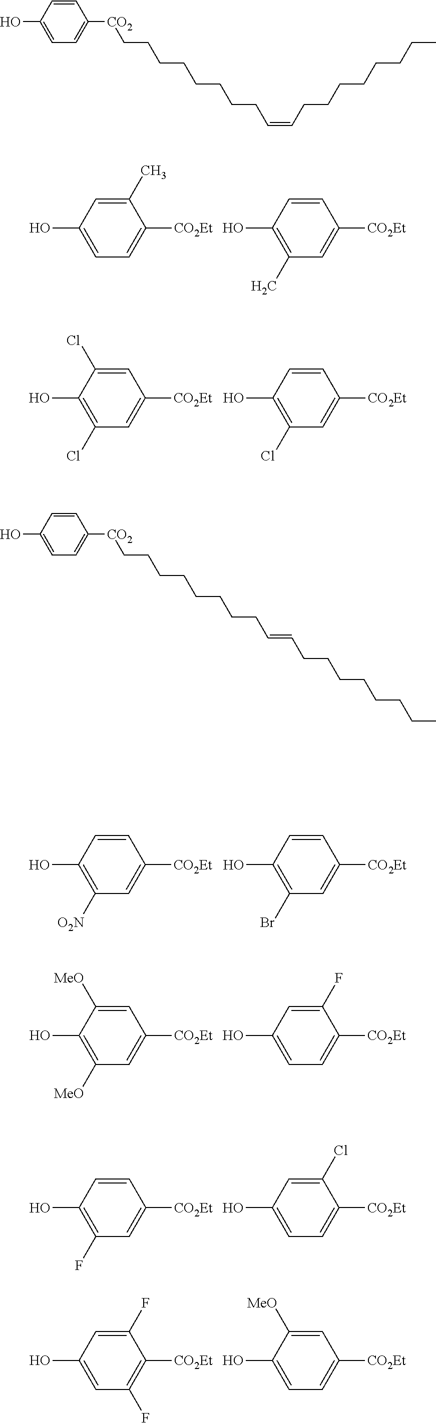

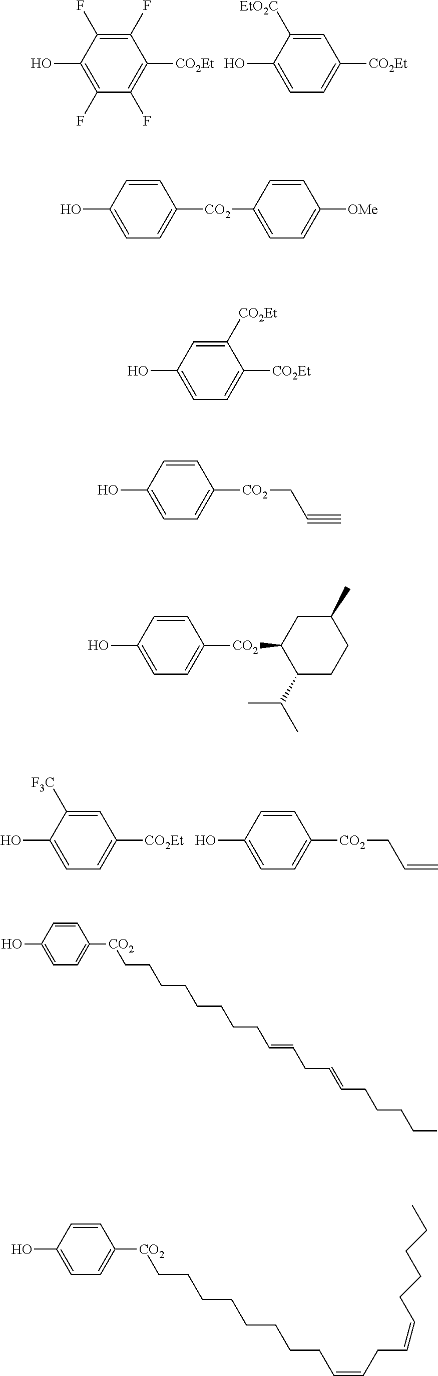

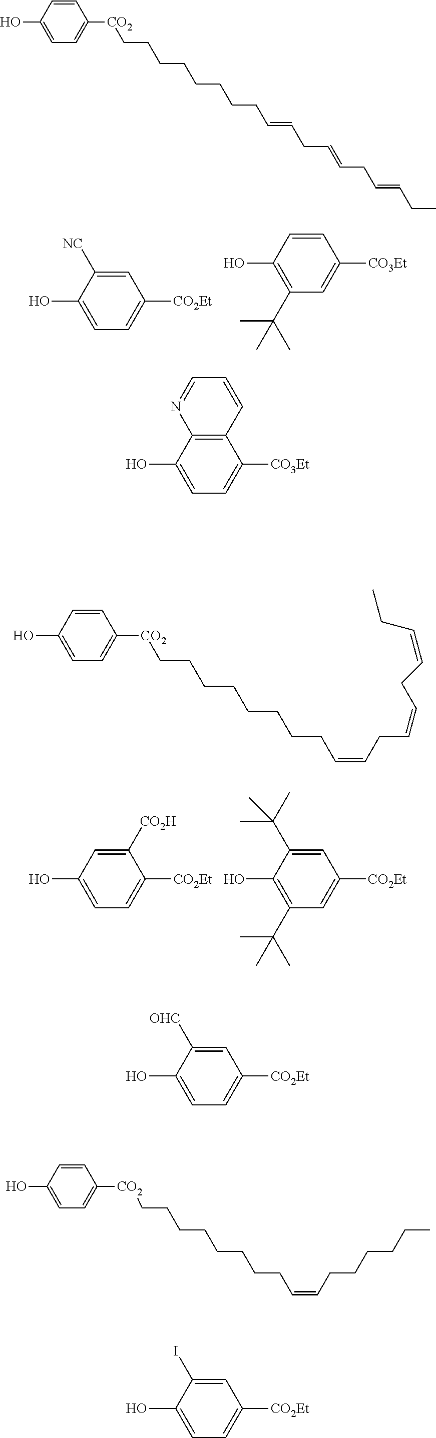

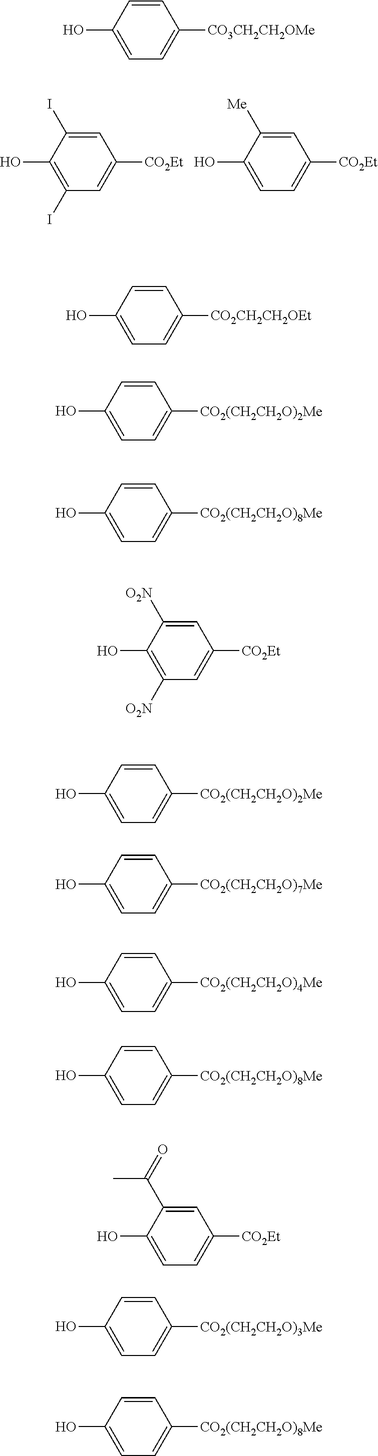

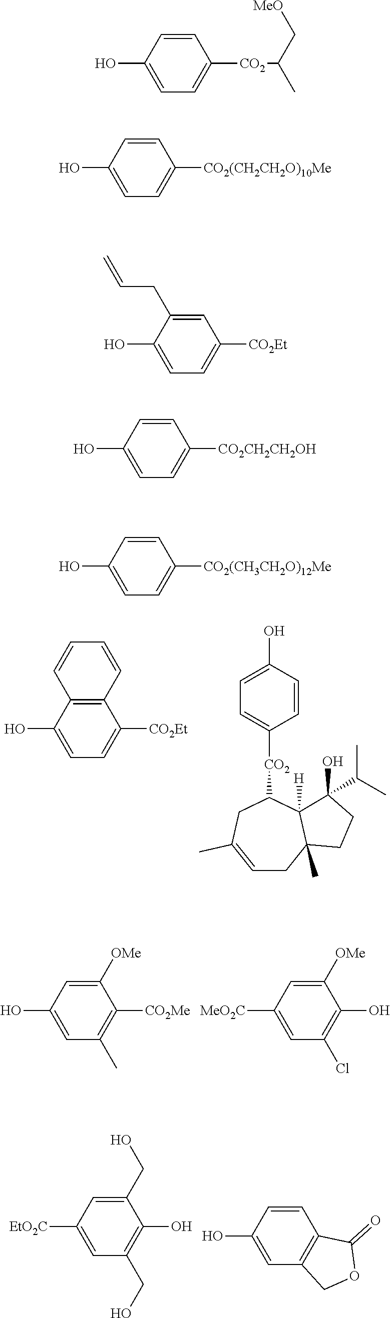

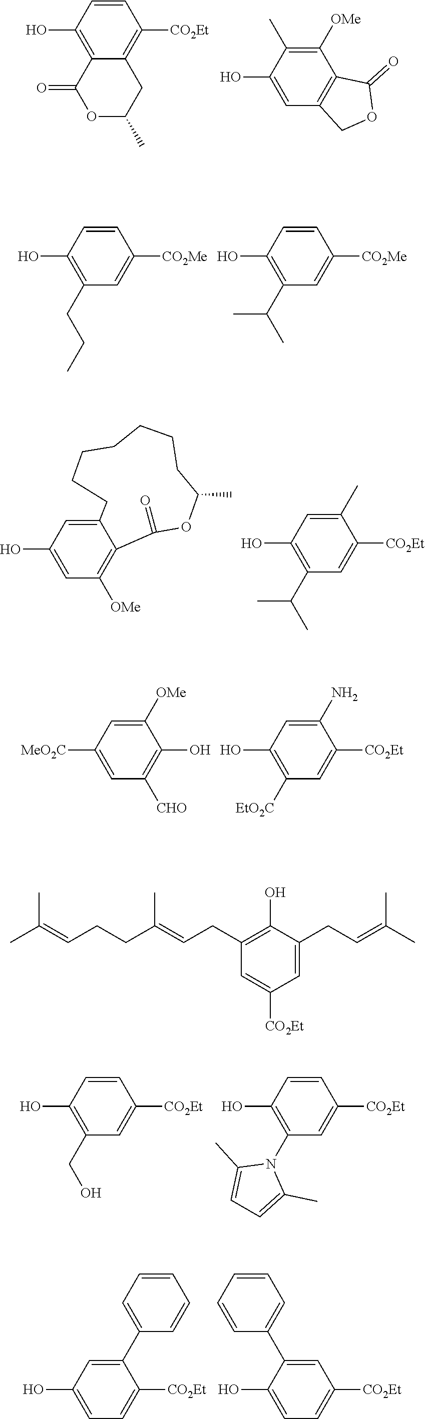

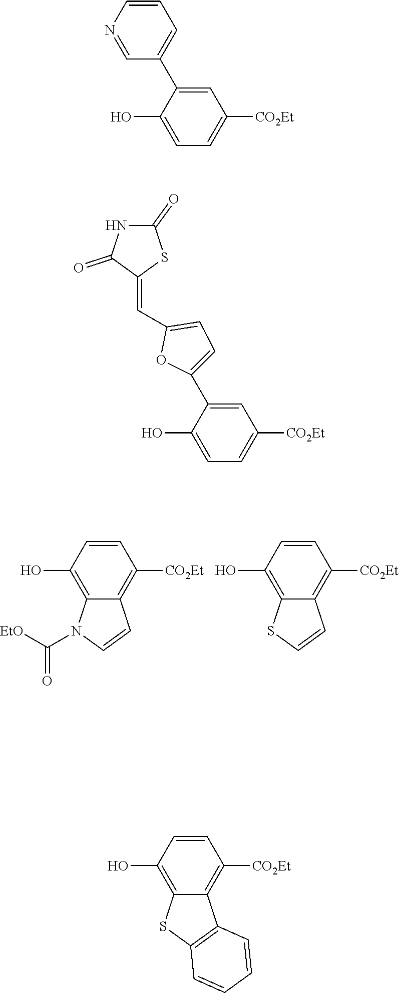 [SMILES: CCOC(=O)c1ccc(O)c(-c2cccnc2)c1 ; CCOC(=O)c1ccc(O)c(-c2ccc(/C=C3\SC(=O)NC3=O)o2)c1 ; CCOC(=O)c1ccc(O)c2c1ccn2C(=O)OCC ; CCOC(=O)c1ccc(O)c2sccc12 ; CCOC(=O)c1ccc(O)c2sc3ccccc3c12]

Examples of other forms of the compound having a phenolic hydroxyl group include a compound (hereinafter, also called “compound F”) having only a residue that remains after one or more hydrogen atoms excluding a hydrogen atom in a hydroxyl group are removed from the compound represented by Formula (1F) as a 6-membered aromatic ring group substituted with two or more hydroxyl groups and a compound represented by Formula (1G) (hereinafter, also called “compound G”).

(Compound F)

The compound F is a compound having only a residue (hereinafter, also called “residue of Formula (1F)”) that remains after one or more hydrogen atoms excluding a hydrogen atom in a hydroxyl group are removed from the compound represented by Formula (1F) as an aromatic ring group substituted with two or more hydroxyl groups.

The compound F has at least one residue of Formula (1F).

The compound F may have only one residue of Formula (1F) or two or more residues of Formula (1F).

In a case where the compound F has two or more residues of Formula (1F), the residues of Formula (1F) may be directly bonded to each other, or the plurality of residues of Formula (1F) may be bonded to each other through a linking group.

The compound F may or may not be a polymer.

The molecular weight of the compound F which is not a polymer is preferably 110 to 2,000 and more preferably 120 to 1,500.

The total number of residues of Formula (1F) that the compound F which is not a polymer has is preferably 1 to 10, and more preferably 1 to 6.

It is preferable that the compound F which is a polymer has a repeating unit having the residue of Formula (1F). The weight-average molecular weight of the compound F which is a polymer is, for example, preferably 1,000 to 1,000,000, and more preferably 5,000 to 1,000,000.

In the present specification, a weight-average molecular weight (Mw) is defined as a value expressed in terms of polystyrene by Gel Permeation Chromatography (GPC).

In a case where compound F has two or more residues of Formula (1F), the plurality of residues of Formula (1F) may be the same as or different from each other.

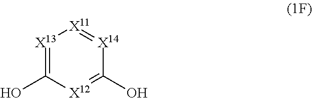

In Formula (1F), X¹¹ represents —C(OH)═, a nitrogen atom, or —CR¹¹═.

X¹² to X¹⁴ each independently represent —CR¹¹═ or a nitrogen atom.

R¹¹ represents a substituent other than a hydroxyl group or a hydrogen atom.

As X¹¹, —C(OH)═ or —CR¹¹═ is preferable, and —C(OH)═ is more preferable.

As X¹² to X¹⁴, —CR¹¹═ is preferable.

In a case where the compound has a plurality of structures represented by the plurality of R¹¹'s may be the same or different from each other.

In the present specification, “substituent other than a hydroxyl group” just needs to be a substituent other than “—OH”, and this substituent may have a hydroxyl group as a substituent contained in the substituent. For example, “substituent other than a hydroxyl group” represented by R¹¹ may be —CH₂(OH).

Examples of the substituent represented by R¹¹ other than a hydroxyl group include an alkyl group, an alkoxy group, an aryl group, and a heterocyclic group (such as a non-aromatic heterocycle and an aromatic heterocycle, the heteroatom is preferably a nitrogen atom, a sulfur atom, or an oxygen atom, specifically, a pyrylium ring, a benzopyrylium ring, a chromanone ring, a pyridyl group, a pyrimidyl group, a pyrazyl group, an oxazolyl group, an imidazolyl group, a pyrazolyl group, a thiazolyl group, a triazinyl group, a quinolyl group, an isoquinolyl group, a quinoxalyl group, a cinnolyl group, a pteridyl group, and the like), a halogen atom (such as a fluorine atom, a chlorine atom, a bromine atom, and an iodine atom), a nitro group, a sulfo group, a phosphoric acid group, a cyano group, an amino group, an alkali metal oxy group (such as a sodium oxy group and a potassium oxy group), a sulfonate group (such as a sodium sulfonate group), a sugar group, a group having a vinylene group (*—C═C—*), a group having an ethynylene group (*—C≡C—*), a group having an ether group (*—O—*), a group having a thioether group (*—S—*), a group having an imino group (*—C(═N—*)—*), a group having an ester group (*—CO—O—* and *—O—CO—*), a group having carbonyl group (*—CO—*), a group having a phosphine oxide group (*—P(═O)(—*)₂), a group having a phosphonic acid ester group (*—P(═O)(—O— *)₂), a group having a phosphoric acid ester group (*—OP(═O)(—O—*)₂), a group having a sulfinyl group (*—S(═O)—*), a group having a sulfonyl group (*—SO₂—*), a group having an amide group (*—CO—N(—*)₂ and *—N(—*)—CO—*), a group having a sulfonamide group (*—SO₂—N(—*)₂ and *—N(—*)—SO₂—*), a group having an azo group (*—N═N—*), a group having a trialkoxysilyl group (*—Si(OR^{S1}₃)), a group having an ammonium group (*—N⁺(—*)₃), a group having a sulfonium group (*—S⁺(—*)₂), a group having a phosphonium group (*—P⁺(—*)₃), a group having an oxonium group (*—O⁺(—*)₂), a group having a carbonium group (*—C⁺(—*)₂), a group having a halonium group (*—X⁺—*; X is a halogen atom), and a group obtained by combining these.

* in the above groups represents a binding position.

In the above examples, R^{S1} represents an alkyl group. In a case where one group has a plurality of R^{S1}'s, the plurality of R^{S1}'s may be the same or different from each other.

In the examples, counterions of groups having an ionic group are not particularly limited, and examples thereof include a halide ion and the like.

Furthermore, in a case where these substituents can have a substituent, they may further have a substituent (the substituent is not particularly limited and may be a hydroxyl group).

The alkyl group in the above examples may be linear or branched or may have a cyclic structure. The number of carbon atoms in the alkyl group is preferably 1 to 20.

The number of carbon atoms in the aryl group in the above examples is preferably 6 to 15, more preferably 6 to 10, and even more preferably 6.

Particularly, R¹¹ is, for example, preferably a hydrogen atom or a substituent having a Hammett substituent constant σₚ higher than 0.

Regarding the Hammett substituent constant σₚ, Chem. Rev. 1991, 91, p 165-195 can be referred to.

Examples of the substituent having a Hammett substituent constant σₚ higher than 0 include the groups belonging to the following substituent T group. That is, R^{u} is preferably a hydrogen atom or any of the substituents belonging to the substituent T group.

(Substituent T Group)

Examples of the substituent T include an alkoxycarbonyl group, a carboxyl group, a halogen atom, a phosphoric acid group, a perfluoroalkyl group, a perfluoroaryl group, a perfluoroalkyloxy group, an alkanesulfonyl group, an alkanesulfonyloxy group, an arylsulfonyl group, an arylsulfonyloxy group, a nitro group, a cyano group, a formyl group, an alkylsulfinyl group, an arylsulfinyl group, a heteroarylsulfinyl group, an aryl azo group, a heteroaryl azo group, a trialkoxysilyl group, —CO—R^{S2}, —O—CO—R^{S2}, —CO—NR^{S2}₂, —SO₂—NR^{S2}, —NR^{S2}(SO₂R^{S2}), —N(SO₂R^{S2})₂, —SO₂—NR^{S2}₂, —C(═NR^{S2})R^{S2}, —P(═O)(OR^{S2}₂), —C≡CR^{S3}, —N⁺R^{S2}₃, —S*R^{S2}₂, —P⁺R^{S2}₃, —O⁺R^{S2}₂, —C⁺R^{S2}₂, —X⁺R^{S2}, a heteroaryl group (for example, a pyridyl group, a pyrimidyl group, a pyrazyl group, an oxazolyl group, an imidazolyl group, a pyrazolyl group, a thiazolyl group, a triazinyl group, a quinolyl group, an isoquinolyl group, a quinoxalyl group, a cinnolyl group, or a pteridyl group which is bonded to the aromatic ring in the formula at a position where σₚ>0), and a group obtained by combining these.

In the substituent T group, R^{S2} represents a hydrogen atom or a substituent. R^{S2} is preferably an alkyl group, an aryl group, or a heteroaryl group. Here, even though the substituent represented by R^{S2} is bonded to a group, σₚ of the group does not become equal to or lower than 0. In a case where one group has a plurality of R^{S2}'s, the plurality of R^{S2}'s may be the same as or different from each other.

In the substituent T group, R^{S3} represents a hydrogen atom, an alkyl group, an aryl group, or a heteroaryl group. In a case where one group has a plurality of R^{S3}'s, the plurality of R^{S3}'s may be the same as or different from each other.

For example, just as —CH═CH—C(═O)—O—CH₂CH₃ (σₚ=0.03), it is preferable that the substituent having a Hammett substituent constant σₚ higher than 0 is bonded to another substituent (for example, any of the substituents belonging to the substituent T group) having a Hammett substituent constant σₚ higher than 0 through a conjugate group such as a vinylene group, an ethynylene group, an imino group, an azo group, an aryl group, or a heteroaryl group.

The alkyl group belonging to the substituent T group may be linear or branched or may have a cyclic structure. The number of carbon atoms in the alkyl group is preferably 1 to 20.

The number of carbon atoms in the aryl group belonging to lire substituent T group is preferably 6 to IS, more preferably 6 to 10, and even more preferably 6.

In a case where these substituents can further have a substituent, they may further have a substituent.

In the substituent T group, an alkoxycarbonyl group, —CO—NR^{S2}₂, —SO₂—NR^{S2}₂, an acyl group, an alkanesulfonyl group, an arylsulfonyl group, an aryl azo group, a heteroaryl azo group, a cyano group, a formyl group, or a carboxyl group is preferable, an alkoxycarbonyl group, —CO—NR^{S2}₂, an aryl azo group, or a carboxyl group is more preferable, and an alkoxycarbonyl group, —CO—NR^{S2}₂, an aryl azo group, or a carboxyl group is even more preferable.

The compound represented by Formula (1F) is preferably a compound in which at least one of X¹¹, X¹², X¹³, or X¹⁴ is —CR¹¹═, and at least one R¹¹ in the structures represented by —CR¹¹═ is a hydrogen atom or a substituent having a Hammett substituent constant σₚ higher than 0.

The compound represented by Formula (1F) is mote preferably a compound in which at least one of X¹¹, X¹², X¹³ or X¹⁴ represents —CR¹¹═ having R¹¹ that is a substituent having a Hammett substituent constant σₚ higher than 0.

The compound represented by Formula (1F) is preferably a compound in which all the substituents represented by R¹¹ other than a hydroxyl group are substituents having a Hammett substituent constant σₚ higher than 0.

In a case where one compound represented by Formula (1F) has a plurality of R¹¹'s, the plurality of R¹¹'s (for example, R^{u}, s adjacent to each other in a case where X¹¹ and X¹³ represent —CR¹¹═, and R¹¹'s adjacent to each other in a case where X¹¹ and X¹⁴ represent —CR¹¹═) may be linked to each other to form a ring.

The ring formed in this way may be an aromatic ring (for example, an aromatic hydrocarbon ring and an aromatic heterocycle) or a non-aromatic ring (for example, a non-aromatic hydrocarbon ring and a non-aromatic heterocycle).

Furthermore, the formed ring may be a monocyclic ring or a polycyclic ring.

The formed ring is preferably a 5- or 6-membered monocyclic ring or a polycyclic ring as a combination of the monocyclic rings. In a case where each ring is a heterocycle, the number of heteroatoms is preferably 1 to 5.

Examples of the heteroatom of the heterocycle include a nitrogen atom, a sulfur atom, an oxygen atom, a selenium atom, a tellurium atom, a phosphorus atom, a silicon atom, and a boron atom. Among these, a nitrogen atom, a sulfur atom, or an oxygen atom is preferable.

The ring formed in this way forms a fused ring structure by being fused with the aromatic ring in the formula.

Examples of the fused ring structure formed in this way by the compound represented by Formula (1F) include an anthraquinone ring, a benzopyrylium ring, a xanthone ring, a chromanone ring, and a quinoline ring which are formed by the bonding of two hydroxyl groups to the aromatic ring in the formula at meta position.

Furthermore, usnic acid, bergenin, and the like can also be used as the compound represented by Formula (1F) forming a (used ring structure.

As long as the requirements of the present invention are satisfied, the formed ring may further have a substituent (group exemplified as the substituent represented by R¹¹).

Particularly, tire compound represented by Formula (1F) is preferably a compound represented by Formula (P).

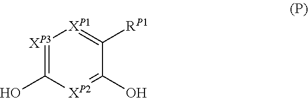

In Formula (P), R^{P1} represents a hydrogen atom or a substituent having a Hammett substituent constant σₚ higher than 0.

X^{P1} represents —C(OH)═, a nitrogen atom, or —CR^{P2}═.

X^{P2} and X^{P3} each independently represent a nitrogen atom or —CR^{P2}═.

R^{P2} represents a substituent other than a hydroxyl group or a hydrogen atom, and has the same definition as R^{u} described above. Examples of R^{P2} include the groups (for example, a hydrogen atom, a substituent having a Hammett substituent constant σₚ higher than 0, an alkyl group, and an alkoxy group) exemplified above as groups that can be adopted as R¹¹. Among these, a hydrogen atom or a substituent having a Hammett substituent constant σₚ higher than 0 is preferable.

In a case where X^{P1} represents —CR^{P2}═, R^{P2} and R^{P1} may be bonded to each other to form a ring. Furthermore, R^{P2}'s may be bonded to each other to form a ring. For instance, in a case where X^{P1} and X^{P3} represent —CR^{P2}═, two R^{P2}'s may be bonded to each other to form a ring. Examples of the aspect in which R^{P2}'s form a ring include the aspect described above in which a plurality of Rⁿ's in Formula (1F) is bonded to each other to form a ring.

Details of the substituent having a Hammett substituent constant σₚ higher than 0 are as described above. Examples of this substituent include any of the substituents belonging to the substituent T group.

Particularly, the compound represented by Formula (1F) is more preferably a compound represented by Formula (3F).

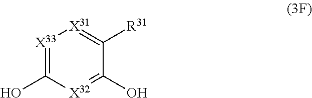

In Formula (3F), R³¹ represents a substituent having a Hammett substituent constant σₚ higher than 0.

X³¹ represents —C(OH)═, a nitrogen atom, or —CR³²═.

X³² and X³³ each independently represent a nitrogen atom or —CR³²═.

R³² represents a hydrogen atom or a substituent having a Hammett substituent constant σₚ higher than 0.

R³¹ and R³² may be bonded to each other to form a ring. For example, in a case where X³¹ represents —CR³²═, R³² and R³¹ may be bonded to each other to form a ring. Furthermore, R³²'s may be bonded to each other to form a ring. For example, in a case where X³¹ and X³³ represent —CR³²═, two R³²'s may be linked to each other to form a ring. Examples of the aspect in which R³²'s form a ring include the aspect described above in which a plurality of R¹¹'s in Formula (1F) is bonded to each other to form a ring.

The compound represented by Formula (1F) turns into a residue (residue of Formula (1F)) after one or more hydrogen atoms excluding a hydrogen atom in a hydroxyl group are removed from the compound represented by Formula (1F). Therefore, at least one of X¹¹. X¹², X¹³, or X¹⁴ is preferably —CR¹¹═ having R¹¹ from which a hydrogen atom is to be removed. That is, at least one of X¹¹, X¹², X¹³, or X¹⁴ preferably represents —CR¹¹═ in which R¹¹ is a hydrogen atom or a group having a hydrogen atom. In other words, in the compound A, the compound represented by Formula (1F) is preferably a compound having one or more hydrogen atoms in addition to the hydroxyl group directly bonded to the aromatic ring in the formula. The same is true of Formulas (P) and (3F) described above.

In the compound F, “group other than the residue of Formula (1F)” to which “residue of Formula (1F)” is bonded is not particularly limited, and may be a hydrogen atom.

Here, in a case where the compound represented by Formula (1F) has —CH═ as —CR¹¹═ having R¹¹ from which a hydrogen atom is to be removed, it is preferable that “group other than the residue of Formula (1F)” bonded to the position where the hydrogen atom removed from —CH═ was is not a hydroxyl group (—OH).

Furthermore, in a case where the compound F has only one residue of Formula (1F), the compound represented by Formula (1F) preferably has only one —CR¹¹═ (preferably —CH═) having R¹¹ from which a hydrogen atom is to be removed.

In a case where the compound F has only one residue of Formula (1F), and the compound represented by Formula (1F) has —CH═ as —CR¹¹═ having R¹¹ from which a hydrogen atom is to be removed, specific examples of “group other than the residue of Formula (1F)” bonded to the position where the hydrogen atom removed from —CH═ was include R¹¹ described above, and the preferred range of “group other than the residue of Formula (1F)” is also the same as that of R¹¹ described above. Furthermore, “group other the residue of Formula (1F)” and another Rⁿ in Formula (1F) may be bonded to each other to form a ring. Examples of the aspect in which “group other the residue of Formula (1F)” and R¹¹ form a ring include the aspect described above in which a plurality of R¹¹'s in Formula (1F) is bonded to each other to form a ring.

In a case where the compound F has only one residue of Formula (1F), as the compound F, a compound represented by Formula (Q1) is preferable.

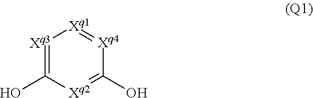

X^{q1} represents —C(OH)═, a nitrogen atom, or —CR^{q1}═. X^{q2} to X^{q4} each independently represent —CR^{q1}═ or a nitrogen atom.

R^{q1} represents a hydrogen atom or a substituent other than a hydroxyl group and a 6-membered aromatic ring group substituted with two or more hydroxyl groups.

The definition of the 6-membered aromatic ring group substituted with two or more hydroxyl groups will be specifically described later.

Examples of R^{q1} include a hydrogen atom and a substituent represented by R¹¹ other than a hydroxyl group (here, this substituent does not include a hydroxyl group and a 6-membered aromatic ring group substituted with two or more hydroxyl groups). R^{q1} is preferably a hydrogen atom or a substituent which is neither a hydroxyl group nor a 6-membered aromatic ring group substituted with two or more hydroxyl groups and has a Hammett substituent constant σₚ higher than 0.

As R^{q1}, a substituent selected from the substituent S group which will be described later or a hydrogen atom is preferable.

(Substituent S Group)

Examples of the substituent S include an alkoxycarbonyl group, a carboxyl group, a halogen atom, a phosphoric acid group, a perfluoroalkyl group, a perfluoroaryl group, a perfluoroalkyloxy group, an alkanesulfonyl group, an alkanesulfonyloxy group, an arylsulfonyl group, an arylsulfonyloxy group, a nitro group, a cyano group, a formyl group, an alkylsulfinyl group, an arylsulfinyl group, a heteroarylsulfinyl group, an aryl azo group, a heteroaryl azo group, a trialkoxysilyl group, —CO—R^{S4}, —O—CO—R^{S4}, —CO—NR^{S4}₂, —SO₂—NR^{S4}₂, —NR^{S4}(SO₂R^{S4}), —N(SO₂R^{S4})₂, —SO²—NR^{S4}₂, —C(═NR^{S4})R^{S4}, —P(═O)(OR^{S4}₂), —C≡CR^{S4}, —N⁺R^{S4}₃, —S⁺R^{S4}₂, —P⁺R^{S4}₃, —C⁺R^{S4}₂, —X⁺R^{S4}, a heteroaryl group (for example, a pyridyl group, a pyrimidyl group, a pyrazyl group, an oxazolyl group, an imidazolyl group, a pyrazolyl group, a thiazolyl group, a triazinyl group, a quinolyl group, an isoquinolyl group, a quinoxalyl group, a cinnolyl group, or a pteridyl group which is bonded to the aromatic ring in the formula at a position where σₚ>0), and a group obtained by combining these.

In the substituent S group, R^{S4} represents a hydrogen atom, an alkyl group, an aryl group, or a heteroaryl group. In a case where one group has a plurality of R^{S4}'s, the plurality of R^{S4}'s may be the same as or different from each other.

In a case where an alkyl group is contained in a group belonging to the substituent S group, the alkyl group may be linear or branched or may have a cyclic structure. The number of carbon atoms in the alkyl group is preferably 1 to 20.

In a case where a group belonging to the substituent S group has an aryl group, the number of carbon atoms in the aryl group is preferably 6 to 15, more preferably 6 to 10, and even more preferably 6.

In a case where these groups can further have substituents, they may have substituents (a hydroxyl group, groups exemplified above as the substituent represented by R¹¹ before the substituent T group, and the like, excluding a 6-membered aromatic ring group substituted with two or more hydroxyl groups).

In the substituent S group, an alkoxycarbonyl group, —CO—NR^{S4}, —SO₂—NR^{S4}₂, an acyl group, an alkancsulfonyl group, an arylsulfonyl group, an aryl azo group, a heteroaryl azo group, a cyano group, a formyl group, or a carboxyl group is preferable, an alkoxycarbonyl group, —CO—NR^{S4}₂, an aryl azo group, or a carboxyl group is more preferable, and an alkoxycarbonyl group, —CO—NR^{S4}₂, an aryl azo group, or a carboxyl group is even more preferable.

In a case where the compound has a plurality of structures represented by —CR^{q1}═, the plurality of R^{q1}'s may be the same or different from each other. The plurality of R^{q1}'s may be bonded to each other to form a ring.

Examples of the types of the formed ring include the rings described above as rings formed in a case where a plurality of R¹¹'s in Formula (1E) is linked to each other.

The aforementioned 6-membered aromatic ring group substituted with two or more hydroxyl groups may be a monovalent group or a group having a valency equal to or higher than 2. Examples of the ring constituting the 6-membered aromatic ring group include a 6-membered aromatic hydrocarbon ring and a 6-membered aromatic heterocycle. A group containing a 6-membered aromatic ring substituted with two or more hydroxyl groups as a part of the group also corresponds to the 6-membered aromatic ring group substituted with two or more hydroxyl groups.

As a compound represented by Formula (Q1), a compound represented by Formula (Q2) is preferable.

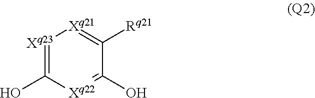

In Formula (Q2), R^{q21} represents a hydrogen atom or a substituent which is neither a hydroxyl group nor a 6-membered aromatic ring group substituted with two or more hydroxyl groups and has a Hammett substituent constant σₚ higher than 0.

As R^{q21}, a substituent selected from the substituent S group or a hydrogen atom is preferable. The definition and suitable aspect of the substituent S group are as described above.

X^{q21} represents —C(OH)═, a nitrogen atom, or —CR^{q22}═.

X^{q22} and X^{q23} each independently represent a nitrogen atom or —CR^{q22}═.

R^{q22} represents a hydrogen atom or a substituent which is neither a hydroxyl group nor a 6-membered aromatic ring group substituted with two or more hydroxyl groups. R^{q22} has the same definition as R^{q1} described above. Particularly, as R^{q22}, a hydrogen atom or a substituent which is neither a hydroxyl group nor a 6-membered aromatic ring group substituted with two or more hydroxyl groups and has a Hammett substituent constant σₚ higher than 0 is preferable, and a hydrogen atom or a substituent selected from the substituent S group is more preferable. The definition and suitable aspect of the substituent S group are as described above.

In a case where X^{q21} represents —CR^{q22}═, R^{q22} and R^{q21} may be bonded to each other to form a ring. Furthermore, R^{q22}, s may be bonded to each other to form a ring. For example, in a case where X^{q21} and X^{q23} represent —CR^{q22}═, two R^{q22}'s may be bonded to each other to form a ring. Examples of the types of the formed ring include the rings described above as rings formed in a case where a plurality of Rⁿ's in Formula (1F) is linked to each other.

In a case where the compound F has m pieces of the residue of Formula (1F), it is preferable that the compound F has m pieces of the 6-membered aromatic ring group substituted with two or more hydroxyl groups, m is a positive integer.

In a case where the compound F has two or more residues of Formula (1F), each of the residues of Formula (1F) is preferably a group represented by Formula (1-2F).

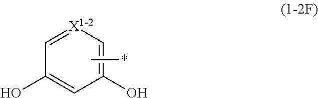

In Formula (1-2F), X¹⁻² represents —CR¹⁻²═, a nitrogen atom, or C(OH)═.

R¹² has the same definition as R¹¹ in Formula (1F).

* represents a binding position.

In a case where the compound F has two or more residues of Formula (1F), as the compound F, a compound represented by Formula (A1F) is preferable.

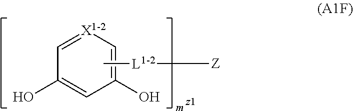

X¹⁻² in Formula (A1F) has the same definition as X¹⁻² in Formula (1-2F).

L¹⁻² represents a single bond or a divalent linking group. Examples of the divalent linking group include an ether group, a carbonyl group, an ester group, a thioester group, an amide group, a sulfonamide group, a thioether group, —SO₂—, and —NR^{A}— (R^{A} represents a hydrogen atom, an alkyl group, an aryl group, or a heteroaryl group), a divalent hydrocarbon group (for example, an alkylene group, an alkenylene group, an alkynylene group, and an arylene group), a heteroarylene group, an azo group, and a group obtained by combining these.

Particularly, L¹⁻² is preferably a single bond, an ester group (preferably an ester group represented by —CO—O— in which a carbon atom in the ester group is directly bonded to an aromatic ring in the formula), or an amide group (preferably an amide group represented by —CO—NH— in which a carbon atom in the amide group is directly bonded to an aromatic ring in the formula).

m^{z1} represents an integer equal to or greater than 2.

m^{z1} is preferably 2 to 10.

In a case where m^{z1} is 2, Z represents a single bond or a divalent linking group. In a case where m^{z1} is greater than 2, Z represents an m^{z1}-valent linking group.

Particularly, in a case where m^{z1} is 2, Z is preferably a single bond or a divalent linking group represented by the following formula. In the formula, Rx² represents a hydrogen atom, a halogen atom, or an alkyl group (the alkyl group may be linear or branched or may have a cyclic structure, and the number of carbon atoms in the alkyl group is preferably 1 to 20). Ar represents an arylene group (the number of carbon atoms in the arylene group is preferably 1 to 20, the arylene group is preferably a phenylene group, a naphthylene group, or an anthracenylene group, and more preferably an anthracenylene group). * represents a position bonded to L¹⁻².

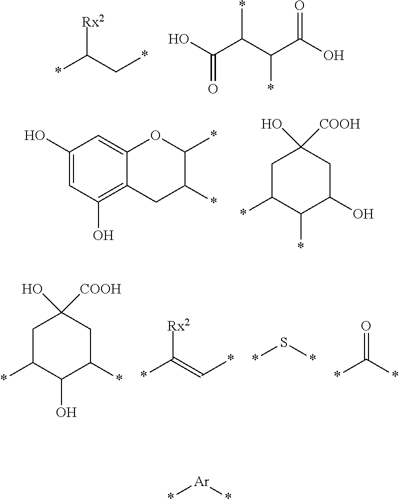

In a case where m^{z1} is 3, Z is preferably any of the trivalent linking groups represented by the following formula. In the formulas, Rx³ represents a hydrogen atom, a halogen atom, or an alkyl group (the alkyl group may be linear or branched or may have a cyclic structure, the number of carbon atoms in the alkyl group is preferably 1 to 20, and the alkyl group is more preferably a methyl group). * represents a position bonded to L¹⁻².

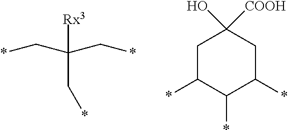

In a case where m^{z1} is 4, Z is preferably any of the tetravalent linking groups represented by the following formula. * represents a position bonded to L¹⁻².

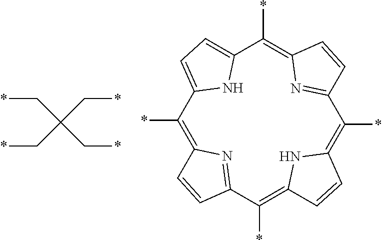

In a case where m^{z1} is 5, Z is preferably a pentavalent linking group represented by the following formula. * represents a position bonded to L¹⁻².

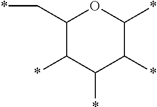 [SMILES: *CC1OC(*)C(*)C(*)C1*]

In a case where m^{z1} is 6, Z is preferably a hexavalent linking group represented by the following formula. * represents a position bonded to L¹⁻².

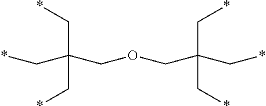 [SMILES: *CC(C*)(C*)COCC(C*)(C*)C*]

In a case where compound F is a polymer and has a repeating unit having the residue of Formula (1F), the compound F preferably has a repeating unit represented by the following formula.

The polymer may have a repeating unit other than the repeating unit represented by the following formula.

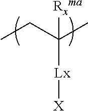

In the formula, Rx^{ma} represents a hydrogen atom, a halogen atom, an alkyl group (the alkyl group may be linear or branched or may have a cyclic structure, foe number of carbon atoms in the alkyl group is preferably 1 to 20, and foe alkyl group is more preferably a methyl group), or a perfluoroalkyl group (the perfluoroalkyl group may be linear or branched or may have a cyclic structure, foe number of carbon atoms in the perfluoroalkyl group is preferably 1 to 20, and the perfluoroalkyl group is more preferably a trifluoromethyl group).

Lx represents a single bond or a divalent linking group. The divalent linking group has the same definition as foe divalent linking group represented by L¹⁻².

X represents the residue of Formula (1F).

As described above, foe compound F has, as a 6-membered aromatic ring group substituted with two or more hydroxyl groups, only a residue remaining after one or more hydrogen atoms excluding a hydrogen atom in a hydroxyl group are removed from foe compound represented by Formula (1F).

That is, foe compound F has, as a 6-membered aromatic ring group substituted with two or more hydroxyl groups, only a 6-membered aromatic ring group in which some of foe hydroxyl groups are arranged in meta position with the rest of foe hydroxyl groups.

In other words, foe compound A does not have a 6-membered aromatic ring group substituted with two or more hydroxyl groups in which two hydroxyl groups are arranged in ortho or para position.

The 6-membered aromatic ring group also includes a 6-membered aromatic ring group incorporated into a polycyclic group. For example, the compound A does not have a residue which remains after one or more hydrogen atoms other than a hydrogen atom in a hydroxyl group are removed from 1,2-dihydroxynaphthalene, 1,4-dihydroxynaphthalene, or 1,2,4-trihydroxynaphthalene.

The 6-membered aromatic ring group in which two hydroxyl groups are arranged at ortho or para position turns into a quinone derivative by oxidation. In contrast, foe 6-membered aromatic ring group (residue of Formula (1F)) in which two hydroxyl groups are arranged at meta position is difficult to form a quinone derivative due to foe arrangement of the hydroxyl groups. Therefore, this group is chemically more stable than the 6-membered aromatic ring group in which two hydroxyl groups are arranged at ortho or para position. Accordingly, because the compound F has only the residue of Formula (1F) as the 6-membered aromatic ring group substituted with two or more hydroxyl groups, the storage stability of the liquid agent is improved. In a case where a substituent having a Hammett substituent constant σₚ higher than 0 is introduced into the 6-membered aromatic ring group (residue of Formula (1F)) in which two hydroxyl groups are arranged at meta position, the storage stability of the liquid agent is further improved.

(Compound G)

The compound G is a compound represented by Formula (2G). The compound G is also a 6-membered aromatic ring group in which all the hydroxyl groups are arranged at meta position. Therefore, this compound is chemically stable and has excellent storage stability.

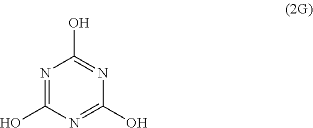

Examples of the compound F and the compound G will be shown below, but the compounds F and G are not limited thereto.

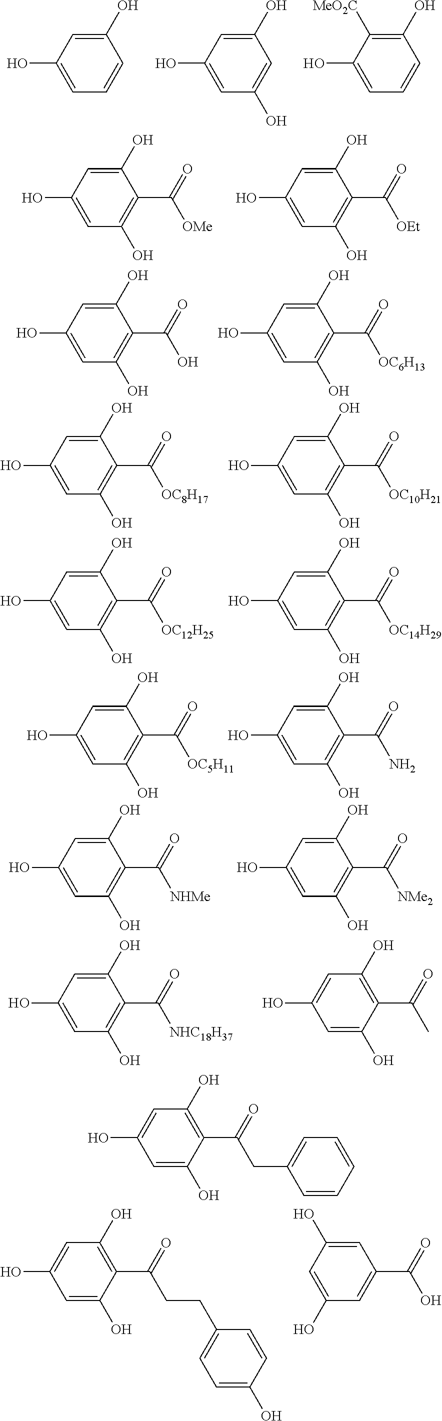

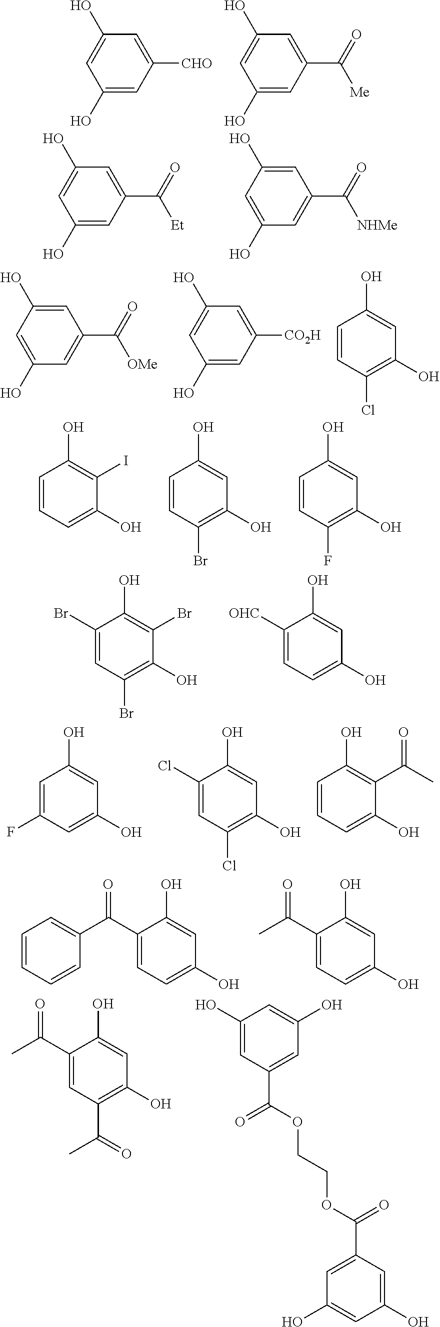

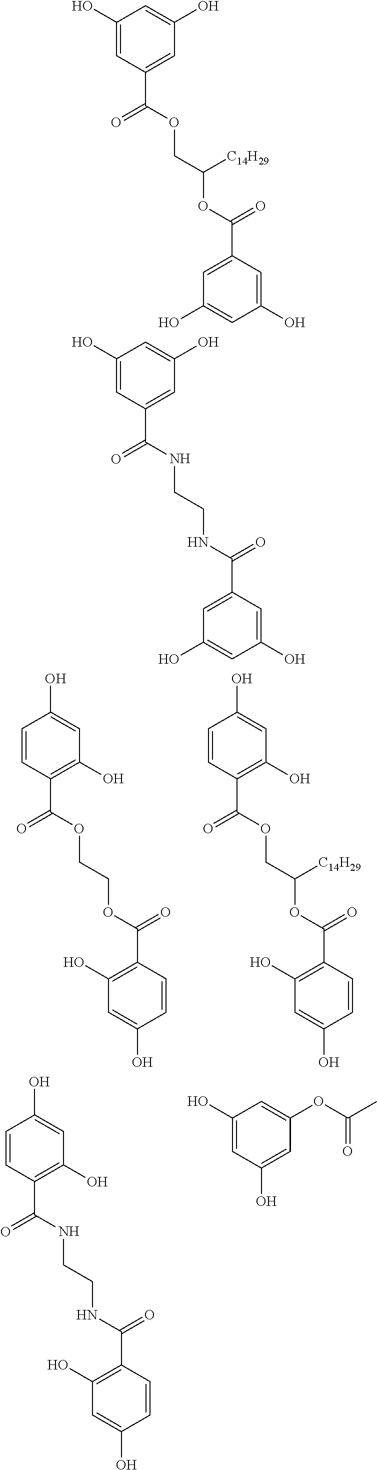

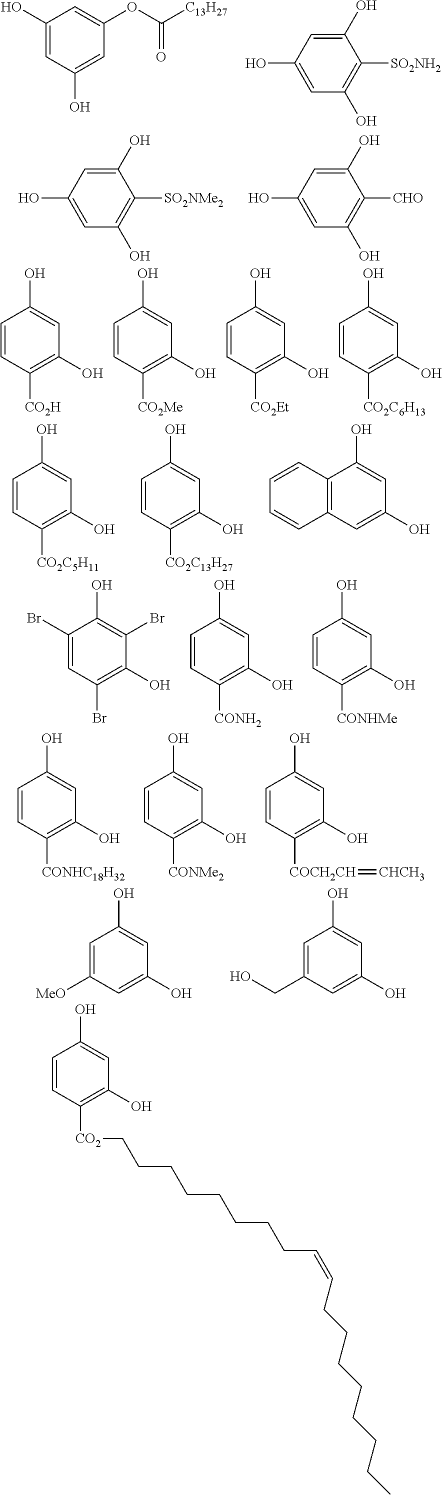

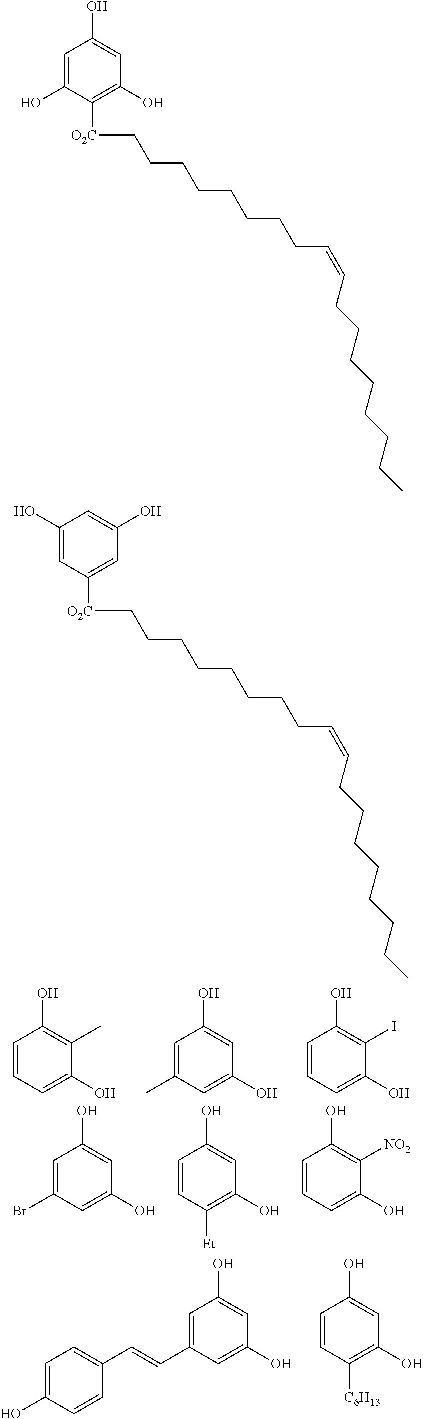

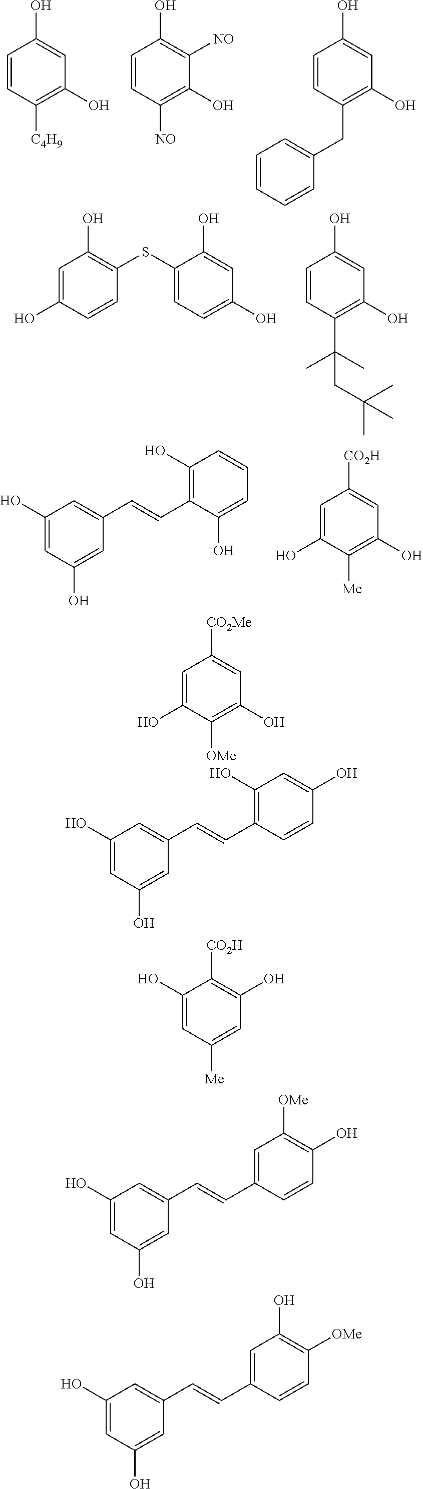

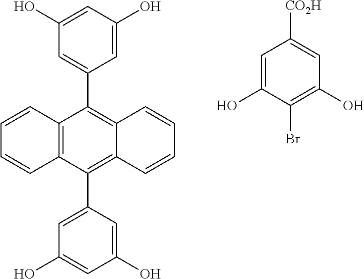 [SMILES: Oc1cc(O)cc(-c2c3ccccc3c(-c3cc(O)cc(O)c3)c3ccccc23)c1 ; O=C(O)c1cc(O)c(Br)c(O)c1]

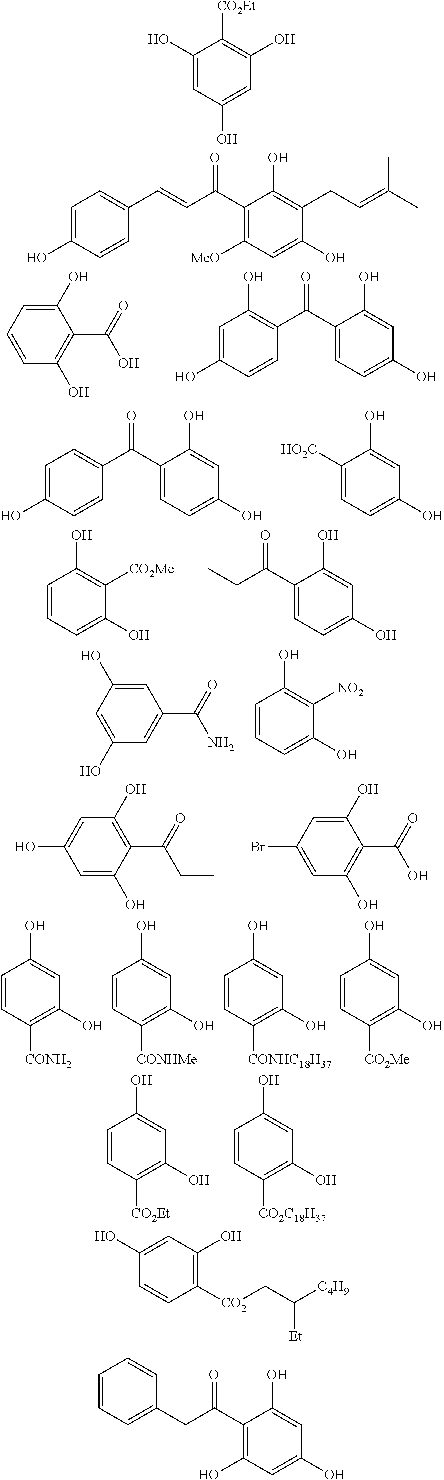

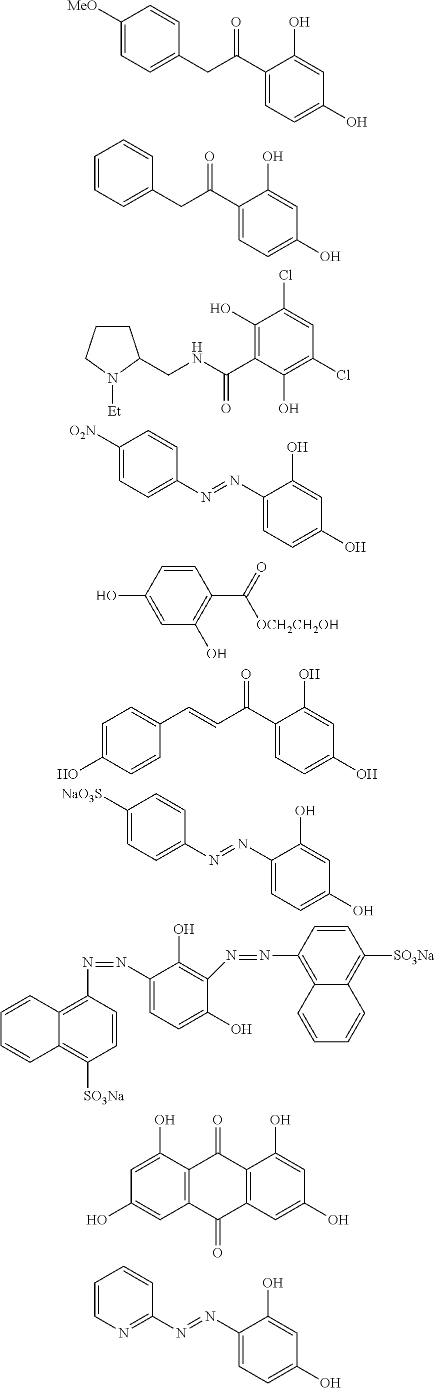

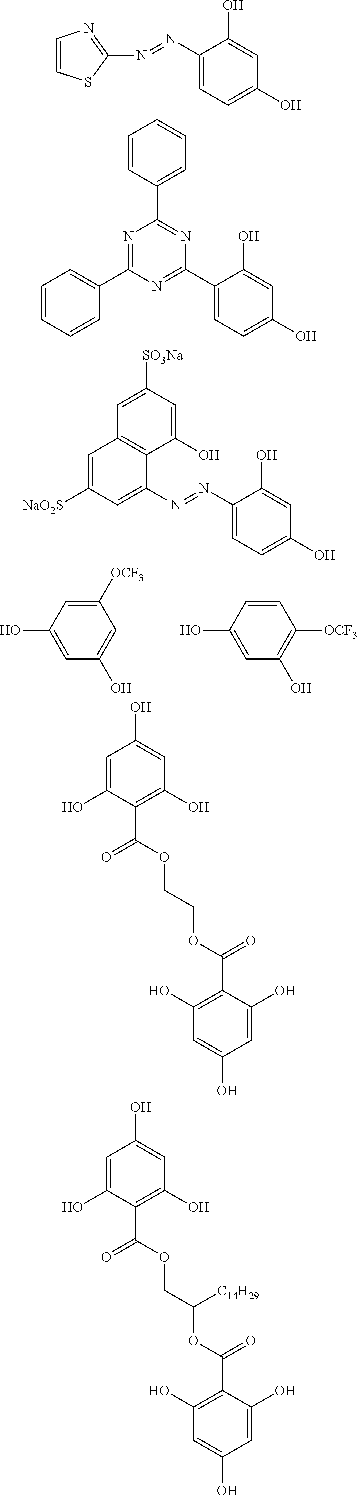

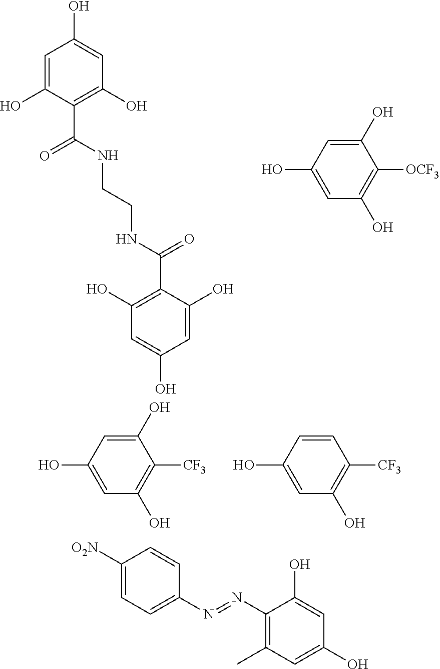

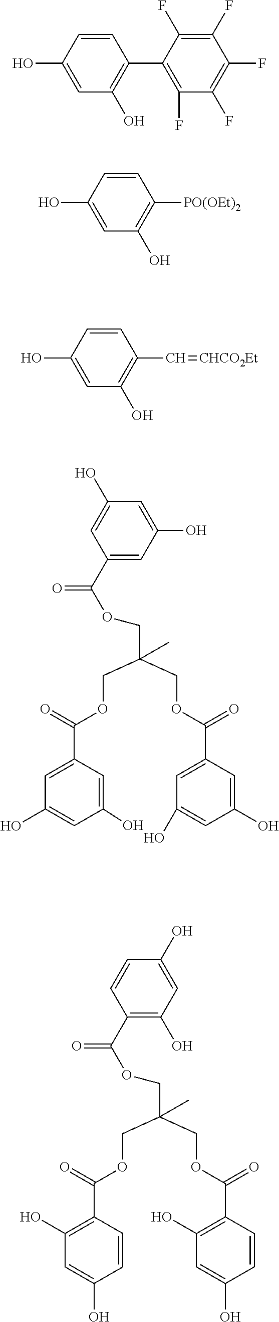

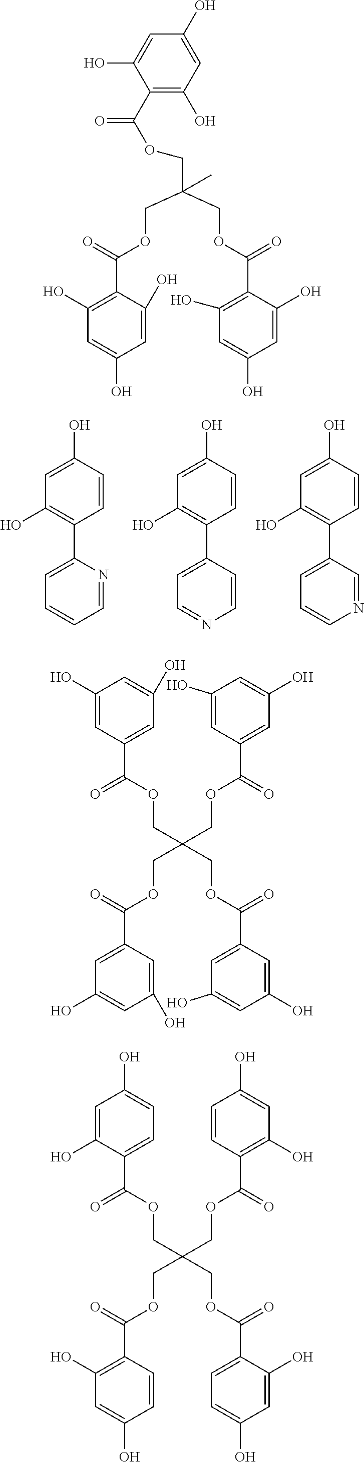

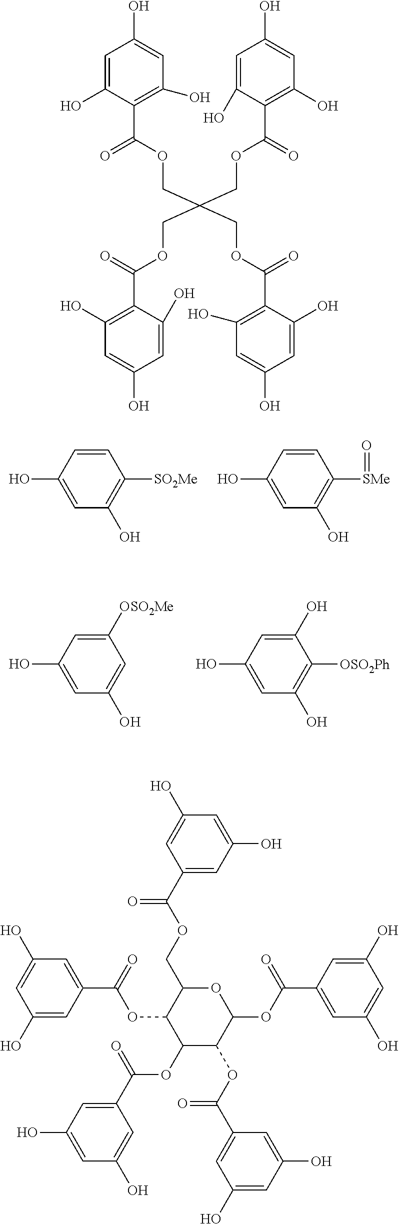

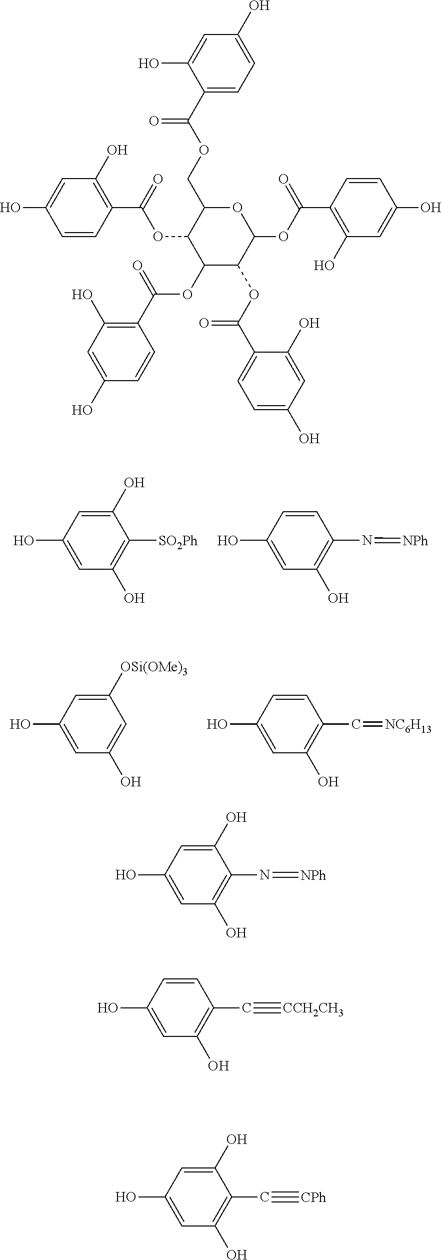

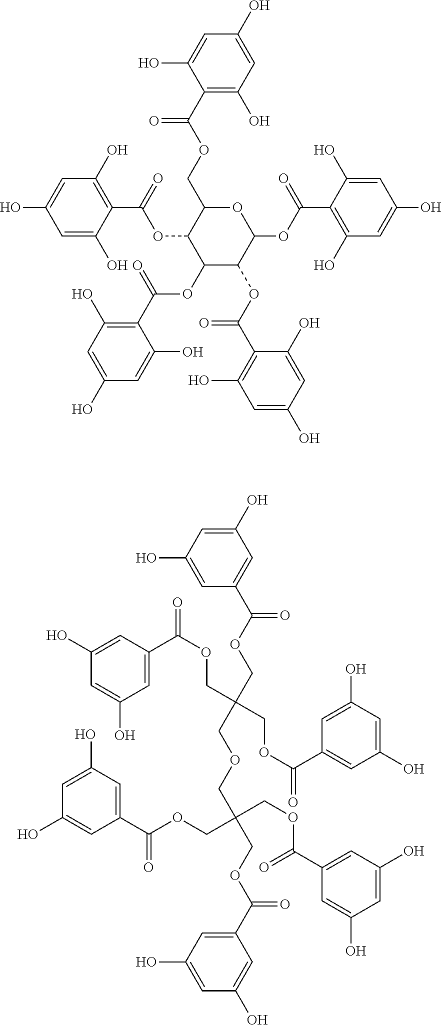 [SMILES: O=C(OCC1OC(OC(=O)c2c(O)cc(O)cc2O)[C@H](OC(=O)c2c(O)cc(O)cc2O)C(OC(=O)c2c(O)cc(O)cc2O)[C@@H]1OC(=O)c1c(O)cc(O)cc1O)c1c(O)cc(O)cc1O ; O=C(OCC(COCC(COC(=O)c1cc(O)cc(O)c1)(COC(=O)c1cc(O)cc(O)c1)COC(=O)c1cc(O)cc(O)c1)(COC(=O)c1cc(O)cc(O)c1)COC(=O)c1cc(O)cc(O)c1)c1cc(O)cc(O)c1]

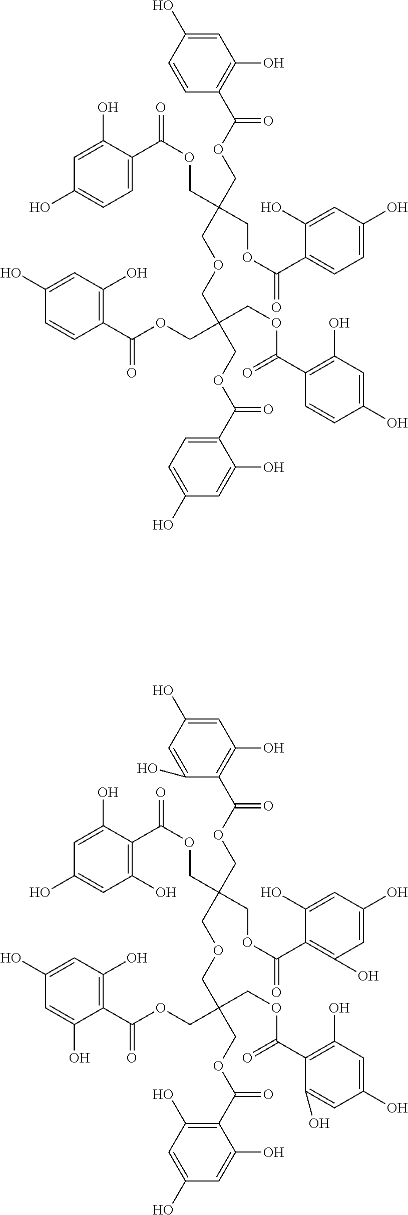 [SMILES: O=C(OCC(COCC(COC(=O)c1ccc(O)cc1O)(COC(=O)c1ccc(O)cc1O)COC(=O)c1ccc(O)cc1O)(COC(=O)c1ccc(O)cc1O)COC(=O)c1ccc(O)cc1O)c1ccc(O)cc1O ; O=C(OCC(COCC(COC(=O)c1c(O)cc(O)cc1O)(COC(=O)c1c(O)cc(O)cc1O)COC(=O)c1c(O)cc(O)cc1O)(COC(=O)c1c(O)cc(O)cc1O)COC(=O)c1c(O)cc(O)cc1O)c1c(O)cc(O)cc1O]

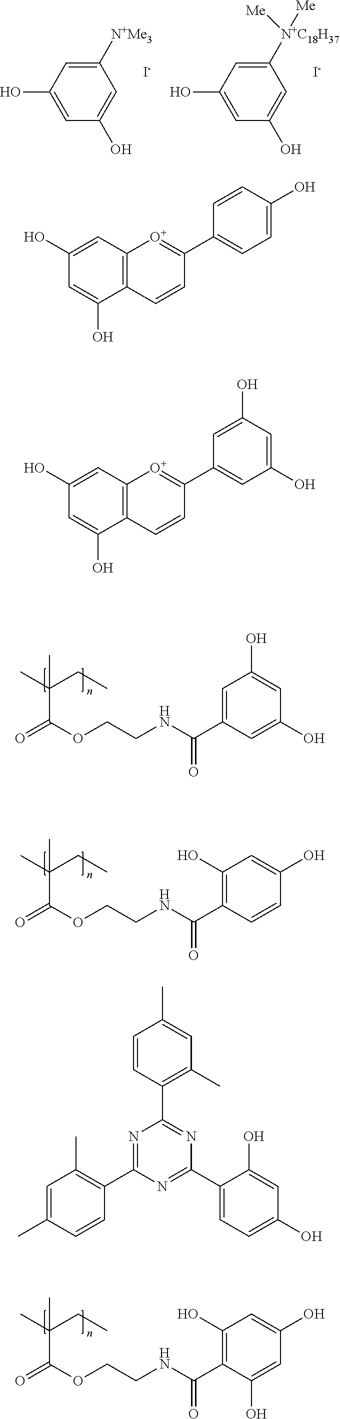

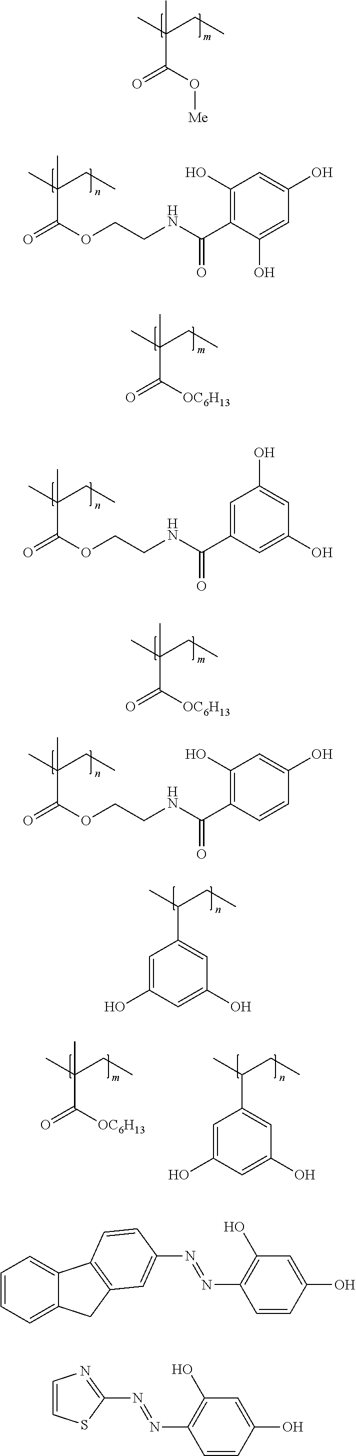

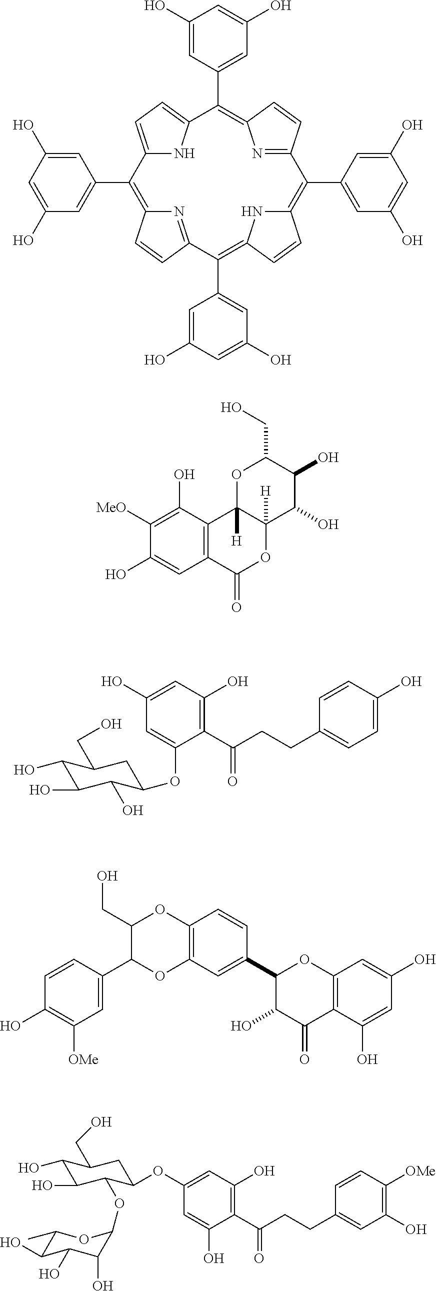

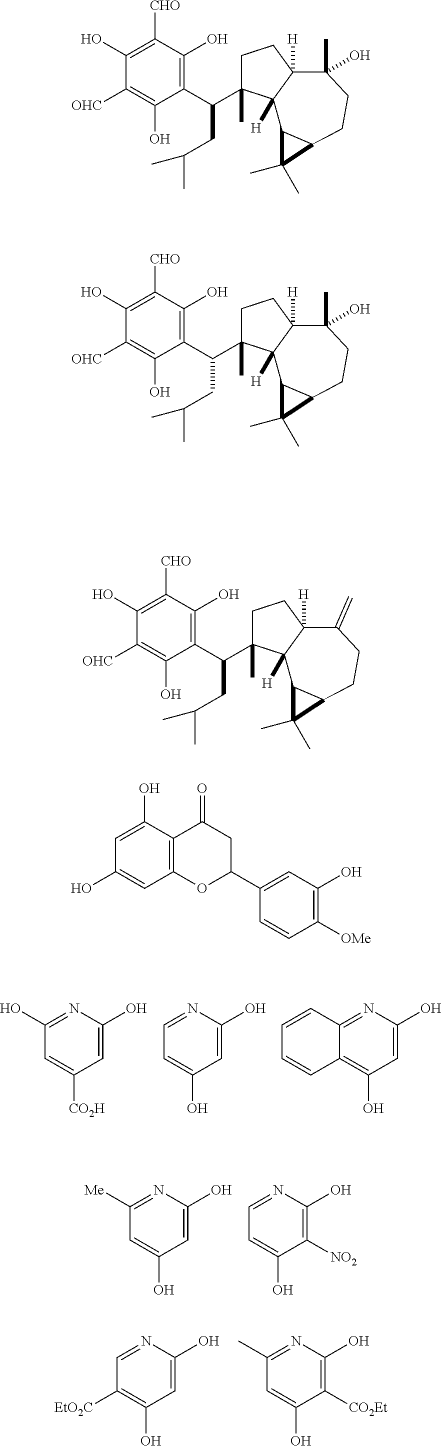

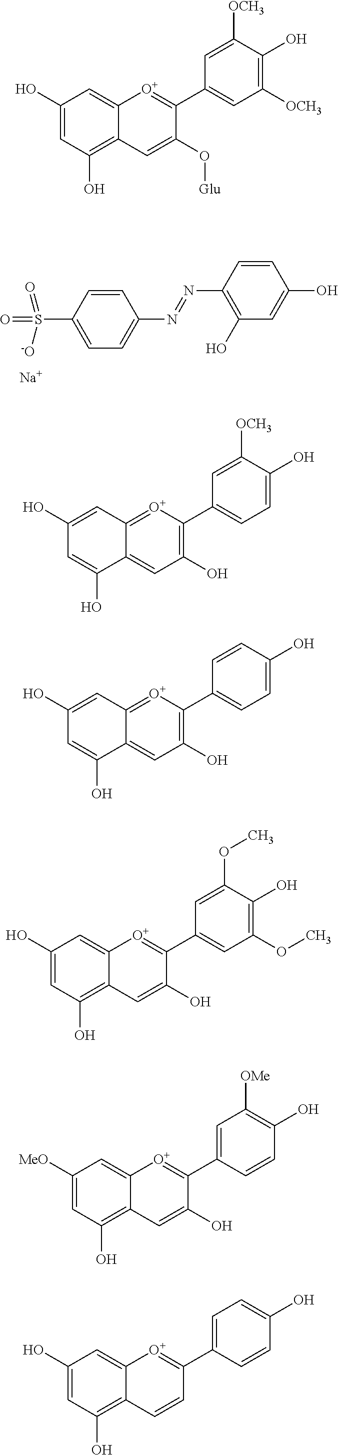

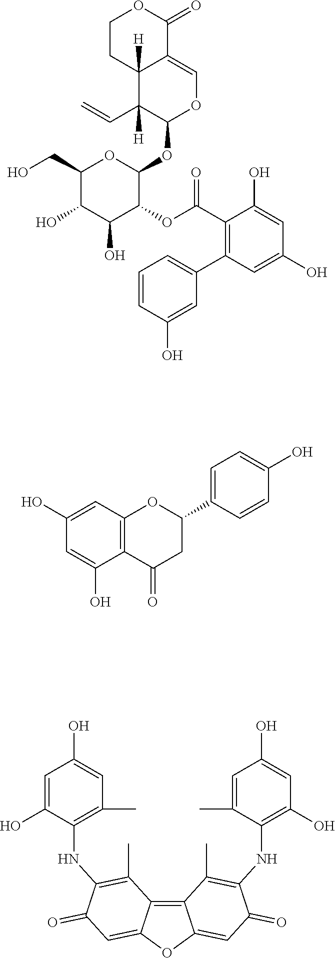

In the above compounds, Me represents a methyl group, Et represents an ethyl group, and Glu represents a glucose residue.

Examples of other forms of the compound having a phenolic hydroxyl group include the following compound represented by Formula (1H) and the following compound represented by a compound (2Ai).

(Compound Represented by Formula (1H))

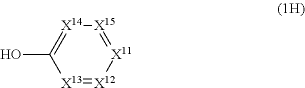

In Formula (1H), X¹¹ represents a nitrogen atom or —CR¹¹═.

R¹¹ represents a hydrogen atom or a monovalent substituent excluding a hydroxyl group and an alkoxycarbonyl group.

The monovalent substituent represented by R¹¹ is not particularly limited, and examples thereof include substituents (excluding a hydroxyl group and an alkoxycarbonyl group) exemplified below as substituents belonging to the following substituent group T2.

(Substituent Group T2)

Examples of substituents belonging to the substituent group T2 include an alkyl group (preferably an alkyl group having 1 to 20 carbon atoms), an alkenyl group (preferably an alkenyl group having 2 to 20 carbon atoms), an alkynyl group (preferably an alkynyl group having 2 to 20 carbon atoms), an aryl group (preferably an aryl group having 6 to 26 carbon atoms), a heteroaryl group (preferably a heteroaryl group having 2 to 20 carbon atoms, the heteroaryl group is more preferably a 5- or 6-membered heteroaryl group having at least one oxygen, sulfur, or nitrogen atom, examples of the heteroaryl group include a pyridyl group, a pyrimidyl group, a pyrazyl group, an oxazolyl group, an imidazoiyl group, a pyrazolyl group, a thiazolyl group, a triazinyl group, a quinolyl group, an isoquinolyl group, a quinoxalyl group, a cinnolyl group, a pteridyl group, and the like), an alkoxy group (preferably an alkoxy group having 1 to 20 carbon atoms), an aryloxy group (preferably an aryloxy group having 6 to 26 carbon atoms), a heteroaryloxy group (preferably a heteroaryloxy group having 2 to 20 carbon atoms, the heteroaryloxy group is more preferably a 5- or 6-membered heteroaryloxy group having at least one oxygen, sulfur, or nitrogen atom), an alkylthio group (preferably an alkylthio group having 1 to 20 carbon atoms), an arylthio group (preferably an arylthio group having 6 to 26 carbon atoms), a heteroarylthio group (preferably a heteroarylthio group having 2 to 20 carbon atoms, the heteroarylthio group is more preferably a 5- or 6-membered thioheteroaryl group having at least one oxygen, sulfur, or nitrogen atom), an aralkyl group (preferably an aralkyl group having 7 to 25 carbon atoms), an amino group (preferably an amino group having 0 to 20 carbon atoms, an alkylamino group, or an arylamino group, for example, amino, N,N-dimethylamino, N,N-diethylamino, N-ethylamino, anilino, and the like), a hydroxyl group, a sulfonic acid group, a carboxyl group, a phosphoric acid group, a halogen atom (preferably fluorine, chlorine, bromine, or iodine), a nitro group, a cyano group, a formyl group, a perfluoroalkyl group (preferably a perfluoroalkyl group having 1 to 20 carbon atoms), a perfluoroaryl group (preferably a perfluoroaryl group having 6 to 26 carbon atoms), a perfluoroalkyloxy group (preferably a perfluoroalkyloxy group having 1 to 20 carbon atoms), an alkoxycarbonyl group (—CO₂R¹¹¹). an acyl group (—COR¹¹²), an aryloxy group (—OCOR¹¹³), a sulfonamide group (—SO₂NR¹¹⁴R¹¹⁵), a phosphonic acid ester group (—PO(OR¹¹⁶)(OH) or —PO(OR¹¹⁷)₂), a trialkoxysilyl group (—Si(OR¹¹⁸)₃), an amide group (—CONR¹¹⁹R¹²⁰ or —NR¹²¹COR¹²²), an ammonium group (—N⁺R¹²³₃), a sulfonium group (—S⁺R¹²⁴R¹²⁵), a phosphonium group (—P⁺R¹²⁶R¹²⁷), an oxonium group (—O⁺R¹²⁸R¹²⁹), a carbonium group (—C⁺R¹³⁰R¹³¹), a halonium group (—X⁺R¹³²; X represents a halogen atom), an imino group (—C═NR¹³³), an alkanesulfonyl group (—SO₂R¹³⁴), an alkanesulfonyloxy group (—OSO₂R¹³⁵), an alkanesulfinyl group (—SOR¹³⁶), an aryl- or heteroarylsulfonyl group (—SO₂Ar), an aryl- or heteroarylsulfonyloxy group (—OSO₂Ar), an aryl- or heteroarylsulfinyl (—OSOAr), an aryl- or heteroaryl azo group (—N═N—Ar), and the like.

R¹¹¹ to R¹¹⁸ in the above groups each independently represent a monovalent substituent. Specifically, as the monovalent substituent represented by R¹¹¹ to R¹¹⁸, an aliphatic hydrocarbon group (the aliphatic hydrocarbon group may be linear, branched, or cyclic), an aryl group (preferably an aryl group having 6 to 26 carbon atoms), or a heteroaryl group (preferably a heteroaryl group having 2 to 20 carbon atoms, the heteroaryl group is more preferably a 5- or 6-membered heteroaryl group having at least one oxygen, sulfur, or nitrogen atom) Is preferable.

R¹¹⁹ to R¹³³ in the above groups each independently represent a hydrogen atom or a monovalent substituent.

Specific examples of the monovalent substituent represented by R¹¹⁹ to R¹³³ include the substituents exemplified above as the monovalent substituent represented by R¹¹¹ to R¹¹⁸.

R¹³⁴ to R¹³⁶ in the above groups each independently represent an aliphatic hydrocarbon group (the aliphatic hydrocarbon group may be linear, branched, or cyclic).

Ar in the above groups is an aryl group (preferably an aryl group having 6 to 26 carbon atoms) or a heteroaryl group (preferably a heteroaryl group having 2 to 20 carbon atoms, the heteroaryl group is more preferably a 5- or 6-membered heteroaryl group having at least one oxygen, sulfur, or nitrogen atom).

Furthermore, each of the groups exemplified as the substituent group T2, R¹¹⁹ to R¹³³, R¹³⁴ to R¹³⁶, and Ar may be further substituted with the groups exemplified above as the substituents belonging to the substituent group T2.

In a case where the above substituents are acidic groups or basic groups, salts thereof may be formed.

In a case where a compound, a substituent, a linking group, and the like contain an alkyl group, an alkylene group, an alkenyl group, an alkenylene group, an alkynyl group, an alkynylene group, and the like, these may be linear, branched, or cyclic or may be substituted or unsubstituted as described above.

Note that R¹¹ never represents a hydroxyl group and an alkoxycarbonyl group exemplified above as the substituents belonging to the substituent group T2. However, in a case where the hydroxyl group and the alkoxycarbonyl group exemplified above as the substituents belonging to the substituent group T2 form a substituent by being bonded to a residue that remains after one or more hydrogen atoms are removed from a substituents exemplified as the substituent belonging to the substituent group 12, the formed substituent is acceptable as a substituent represented by R¹¹.

As the monovalent substituent represented by R¹¹ in Formula (1H), an alkyl group (preferably an alkyl group having 1 to 20 carbon atoms), an alkenyl group (preferably an alkenyl group having 2 to 20 carbon atoms), an alkynyl group (preferably an alkynyl group having 2 to 20 carbon atoms), an alkoxy group (preferably an alkoxy group having 1 to 20 carbon atoms), a sulfonic acid group or a salt thereof, a carboxyl group or a salt thereof, a phosphoric acid group or a salt thereof a halogen atom (preferably fluorine, chlorine, bromine, or iodine), an acetal group, a nitro group, or an aryl- or heteroaryl azo group (—N—N—Ar) is preferable.

These groups may be further substituted with the groups exemplified above as substituents belonging to the substituent group T2. In a case where the alkyl group, alkenyl group, alkynyl group, or aryl- or heteroaryl azo group described above has a substituent, specific examples of the substituent include a hydroxyl group, an alkoxy group (preferably an alkoxy group having 1 to 20 carbon atoms), a sulfonic acid groups or a salt thereof, a carboxyl group or a salt thereof, a phosphoric acid group or a salt thereof, an amino group (preferably an amino group having 0 to 20 carbon atoms), and a halogen atom.

X¹² to X¹⁵ in the above formula each independently represent a nitrogen atom or —CR¹²═.

R¹² in the above formula represents a hydrogen atom or a monovalent substituent excluding a hydroxyl group.

The monovalent substituent represented by R¹² is not particularly limited, and examples thereof include the substituents (excluding a hydroxyl group) exemplified above as substituents belonging to the substituent group T2.

As the monovalent substituent represented by R¹² in Formula (1H), an alkyl group (preferably an alkyl group having 1 to 20 carbon atoms), an alkenyl group (preferably an alkenyl group having 2 to 20 carbon atoms), an alkynyl group (preferably an alkynyl group having 2 to 20 carbon atoms), an alkoxy group (preferably an alkoxy group having 1 to 20 carbon atoms), a sulfonic acid group or a salt thereof, a carboxyl group or a salt thereof, a phosphoric acid group or a salt thereof, a halogen atom (preferably fluorine, chlorine, bromine, or iodine), an acetal group, a nitro group, an amino group (preferably an amino group having 0 to 20 carbon atoms), or an aryl- or heteroaryl azo group (—N═N—Ar) is preferable.

These groups may be further substituted with the groups exemplified above as substituents belonging to the substituent group T2. in a case where the alkyl group, alkenyl group, alkynyl group, or aryl- or heteroaryl azo group described above has a substituent, specific examples of the substituent include a hydroxyl group (excluding a phenolic hydroxyl group), an alkoxy group (preferably an alkoxy group having 1 to 20 carbon atoms), a sulfonic acid group or a salt thereof a carboxyl group or a salt thereof, a phosphoric acid group or a salt thereof, and a halogen atom.

In a case where X¹³ or X¹⁴ represents —CR¹²═, R¹² is preferably a group other than a carboxyl group.

In addition, in Formula (1H), a plurality of R¹²'s may be linked to each other to form a ring structure, and R¹¹ and R¹² may be linked to each other to form a ring structure. In a case where the plurality of R¹²'s is linked to each other to form a ring structure, or in a case where R¹¹ and R¹² are linked to each other to form a ring structure, the ring structure may be an aromatic ring or a non-aromatic ring. Furthermore, the ring may contain a heteroatom.

The type of the heteroatom is not particularly limited, and examples thereof include an oxygen atom, a nitrogen atom, a sulfur atom, a selenium atom, and a tellurium atom. Particularly, in view of further improving the antiviral activity of the wiper, it is preferable that the heteroatom is incorporated into the compound in the form of —Y¹—, —N(Ra)—, —C(═Y²)—, —CON(Rb)-, —C(═Y³)Y⁴—, —SOt-, —SO₂N(Rc)-, or a group obtained by combining these.

Y¹ to Y⁴ are each independently selected from the group consisting of an oxygen atom, a sulfur atom, a selenium atom, and a tellurium atom. Among these, in view of greater ease of handling, an oxygen atom or a sulfur atom is preferable, t represents an integer of 1 to 3. Ra, Rb, and Rc in the above formula each independently represent a hydrogen atom, an alkyl group having 1 to 10 carbon atoms, an acyl group having 1 to 10 carbon atoms, an aryl groups having 6 to 16 carbon atoms, or a heteroaryl group having 2 to 13 carbon atoms.

Furthermore, in a case where a plurality of R¹²'s is linked to each other to form a ring structure, or R¹¹ and R¹² are linked to each other to form a ring structure, the ring structure may further have a substituent (for example, the substituent exemplified above as a substituent belonging to the substituent group T2).

In a case where there is a plurality of R¹²'s in Formula (1H), R¹²'s may be the same as or different horn each other.

Particularly, in view of high antiviral activity, the compound represented by Formula (1H) is preferably a compound in which X¹¹ represents —CR¹¹═ and X¹² to X¹⁵ all represent —CR¹²═ or a compound in which one or two out of X¹¹ to X¹⁵ represent a nitrogen atom and others represent —CR¹¹═ or —CR¹²═.

In addition, the compound represented by Formula (1H) is preferably a compound containing only one phenolic hydroxyl group.

(Compound (2Ai))

The compound (2Ai) is a compound having two or more residues (hereinafter, also called “residue of Formula (2i)”) that remain after one or two hydrogen atoms excluding a hydrogen atom in a hydroxyl group are removed from a compound represented by Formula (2i).

The compound (2Ai) may be a structure in which a plurality of residues of Formula (2i) is directly bonded to each other or a structure in which a plurality of residues of Formula (2i) is bonded to each other through a linking group. In addition, the plurality of residues of Formula (2i) in the compound (2Ai) may be the same as or different from each other.

The number of residues of Formula (2i) in the compound (2Ai) is not particularly limited, but is preferably 2 to 10,000.

The molecular weight of compound (2Ai) (weight-average molecular weight in a case where the compound has a molecular weight distribution) is not particularly limited, but is preferably 185 to 1,000,000 and more preferably 185 to 500,000. In a case where the compound (2Ai) is a polymer, the weight-average molecular weight (Mw) thereof is defined as a value expressed in terms polystyrene of by Gel Permeation Chromatography (GPC).

First, the residue of Formula (2i) will be described below.

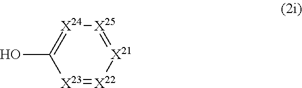

In Formula (2i), X²¹ represents a nitrogen atom or —CR²¹═. R²¹ represents a hydrogen atom or a monovalent substituent excluding a hydroxyl group.

The monovalent substituent represented by R²¹ is not particularly limited, and examples thereof include the substituents (excluding a hydroxyl group) exemplified above as the substituent group T.

X²² to X²⁵ each independently represent a nitrogen atom or —CR²²═. R²² represents a hydrogen atom or a monovalent substituent excluding a hydroxyl group.

The monovalent substituent represented by R²² is not particularly limited, and examples thereof include the substituents (excluding a hydroxyl group) exemplified above as substituents belonging to the substituent group T.

In Formula (2i), a plurality of R²²'s may be linked to each other to form a ring structure, and R²¹ and R²² may be linked to each other to form a ring structure. In a case where the plurality of R²²'s is linked to each other to form a ring structure, or in a case where R²¹ and R²² are linked to each other to form a ring structure, the ring structure may be an aromatic ring or a non-aromatic ring. Furthermore, the ring may contain a heteroatom.

The type of the heteroatom is not particularly limited, and examples thereof include an oxygen atom, a nitrogen atom, a sulfur atom, a selenium atom, and a tellurium atom.

In a case where there is a plurality of R²²'s in Formula (2i), R²²'s may be the same as or different from each other.

Particularly, in view of high antiviral activity, the compound represented by Formula (2i) is preferably a compound in which X²¹ represents —CR²¹— and X²² to X²⁵ all represent —CR²²═ or a compound in which one or two out of X²¹ to X²⁵ represent a nitrogen atom and others represent —CR²¹═ or —CR²²═.

The compound represented by Formula (2i) forms a residue by the removal of one or two hydrogen atoms excluding a hydrogen atom in a hydroxyl group specified in the formula. In other words, in the compound represented by Formula (2i), one or two out of X²¹ to X²⁵ represent —CH═, or one or two out of X²¹ to X²⁵ represent —CR²¹═ or —CR²²═ which is a group having a hydrogen atom. That is, the compound represented by Formula (2i) forms a residue by the removal of one or two hydrogen atoms.

The compound represented by Formula (2i) is preferably any of the following compounds.

Compound which has —CH═ represented by at least one or two out of X²¹, X²², X²³, X²⁴, or X²⁵ and forms a residue by the removal of a hydrogen atom from the one or two —CH═ structures.

Compound which has —CR²¹═ represented by —X²¹ and —CR²²═ represented by X²² and forms a residue by the removal of one or two hydrogen atoms from a ring structure formed in a case where R²¹ and R²² are linked to each other.

Compound which has —CR²²═ represented by both of —X²² and X²³ and forms a residue by the removal of one or two hydrogen atoms from a ring structure formed in a case where two R²²'s are linked to each other.

Among these, the compound which has —CH═ represented by at least one or two out of X²¹, X²², X²³, X²⁴, or X²⁵ and forms a residue by the removal of a hydrogen atom from the one or two —CH═ structures is more preferable as the compound represented by Formula (2i).

In addition, in view of further improving the antiviral properties of the liquid agent, it is preferable that the compound represented by Formula (2i) is not a glycoside.

Next, the compound (2Ai) will be described.

As described above, the compound (2Ai) may be a structure in which a plurality of residues of Formula (2i) is directly bonded to each other or a structure in which a plurality of residues of Formula (2i) is bonded to each other through a linking group.

In a case where the compound (2Ai) is a structure in which a plurality of residues of Formula (2i) is bonded to each other through a linking group, as the compound (2Ai), a compound represented by Formula (2A-1i), a compound represented by Formula (2A-2i), a compound represented by Formula (2A-3i), or a polymer having a repeating unit represented by Formula (2A-4i) is preferable.

(Compound Represented by Formula (2A-1i))

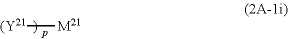

In Formula (2A-1i), Y²¹ represents a group represented by Formula (2-1i), a group represented by Formula (2-2i), or a group represented by Formula (2-3i). The group represented by Formula (2-1i), the group represented by Formula (2-2i), and the group represented by Formula (2-3i) are a residue formed from the compound represented by Formula (2i), in which at least one of X²¹, X²², X²³, X²⁴, or X²⁵ represents —CH═. This residue corresponds to a residue formed by the removal of a hydrogen atom from one —CH═ described above.

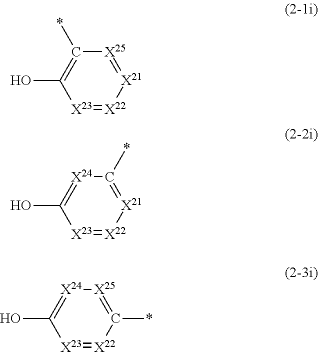

X²¹ to X²⁵ in the group represented by Formula (2-1i), the group represented by Formula (2-2i), and the group represented by Formula (2-3i) have the same definitions as X²¹ to X²⁵ in Formula (2i) described above.

In Formula (2A-1i), M²¹ represents a p-valent linking group. That is, Formula (2A-1i) corresponds to a compound having p pieces of group represented by Formula (2-1i), p pieces of group represented by Formula (2-2i), or p pieces of group represented by Formula (2-3i).

p represents an integer equal to or greater than 2. p is preferably 2 to 10, and more preferably 2 to 6.

The linking group represented by M²¹ is not particularly limited, and examples thereof include the following linking groups.

Divalent Linking Group

The divalent linking group represented by M²¹ is not particularly Limited. Examples of the divalent linking group include a divalent hydrocarbon group (the divalent hydrocarbon may be a divalent saturated hydrocarbon group or a divalent aromatic hydrocarbon ring group, the divalent saturated hydrocarbon group may be linear, branched, or cyclic and preferably has 1 to 20 carbon atoms, examples thereof include an alkylene group, the divalent aromatic hydrocarbon ring group preferably has 5 to 20 carbon atoms, examples thereof include a phenylene group, the divalent aromatic hydrocarbon ring group may also be an alkenylene group (preferably having 2 to 20 carbon atoms) or an alkynylene group (preferably having 2 to 20 carbon atoms)), a divalent heterocyclic group, —O—, —S—, —SO₂—, —NR^{A}—, —CO—, —(C═O)O—, and a group obtained by combining two or more groups described above. R^{A} represents a hydrogen atom, an alkyl group (preferably having 1 to 10 carbon atoms), an acyl group (preferably having 2 to 12 carbon atoms), an aryl group (preferably having 1 to 16 carbon atoms), or a heteroaryl group (preferably having 2 to 13 carbon atoms).

The heterocyclic ring and heteroaryl group described above are preferably a 5- to 7-membered ring and more preferably a 5- or 6-membered ring having at least one nitrogen, oxygen, sulfur, or selenium atom in the ring structure.

The divalent linking group may be further substituted. The substituent is not particularly limited, and examples thereof include the substituents exemplified above as substituents belonging to the substituent group T.

Linking Group Having Valency Equal to or Higher than 3

The linking group represented by M²ⁱ having a valency equal to or higher than 3 is not particularly limited, and examples thereof include a carbon atom, a silicon atom, a nitrogen atom, a p-valent aliphatic hydrocarbon ring, a p-valent aromatic hydrocarbon ring, and a p-valent heterocyclic ring.

The number of carbon atoms contained in the aliphatic hydrocarbon ring is preferably 3 to 15, more preferably 3 to 10, and even more preferably 5 to 10.

The number of carbon atoms contained in the aromatic hydrocarbon ring is preferably 6 to 18, more preferably 6 to 14, and even more preferably 6 to 10.

The heterocyclic ring is preferably a 5- to 7-membered ring and more preferably a 5- or 6-membered ring having at least one nitrogen, oxygen, sulfur, or selenium atom in the ring structure.

Specific examples of the linking group represented by M²¹ having a valency equal to or higher than 3 include groups represented by Formulas (M1) to (M11).

In Formulas (M1) to (M11), L²⁴ to L⁶⁹ each independently represent a single bond or a divalent linking group. The divalent linking group represented by L²⁴ to L⁶⁹ is not particularly limited, and examples thereof include the divalent linking group represented by M²¹ described above.

R^{B} represents a monovalent substituent. The monovalent substituent represented by

R^{B} is not particularly limited, and examples thereof include the substituents exemplified above as substituents belonging to the substituent group T.

q represents an integer of 1 to 3. q is more preferably 1 or 2.

* represents a position linked to Y²¹ described above.

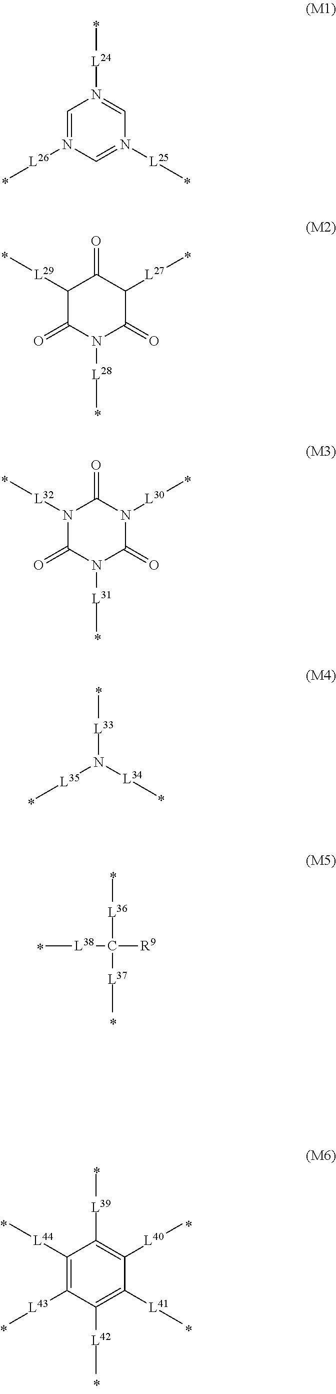

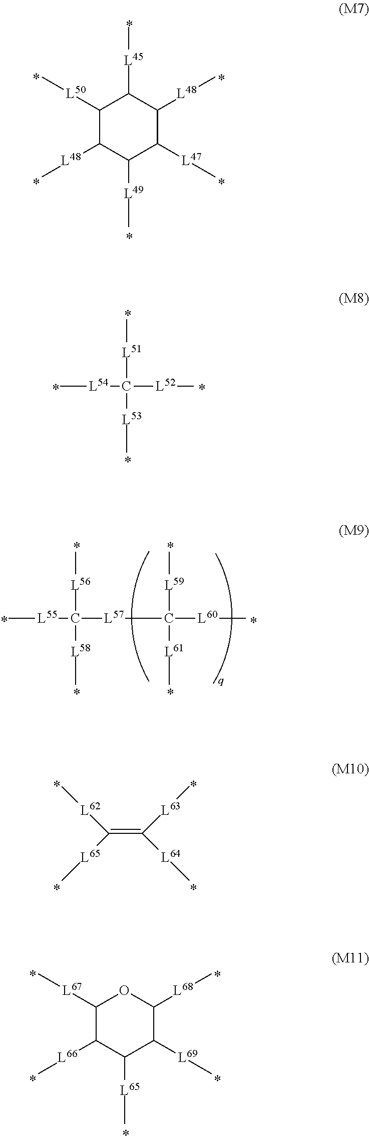

(Compound Represented by Formula (2A-2i))

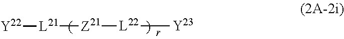

Y²² and Y²³ in Formula (2A-2i) have the same definition as Y²¹ in Formula (2A-1i).

L²¹ and L²² represent a single bond or a divalent linking group. The divalent linking group represented by L²¹ and L²² has the same definition as the divalent linking group represented by M²¹ in Formula (2A-1i). As L²¹ and L²², a divalent linking group is preferable, an alkylene group having 1 to 10 carbon atoms is more preferable, and an alkylene group having 1 to 3 carbon atoms is even more preferable.
Z²¹ is a residue formed from the compound represented by Formula (2i) in which at least two out of X²¹, X²², X²³, X²⁴, or X²⁵ represent —CH═. Z²¹ is preferably a residue formed by the removal of hydrogen atoms from the two —CH═ structures. Examples of the residue represented by Z²¹ include a group represented by Formula (2-4i).

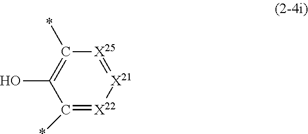

X²¹, X²², and X²⁵ in the group represented by Formula (2-4i) have the same definitions as X²¹ to X²⁵ in Formula (2i).

r represents an integer of 1 to 6. r is preferably 1 to 4, and more preferably 1 or 2.

(Compound Represented by Formula (2A-3i)

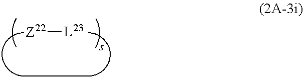

Z²² in Formula (2A-3i) has the same definition as Z²¹ in Formula (2A-2i), and the suitable aspect thereof is also the same.

L²³ represents a single bond or a divalent linking group. The divalent linking group represented by L²³ has the same definition as the divalent linking group represented by M²¹ in Formula (2A-1i). As L²³, a divalent linking group is preferable, an alkyl group having 1 to 10 carbon atoms is more preferable, and an alkyl group having 1 to 3 carbon atoms is even more preferable.

s represents an integer of 1 to 6. r is preferably 1 to 4, and more preferably 1 or 2.

(Polymer Having Repeating Unit Represented by Formula (2A-4i))

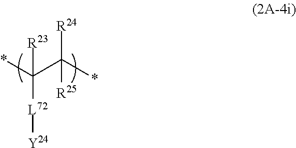

In Formula (2A-4i), R²³ to R²⁵ each independently represent a hydrogen atom or an alkyl group having 1 to 10 carbon atoms,

Y²⁴ has the same definition as Y²¹ in Formula (2A-1i).

L⁷² represents a single bond or a divalent linking group. The divalent linking group represented by L⁷² has the same definition as the divalent linking group represented by M²¹ in Formula (2A-1i). As L⁷², a single bond, —CO₂—, —CONR^{A}—, —O—, an alkylene group having 1 to 10 carbon atoms, or a divalent linking group obtained by combining these groups is preferable, and a single bond, —CO₂—, —CONR^{A}—, —O—, an alkylene group having 1 to 3 carbon atoms, or a divalent linking group obtained by combining these groups is more preferable. R^{A} in the above formula represents a hydrogen atom, an alkyl group (preferably having 1 to 10 carbon atoms), an aryl group (preferably having 6 to 10 carbon atoms), or a heteroaryl group (preferably having 2 to 13 carbon atoms). The heteroaryl group described above is preferably a 5- to 7-membered ring and more preferably a 5- or 6-membered ring having at least one nitrogen, oxygen, sulfur, or selenium atom in the ring structure.

The divalent linking group may be further substituted. The substituent is not particularly limited, and examples thereof include the substituents exemplified above as substituents belonging to the substituent group T2.

Examples of the compound having a phenolic hydroxyl group also include the following compounds. In the following example compounds, n and m represent a molar ratio.

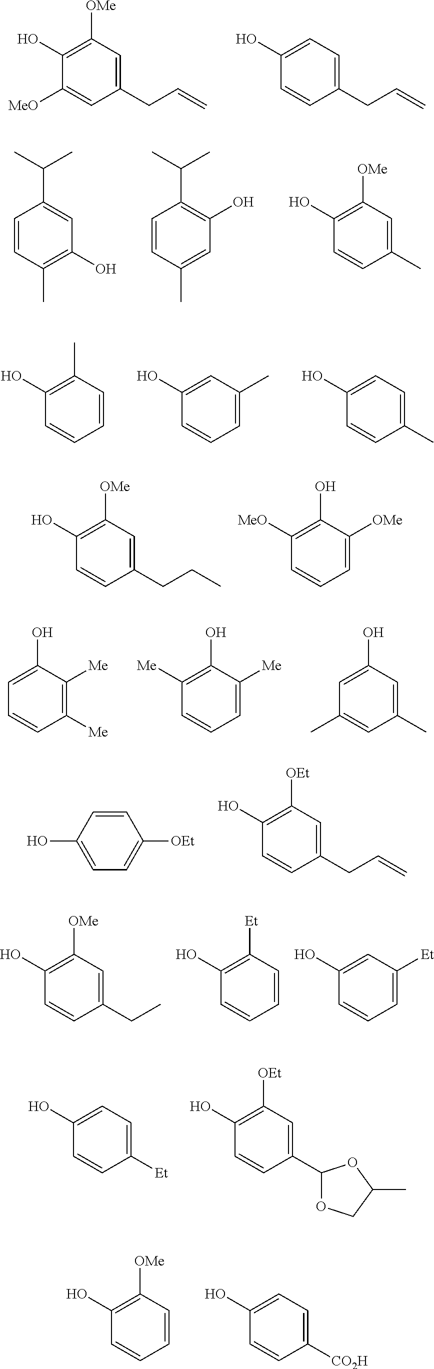

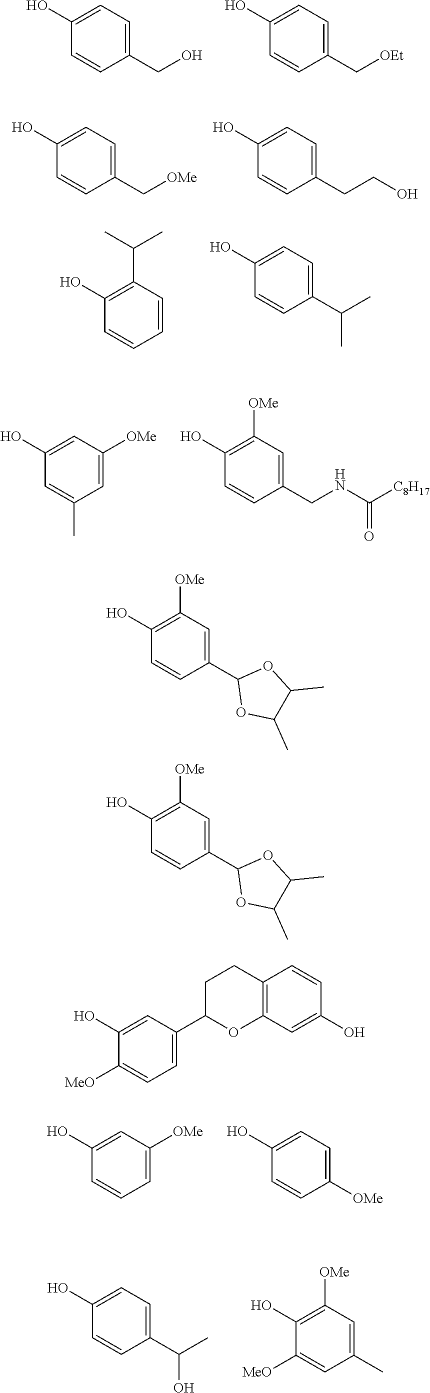

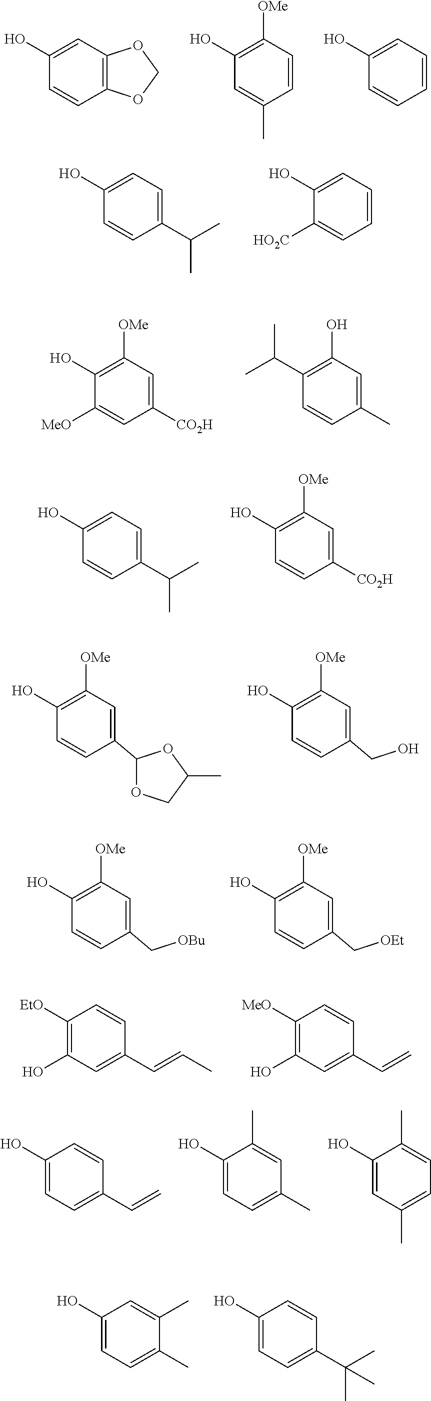

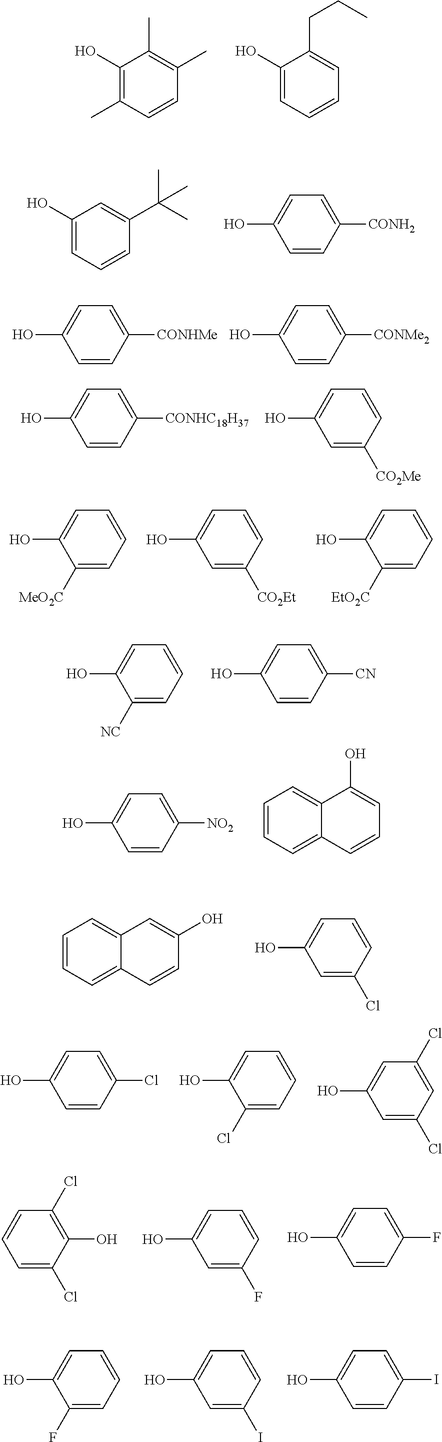

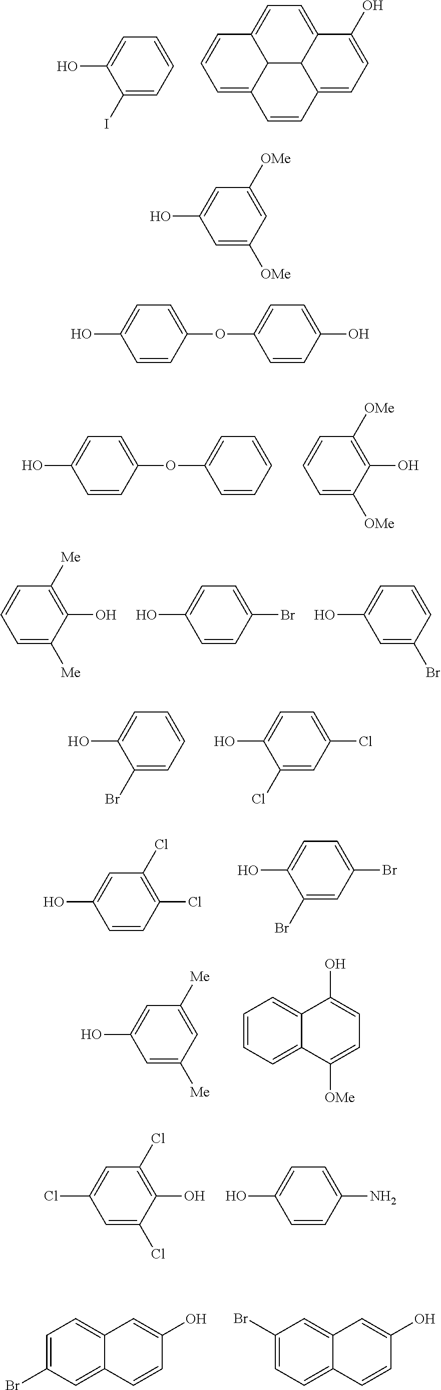

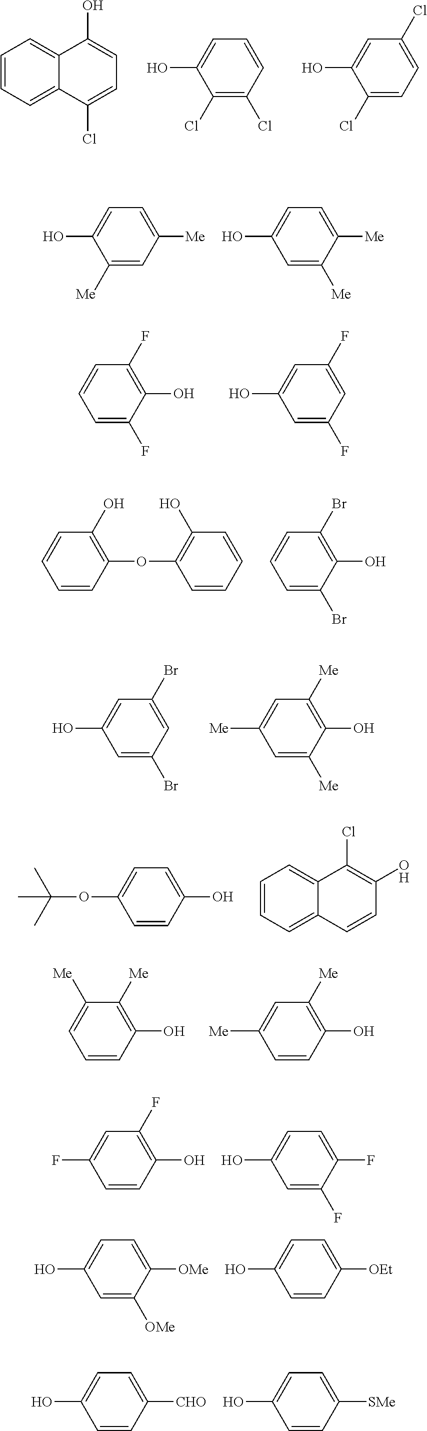

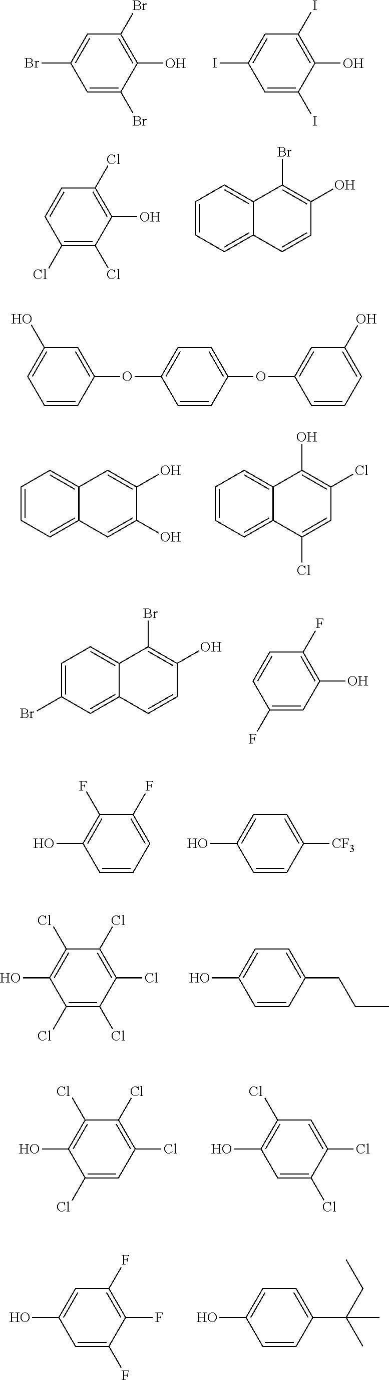

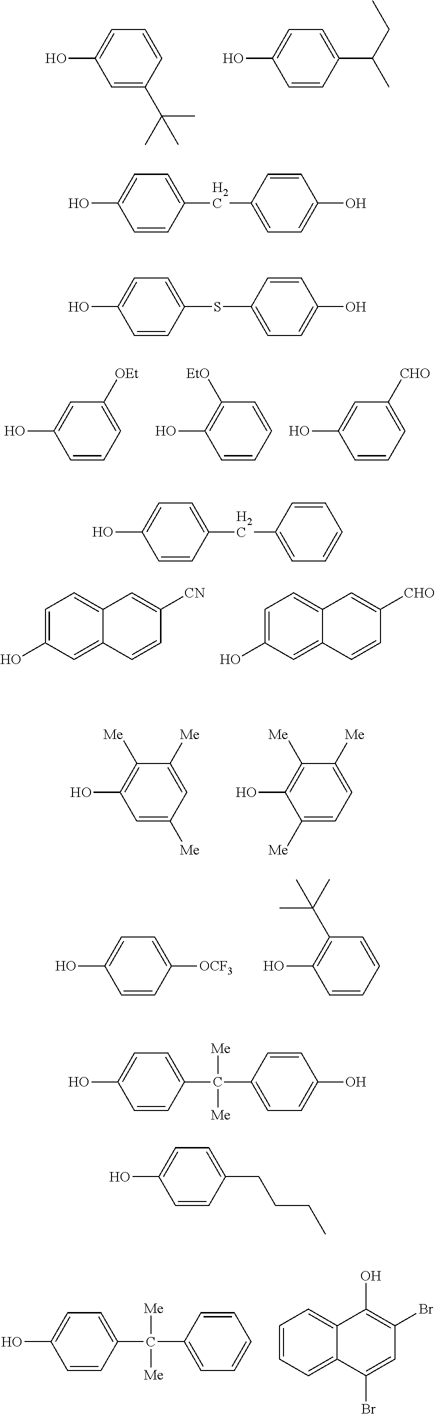

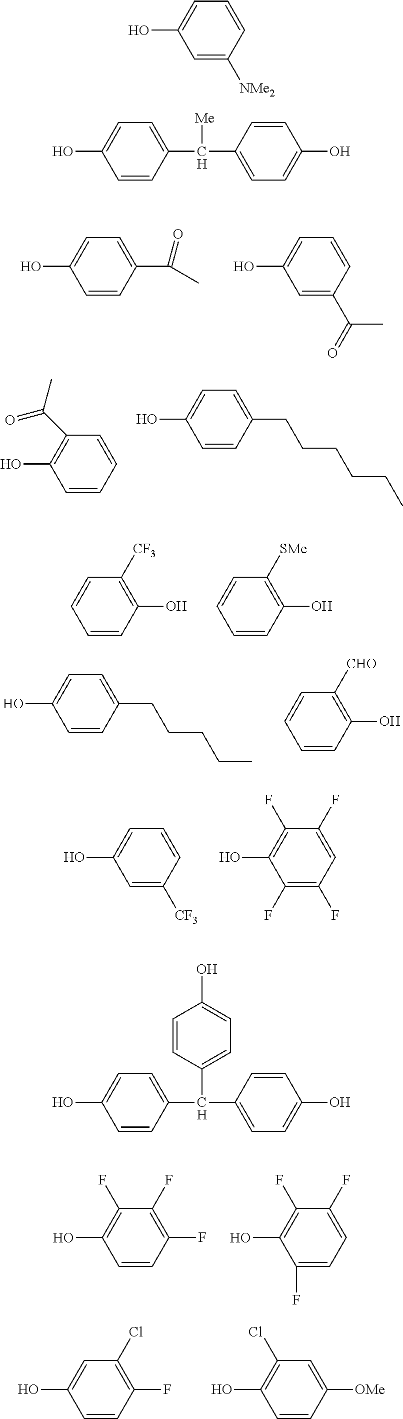

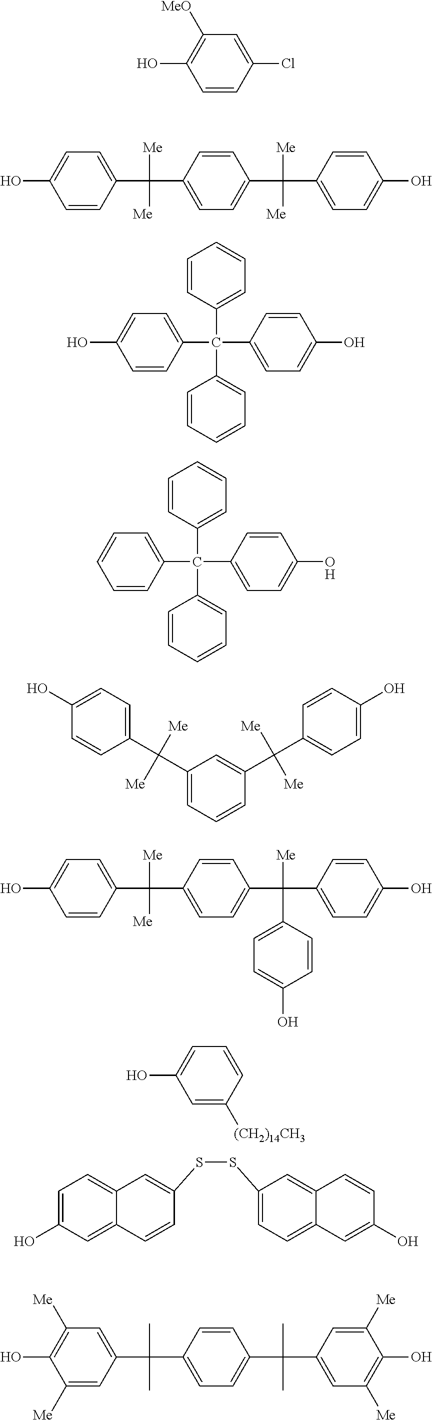

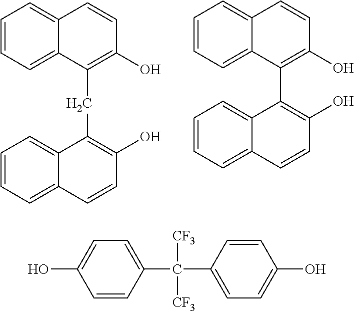

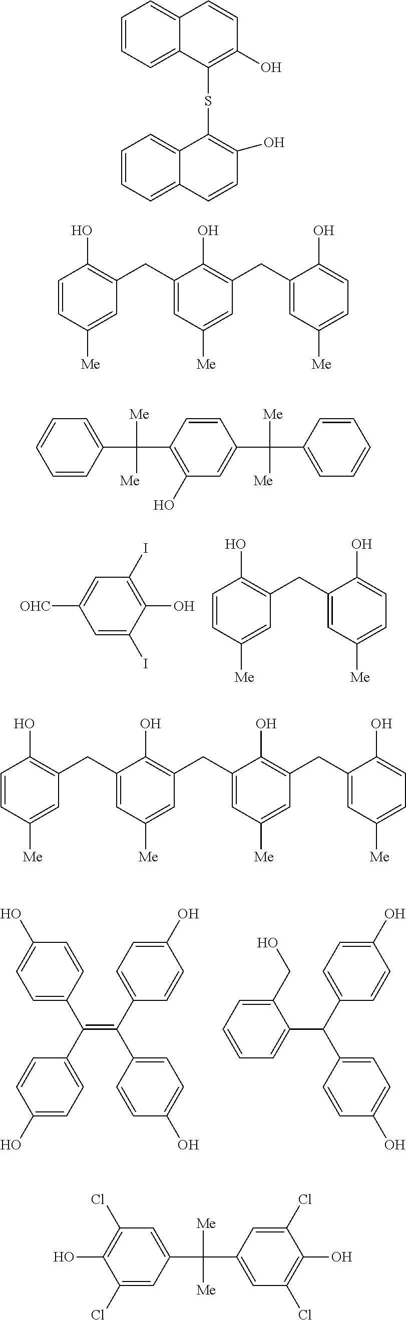

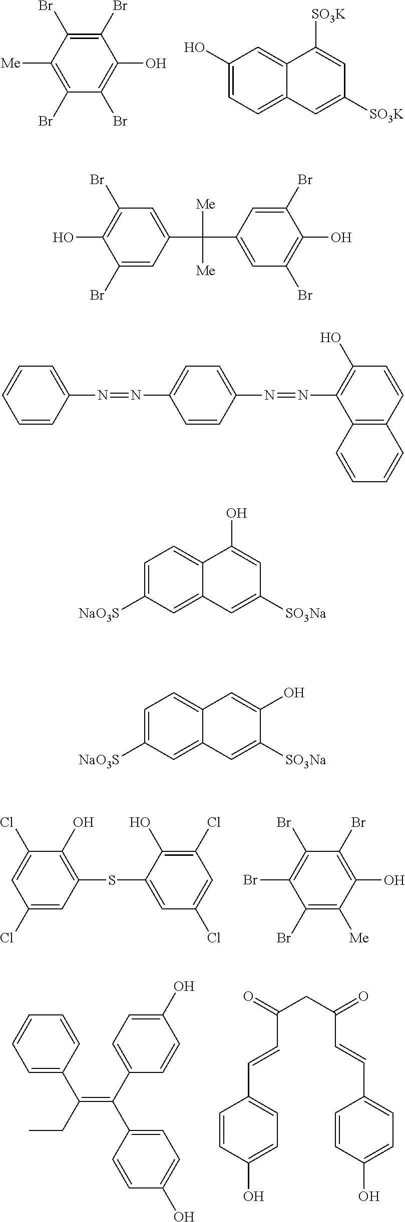

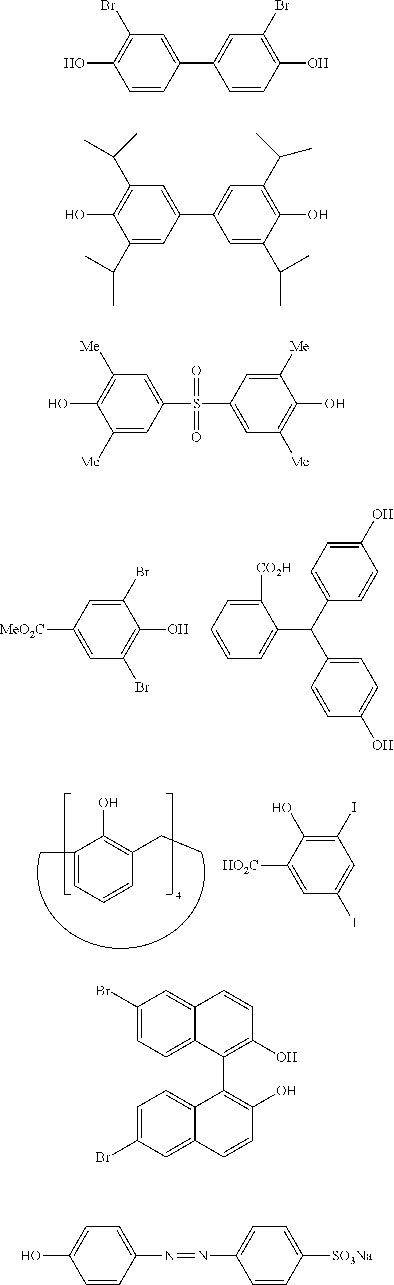

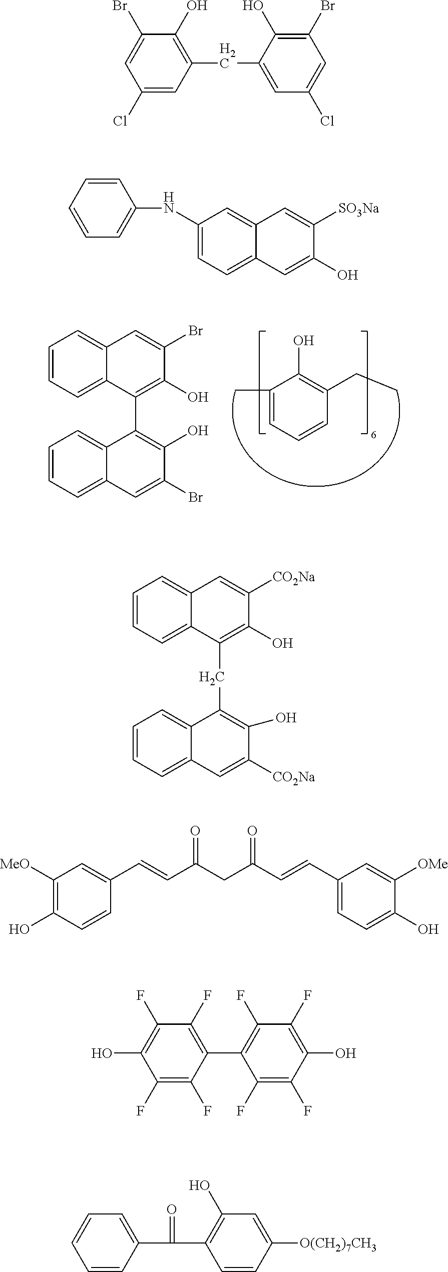

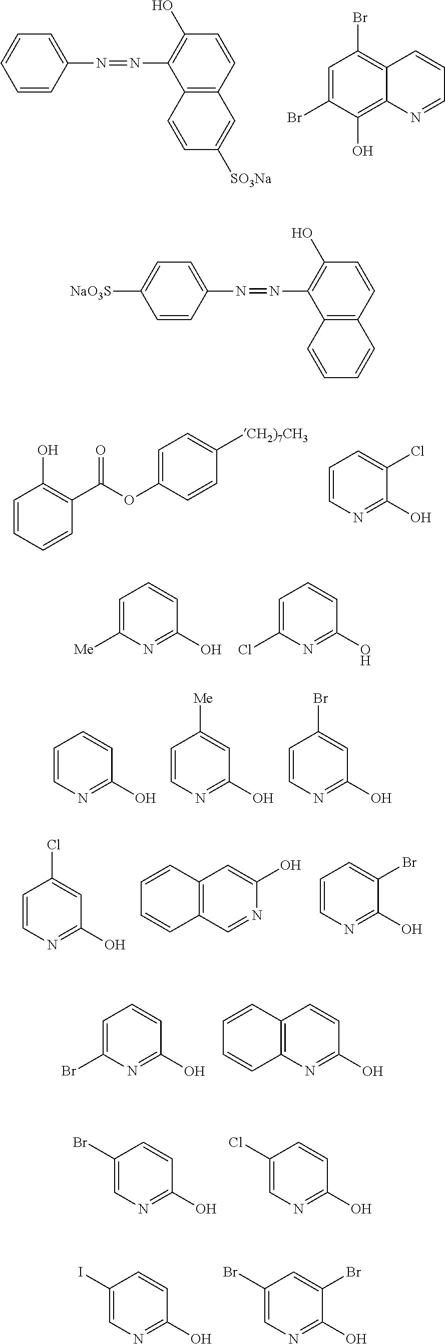

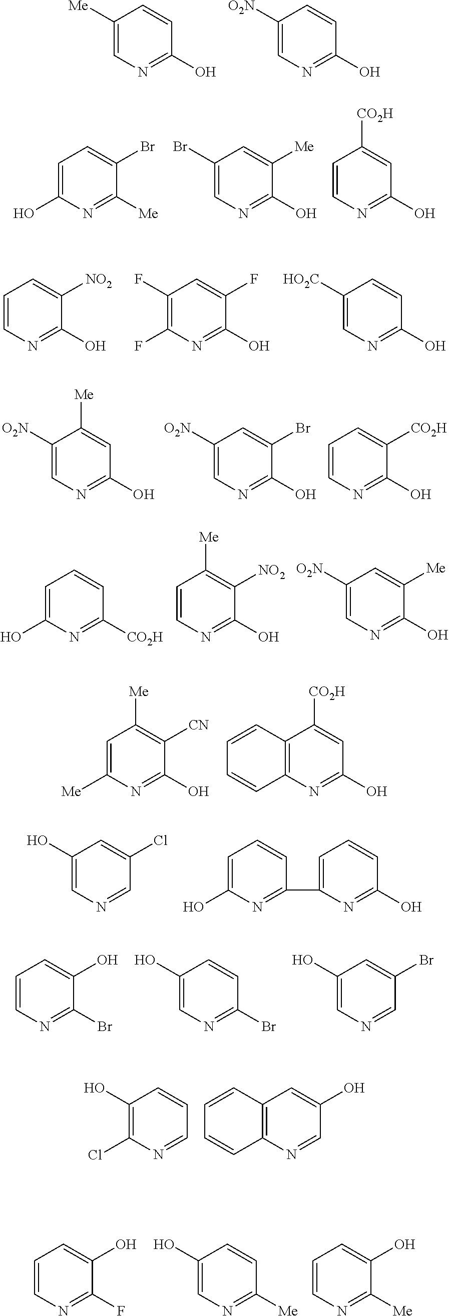

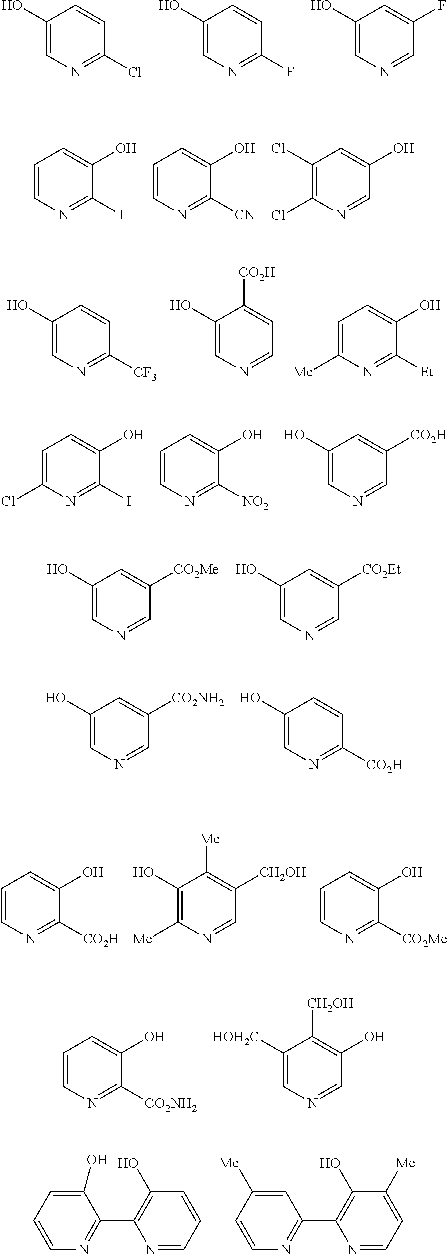

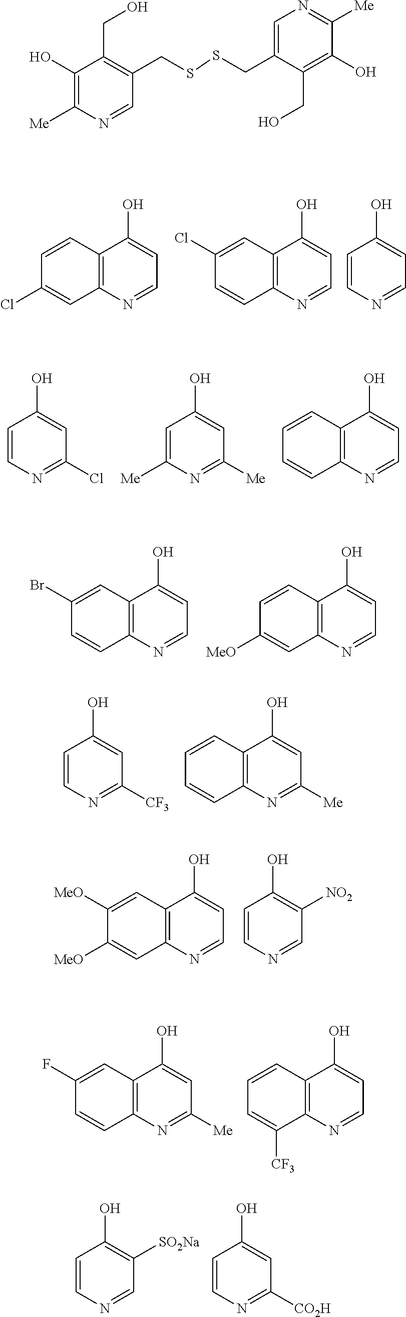

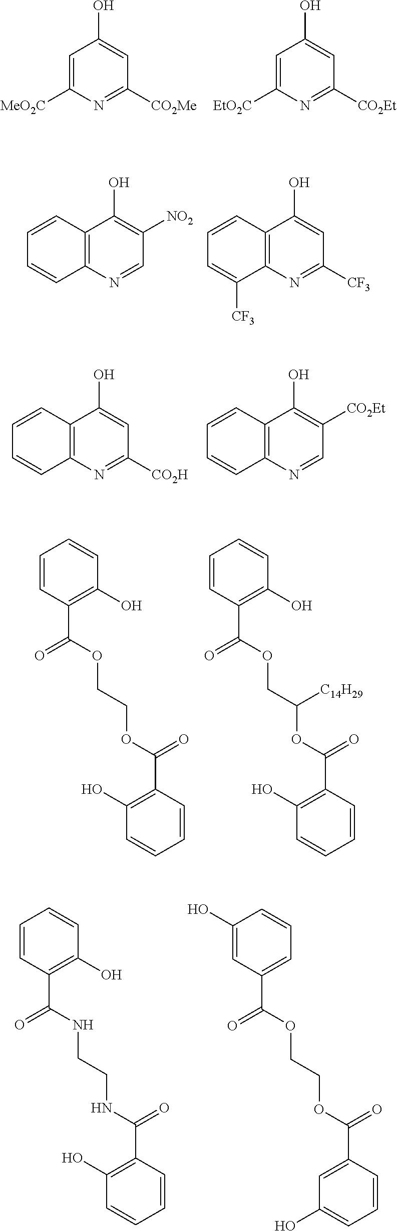

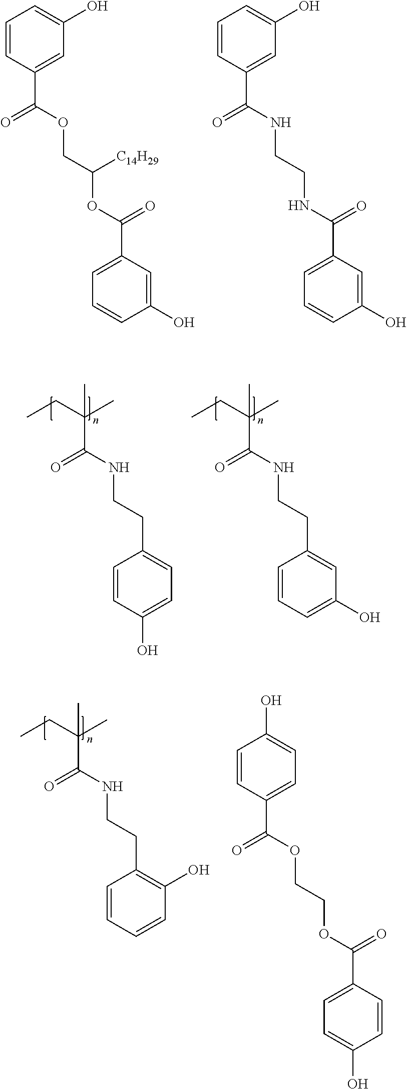

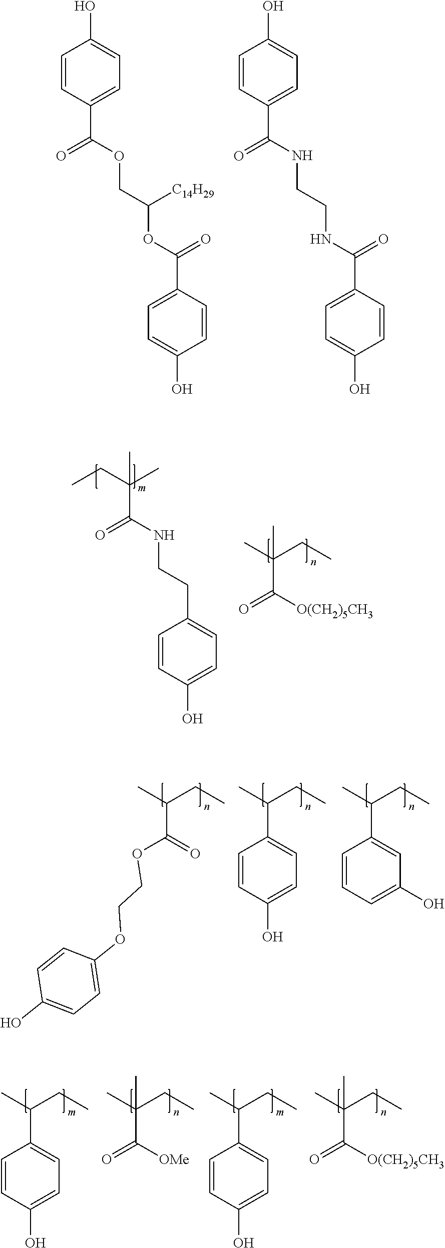

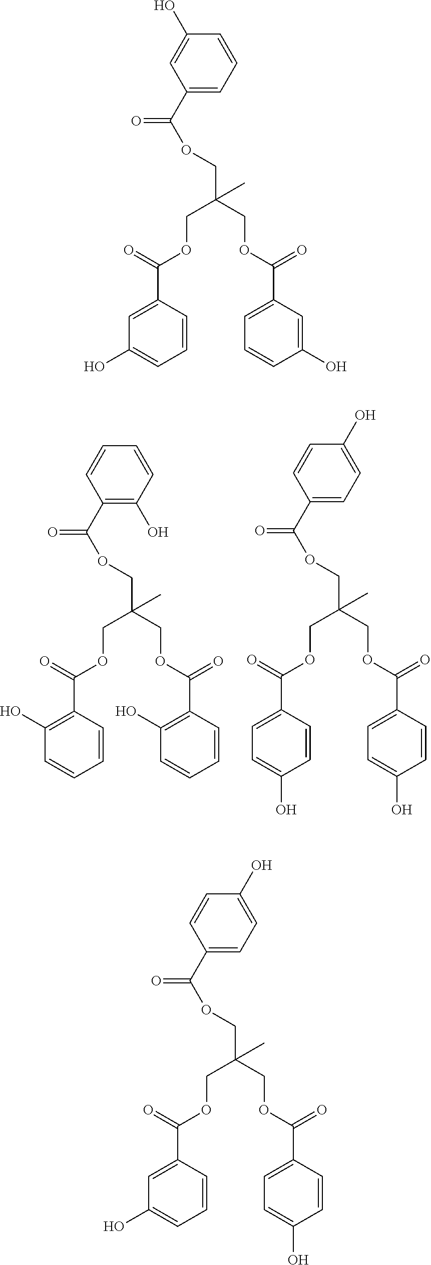

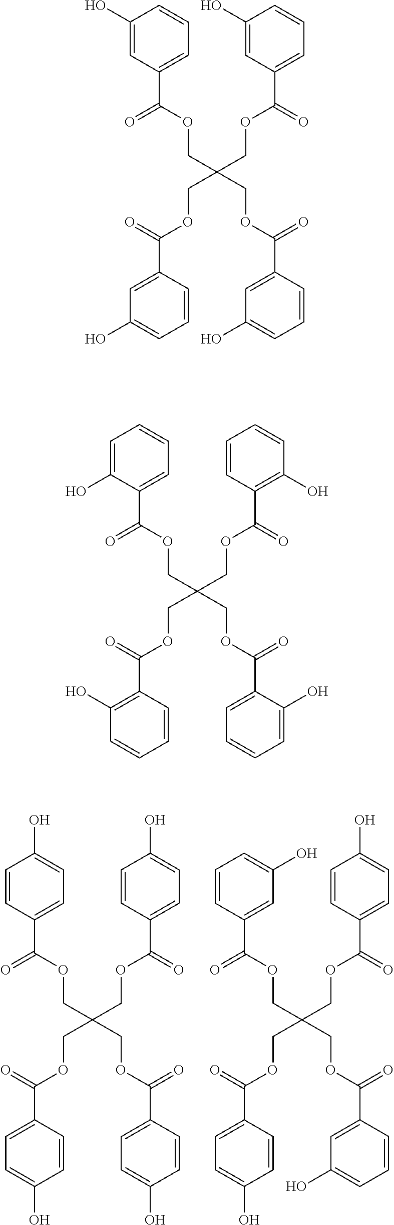

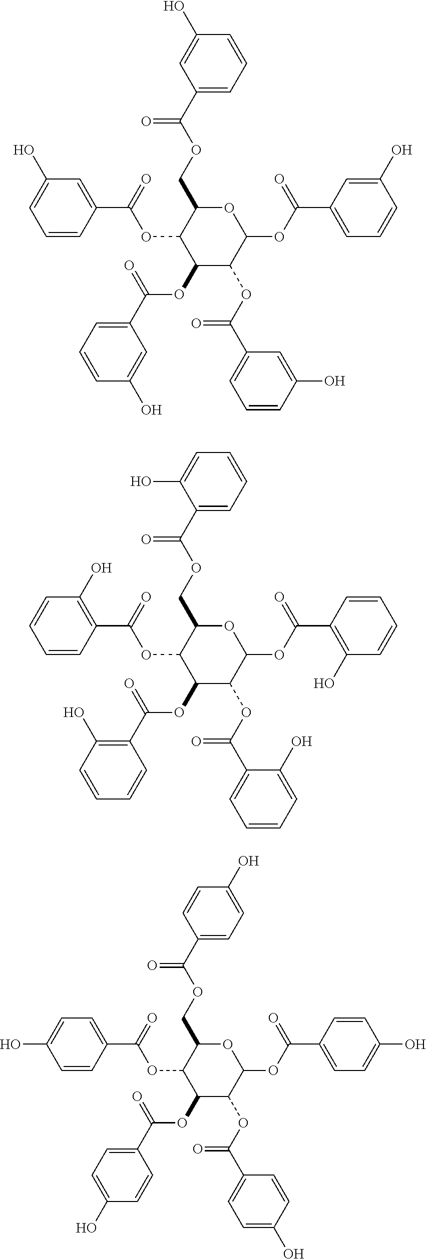

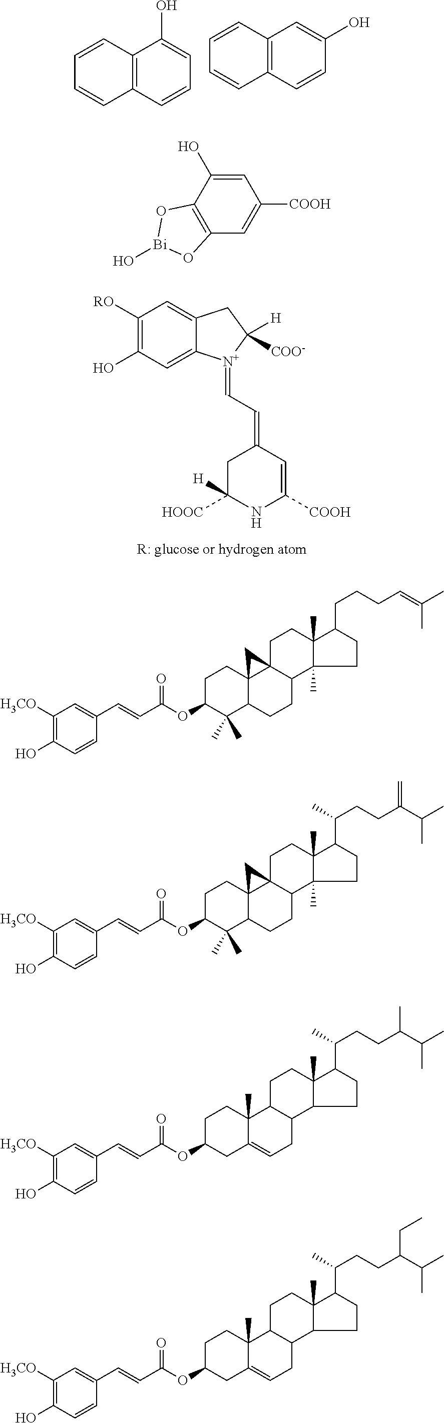

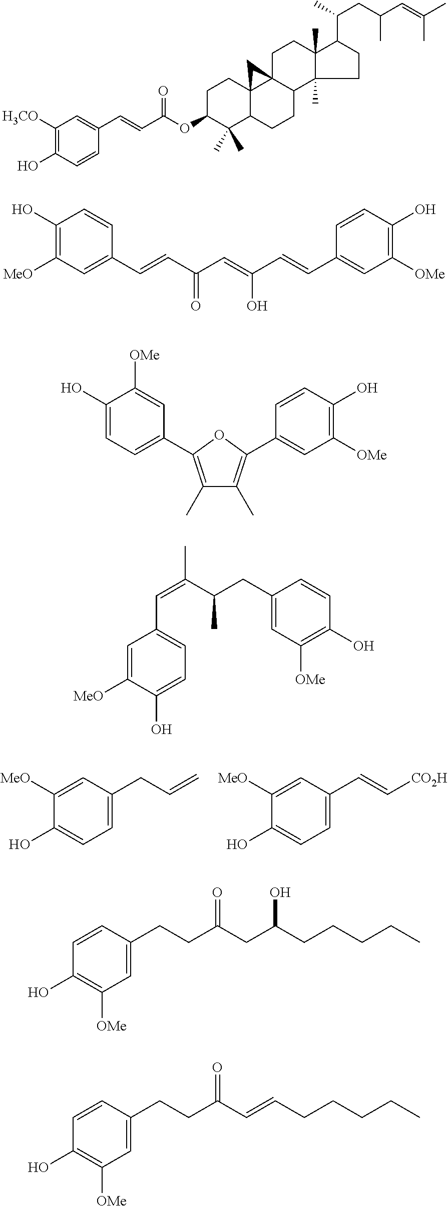

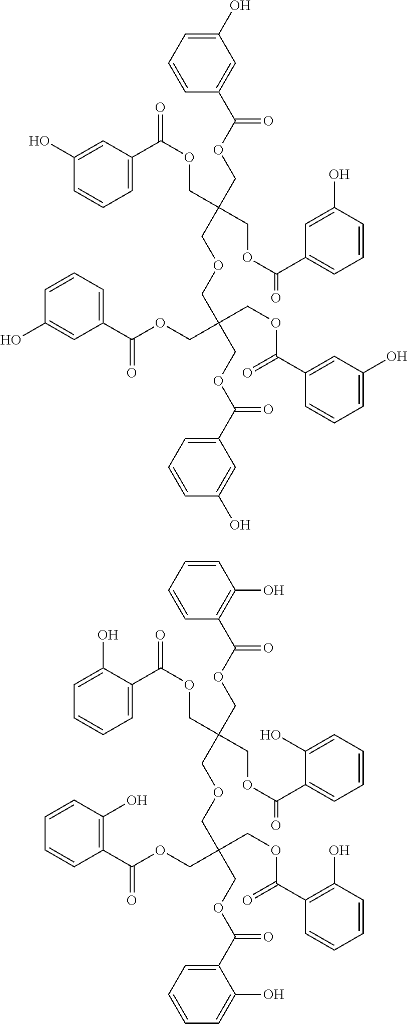

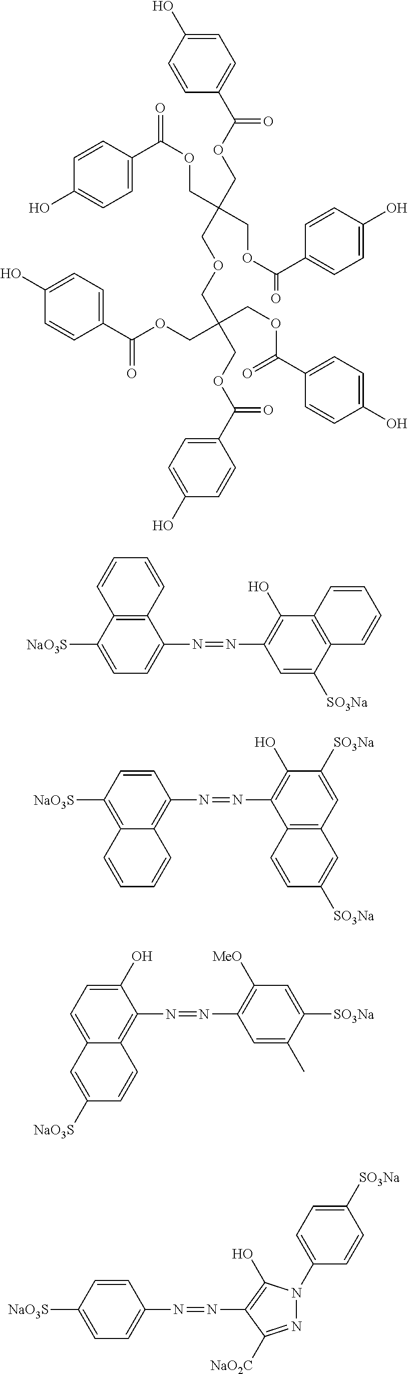

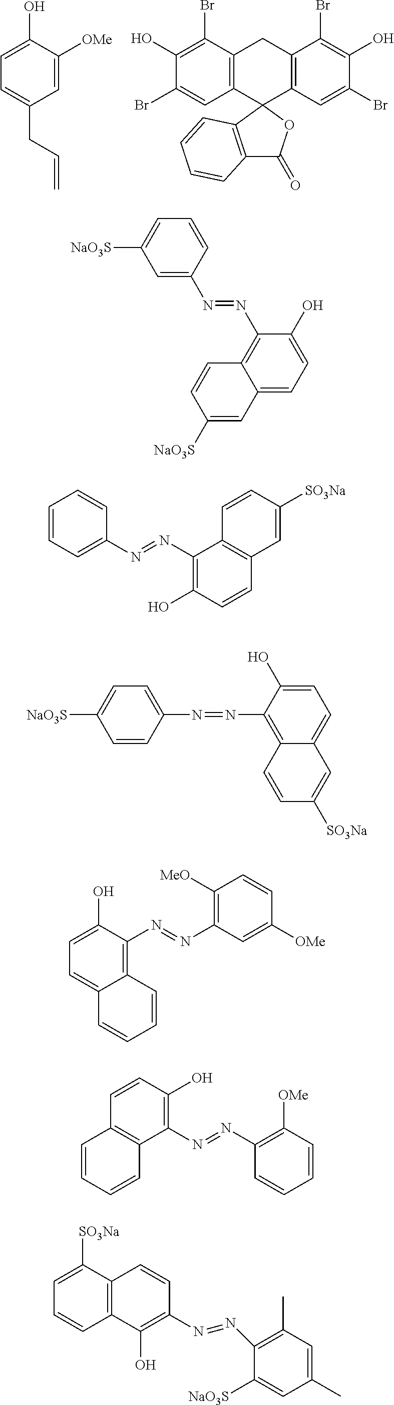

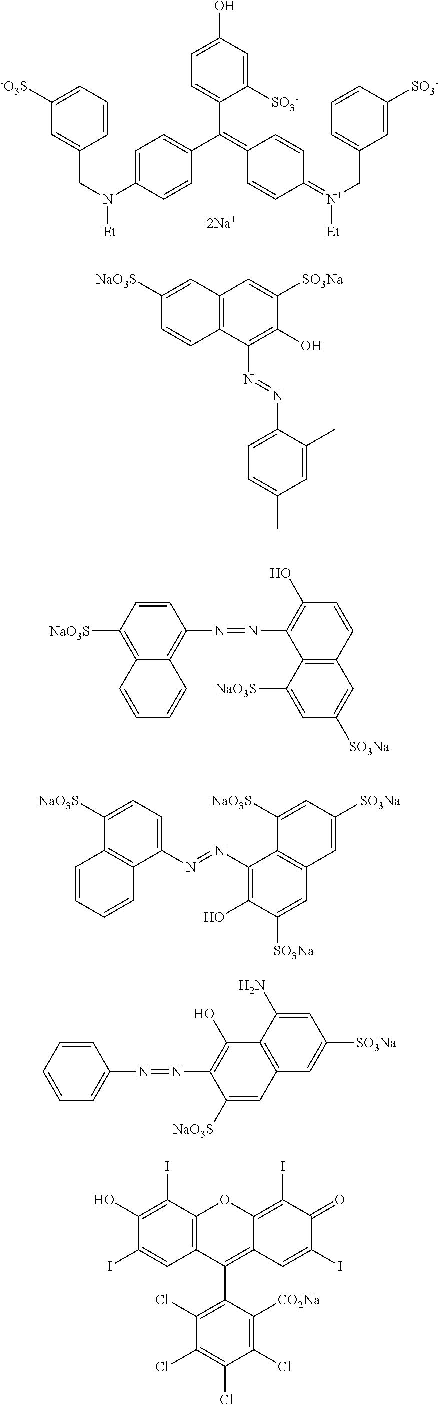

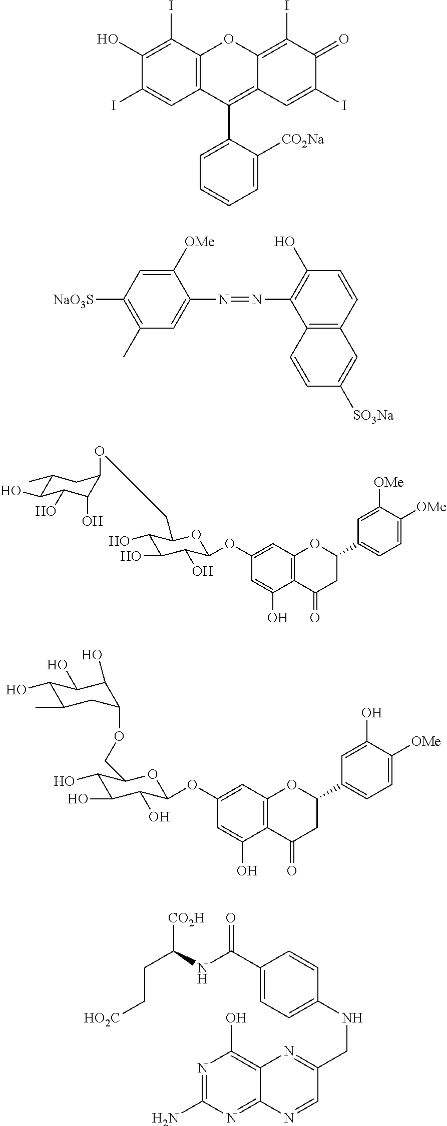

Particularly, in view of further improving the antiviral properties, the liquid agent preferably contains one or more kinds of compounds selected from the group consisting of a polyphenol compound, the compound represented by Formula (1H), and the compound represented by Formula (2Ai) as the compound having a phenolic hydroxyl group, and more preferably contains one or more kinds of compounds selected from the group consisting of the compound represented by Formula (1H) and the compound represented by Formula (2Ai) as the compound having a phenolic hydroxyl group.

<<Compounds X Other than Compound Having Phenolic Hydroxyl Group>>

Examples of the compound X other than the compound having a phenolic hydroxyl group described above include a compound having a mercapto group, a compound having an amine group as a functional group, and the like. Specifically, examples thereof include thioglycerin, benzenethiol, benzenemethanethiol, 2,3-butanedithiol, butanethiol, 2-butanethiol, cyclohexanethiol, cyclopentanethiol, 1,2-ethanedithiol, 2,3-dimercaptopropanol, 2,5-dimethyl-3-furanthiol, 3,3-dimethylbutanethiol, dodecanethiol, ethanethiol, 2-(ethylthio)phenol, 2-furanmethanethiol, heptanethiol, hexadecanethiol, 1,6-hexanedithiol, 3-methylbutanethiol, 2-propanethiol, 3-[(2-mercapto-1-methylpropyl)thio]-2-butanol, 3-hydroxy-2-butanethiol, 2-methoxybenzenethiol, 2-hydroxyethanethiol, 3-mercaptohexanol, pyrazinyl methanethiol, (2-, 3-, or 10)-mercaptopinane, 4-methoxy-2-methyl-2-butanethiol, methanethiol, 2-methyl-3-furanthiol, 2-methyl-3-tetrahydrofuranthiol, 2-methyl-4,5-dihydro-3-furanthiol, (4-methylphenyl)methanthiol, 3-methyl-2-butanethiol, 2-methylbutanethiol, 2-methyl-2-propanethiol, 2-naphthalenethiol, 1,9-nonanedithiol, 1,8-octanedithiol, octanethiol, 2,4,4,6,6-pentamethyl-2-heptanethiol, 2-pentanethiol, pentanethiol, 2-phenylethanethiol, 1-p-menthene-8-thiol, 1,2-propanedithiol, propanethiol, 2-pyrazinylethanethiol, 2-pyridinylmethanethiol, thioteipineol, 2-thienylmethanethiol, 2-thiophenthiol, 1-(2-thienyl)ethanethiol, thiogeraniol, thiolinalol, 2-methylbenzenethiol, 1,4-butanedithiol, 2-mercaptobenzothiazole, 3-{[2-methyl-(2 or 4),5-dihydro-3-furyl]thio}-2-methyltetrahydrofuran-3-thiol, 2-thiazoline-2-thiol, 3-mercapto-2-methylbutanol, 3-mercapto-2-methylpentanol, 3-mercapto-3-methylbutanol, 4-ethoxy-2-methyl-2-butanethiol, ethanedithiol, hexanethiol, 2-methylpropanethiol, mercaptoacetaldehyde diethyl acetal, 3-methyl-2-butenethiol, 1,1-dimethylheptanethiol, 2,6-dimethylbenzenethiol, (S)-1-methoxy-3-heptanethiol, 1,3-propanedithiol, 1-phenylethanethiol, 5-methyl-2-furanmethanethiol, methanedithiol, 4-mercapto-4-methyl-2-pentanol, bis(1-mercaptopropyl)sulfide, 1,1-propanedithiol, 3-pentanethiol, 3-hydroxy-2-methylbutanethiol, 2-heptanethiol, isopentylamine, trimethylamine, butylamine, 4-amino-5,6-dimethylthieno[2,3-d]pyrimidin-2(1H)-one, 3-[(4-amino-2,2-dioxide-1H-2,1,3-benzothiadiazin-5-yl)oxy]-2,2-dimethyl-N-propylpropanamide, 4,4-diethoxy butan-1-amine, 3-(methylthio)propylamine, and the like.

<Solvent>

The above liquid agent contains a solvent. The content of the solvent in the liquid agent is not particularly limited. The content of the solvent with respect to the total mass of the liquid agent is preferably 0.01% to 99.8% by mass and more preferably 0.1% to 99.7% by mass. The solid content means components in the liquid agent except for a solvent. Even though the solid content is liquid, it is calculated as solid content.

In the liquid agent according to an embodiment of the present invention, tire content of an alcohol (total content of alcohols in a case where the liquid agent contains a plurality of alcohols) with respect to the total mass of the solvent is equal to or higher than 40% by mass. In view of further improving the antiviral activity, the content of the alcohol is preferably higher than 50% by mass, and more preferably equal to or higher than 60% by mass. The upper limit of the content of the alcohol is not particularly limited. The upper limit with respect to the total mass of the solvent is, for example, equal to or lower than 100% by mass, and preferably equal to or lower than 80% by mass.

One kind of alcohol may be used singly, or two or more kinds of alcohols may be used in combination. In a case where two or more kinds of alcohols are used in combination, the total content thereof is preferably within the above range.

In the present specification, an alcohol means a compound having an alcoholic hydroxyl group, and does not include a compound having a phenolic hydroxyl group.

The alcohol is not particularly limited, but is, for example, preferably a linear, branched, or cyclic alcohol (including an ether alcohol) having 1 to 20 carbon atoms.

Specifically, examples thereof include methanol, ethanol, n-propanol, isopropanol, polyethylene glycol, propylene glycol, propylene glycol acetate monoester, glycerin, n-butanol, 2-butanol, i-butanol, t-butanol, butane-1,3-diol, diethylene glycol, diethylene glycol monoethyl ether, diethylene glycol monopropyl ether, dipropylene glycol, n-pentanol, 2-pentanol, 3-pentanol, t-amyl alcohol, isoamyl alcohol, 2-methylbutanol, 3-methyl-2-butanol, 3-methyl-2-butenol, 3-methyl-3-butanol, 1-penten-3-ol, n-hexanol, capryl alcohol, 2-ethyl-1-hexanol, decanol, linalol, geraniol, lauryl alcohol, myristyl alcohol, benzyl alcohol, phenylethyl alcohol, cinnamyl alcohol, 3-methoxypropanol, methoxymethoxyethanol, ethylene glycol, ethylene glycol mono-n-butyl ether, diethylene glycol mono-n-butyl ether, triethylene glycol mono-n-butyl ether, tetraethylene glycol mono-n-butyl ether, dipropylene glycol monobutyl ether, citronellol, terpineol, hydroxycitronellal, hydroxycitronellal dimethyl acetal, ethylate glycol monomethyl ether, ethylene glycol monoethyl ether, propylene glycol monomethyl ether, propylene glycol monoethyl ether, diacetone alcohol, ethylene glycol monoisopropyl ether, and diethylene glycol monomethyl ether.

From the viewpoint of safety, the alcohol may be a food additive. The alcohol is preferably methanol, ethanol, propanol, isopropanol, polyethylene glycol, propylene glycol, propylene glycol acetate monoester, n-butanol, 2-butanol, butane-1,3-diol, diethylene glycol, diethylene glycol monoethyl ether, diethylene glycol monopropyl ether, dipropylene glycol, 2-methyl-1-butanol, 1-decanol, 1-penten-3-ol, 2-ethyl-hexanol, 2-pentanol, 3-Pentanol, 3-methyl-2-butanol, 3-methyl-2-butenol, 3-methyl-3-butanol, isoamyl alcohol, i-butanol, benzyl alcohol, citronellol, terpineol, hydroxycitronellal, or hydroxycitronellal dimethyl acetal.

In order to further reduce the variation in the value of antiviral activity, it is preferable that the solvent contains an alcohol having two or less carbon atoms and an alcohol having three or more carbon atoms. In other words, it is preferable that the solvent contains both the alcohol having two or less carbon atoms and alcohol having three or more carbon atoms.

The alcohol having three or more carbon atoms is more soluble in tat than the alcohol having two or less carbon atoms. It is considered that the alcohol having three or more carbon atoms may easily remove viruses and organic substances containing viruses (for example, stains and the like). Therefore, it is considered that in a case where the liquid agent contains both the alcohol having two or less carbon atoms and alcohol having three or more carbon atoms, the variation in the value of antiviral activity may be further reduced.

In a case where the alcohol having two or less carbon atoms and the alcohol having three or more carbon atoms are used in combination, the ratio of the mass of the alcohol having three or more carbon atoms to the mass of the alcohol having two or less carbon atoms in the liquid agent (mass of alcohol having three or more carbon atoms/mass of the alcohol having two or less carbon atoms) is preferably 0.01 to 0.9, more preferably 0.03 to 0.5, and even more preferably 0.03 to 0.4.

The solvent may contain a compound other than an alcohol.

Examples of the compound other than an alcohol include water and an organic solvent (excluding an alcohol).

The organic solvent is not particularly limited, and examples thereof include acetone, methyl ethyl ketone, cyclohexane, benzene, ethyl acetate, isoamyl acetate, isopropyl acetate, geranyl acetate, cyclohexyl acetate, citronellyl acetate, cinnamyl acetate, terpinyl acetate, phenylethyl acetate, butyl acetate, benzyl acetate, menthyl acetate, linalyl acetate, butyric acid, ethyl butyrate, butyl butyrate, isoamyl butyrate, cyclohexyl butyrate, ethylene dichloride, tetrahydrofuran, toluene, ethylene glycol dimethyl ether, acetylacetone, cyclohexanone, ethylene glycol monomethyl ether acetate, ethylene glycol ethyl ether acetate, ethylene glycol monobutyl ether acetate, diethylene glycol dimethyl ether, diethylene glycol diethyl ether, propylene glycol monomethyl ether acetate, 2-methylpropanal, 2-methylbutyraldehyde, 3-methyl-2-butenal, 3-methylbutanal, L-perillaldehyde, acetaldehyde, ethyl acetoacetate, isoamyl acetate, isovaleraldehyde, isobutanol, isopropyl acetate, isopropyl myristate, isoamyl isovalerate, ethyl isovalerate, ethyl lactate, ethyl heptanoate, octanal, ethyl octanoate, octanoic acid, octyl aldehyde, formic acid, isoamyl formate, geranyl formate, citronellyl formate, silicate aldehyde, ethyl silicate, methyl silicate, citral, citronellal, diisopropyl ether, diisopropyl disulfide, diethyl ether, diethyl tartrate, diethyl pyrocarbonate, decanal, ethyl decanoate, triacetin, triethyl citrate, toluene, nonalactone, valeraldehyde, paramethylacetophenone, paramethoxybenzaldehyde, castor oil, isoamyl phenyl acetate, isobutyl phenyl acetate, ethyl phenyl acetate, butanal, propionaldehyde, propionic acid, isoamyl propionate, ethyl propionate, benzyl propionate, hexane, heptane, benzaldehyde, eucalyptol, ionone, terpinyl acetate, α-amylcinnamaldehyde, brominated vegetable oil, acetic acid, dimethyl dicarbonate, ethyl lactate, thermally oxidized soybean oil, esters of thermally oxidized soybean oil and glycerin, and liquid paraffin.

Among these, from the viewpoint of safety, food additives are preferable. As the organic solvent, acetone, methyl ethyl ketone, ethyl acetate, isoamyl acetate, isopropyl acetate, geranyl acetate, cyclohexyl acetate, citronellyl acetate, cinnamyl acetate, terpinyl acetate, phenyethyl acetate, butyl acetate, benzyl acetate, menthyl acetate, linalyl acetate, butyric acid, ethyl butyrate, butyl butyrate, isoamyl butyrate, cyclohexyl butyrate, 2-methylpropanal, 2-methylbutyraldehyde, 3-methyl-2-butenal, 3-methylbutanal, 1-perillaldehyde, acetaldehyde, ethyl acetoacetate, isoamyl acetate, isovaleraldehyde, isobutanol, Isopropyl acetate, isopropyl myristate, isoamyl isovalerate, ethyl isovalerate, ethyl lactate, ethyl heptanoate, octanal, octanoic acid, ethyl octanoate, octyl aldehyde, formic acid, isoamyl formate, geranyl formate, citronellyl formate, silicate aldehyde, ethyl silicate, methyl silicate, citral, citronellal, diisopropyl ether, diisopropyl disulfide, diisopropyl disulfide, diethyl ether, diethyl tartrate, diethyl pyrocarbonate, decanal, ethyl decanoate, triacetin, triethyl citrate, toluene, nonalactone, valeraldehyde, paramethylacetophenone, paramethoxybenzaldehyde, castor oil, isoamyl phenyl acetate, isobutyl phenyl acetate, ethyl phenyl acetate, butanal, propionaldehyde, propionic acid, isoamyl propionate, ethyl propionate, benzyl propionate, hexane, heptane, benzaldehyde, eucalyptol, ionone, terpinyl acetate, a-amylcinnamaldehyde, brominated vegetable oil, acetic acid, dimethyl dicarbonate, ethyl lactate, thermally oxidized soybean oil, esters of thermally oxidized soybean oil and glycerin, or liquid paraffin is preferable.

<Surfactant>

It is preferable that the liquid agent contains a surfactant. The wiper obtained by impregnating a base fabric with the liquid agent containing a surfactant leaves less unwiped stains and has higher cleaning properties.

The surfactant is not particularly limited, and examples thereof include an ionic surfactant such as an anionic surfactant, a cationic surfactant, and an amphoteric surfactant, a nonionic surfactant, and the like.

Examples of the anionic surfactant include a higher tatty acid salt such as potassium stearate and potassium behenate; alkyl ether carboxylate such as polyoxyethylene (hereinafter abbreviated to “POE”) sodium lauryl ether carboxylate, N-acyl-L-glutamate such as a N-stearoyl-L-glutamate monosodium salt; a higher alkyl sulfuric acid ester salt such as sodium lauryl sulfate and potassium lauryl sulfate; an alkyl ether sulfuric acid ester salt such as POE triethanolamine lauryl sulfate and POE sodium lauryl sulfate; N-acylsarcosinate such as sodium lauroyl sarcosine; higher fatty acid amide sulfonate such as N-myristoyl-N-methyltaurine sodium; alkyl phosphate such as sodium stearyl phosphate; alkyl ether phosphate such as POE sodium oleyl ether phosphate and POE sodium stearyl ether phosphate; sulfosuccinate such as sodium di-2-ethylhexyl sulfosuccinate, sodium monolauroyl monoethanolamide polyoxyethylene sulfosuccinate, and sodium lauryl polypropylene glycol sulfosuccinate; alkylbenzene sulfonate such as sodium linear dodecylbenzene sulfonate, linear dodecylbenzene sulfonate, and dodecyl diphenyl ether disulfonate; cholate such as sodium deoxycholate, sodium lithocholate, and sodium cholate; and higher fatty acid ester sulfate such as hydrogenated coconut oil fatty acid sodium glycerin sulfate.

Examples of the cationic surfactant include an alkyltrimethylammonium salt such as stearyltrimethylammonium chloride and lauryltrimethylammonium chloride; a dialkyldimethylammonium salt such as distearyldimethylammonium chloride; an alkylpyridinium salt such as poly(N,N dimethyl-3,5-methylene piperidinium) chloride and cetylpyridinium chloride; an alkyl quaternary ammonium salt; an alkyldimethylbenzylammonium salt; an alkylisoquinolinium salt; a dialkylmorpholinium salt;

POE alkylamine; an alkylamine salt; a polyamine fatty acid derivative; an amyl alcohol fatty acid derivative; benzalkonium chloride; benzethonium chloride; and the like.

Examples of the amphoteric surfactant include betaine laurylamidopropyl acetate; and an alkyl betaine salt such as coconut oil alkyl betaine and palm kernel oil fatty acid amidopropyl betaine.

As the nonionic surfactant, a compound having more than 20 carbon atoms is preferable. Examples thereof include ester-type compounds such as fatty acid esters of mono-, di-, or polyglycerin, propylene glycol fatty acid monoester, sorbitan fatty acid ester, and sucrose fatty acid ester; ether-type compounds such as polyoxyethylene alkyl ether, polyalkylene alkyl ether, and polyoxyethylene polyoxypropylene glycol (such as EMULGEN series manufactured by Kao Corporation); ester ether-type compounds such as fatty acid polyethylene glycol and fatty acid polyoxyethylene sorbitan; and alkanolamide-type compounds such as fatty acid alkanolamide, and the like.

Specific examples of the nonionic surfactant include polyethylene glycol monolauryi ether, polyethylene glycol monostearyl ether, polyethylene glycol monooctyl ether, polyethylene glycol monolauryi ester, polyethylene glycol monostearyl ester, and the like.

One kind of surfactant may be used singly, or two or more kinds of surfactants may be used in combination.

In a case where the liquid agent contains a surfactant, the content of the surfactant (total content in a case where the liquid agent contains two or more kinds of surfactants) with respect to the total mass of the liquid agent is preferably 0.01% to 2% by mass, more preferably 0.05% to 2% by mass, and even more preferably 0.05% to 1% by mass.

<Base>

It is preferable that the liquid agent contains a base. The base is a component that functions as a pH adjuster. The content of the base in the liquid agent is not particularly limited. In view of further improving the antiviral activity of the wiper, the content of the base with respect to the total mass of the liquid agent is preferably 0.01% to 5% by mass. One kind of base may be used singly, or two or more kinds of bases may be used in combination. In a case where two or more kinds of bases are used in combination, the total content thereof is preferably within the above range.

The base is not particularly limited, and examples thereof include a metal alkoxide (for example, sodium methoxide and sodium ethoxide), a metal oxide (for example, calcium oxide, magnesium oxide, and the like), a metal hydroxide (such as calcium hydroxide, magnesium hydroxide, potassium hydroxide, sodium hydroxide, lithium hydroxide, aluminum hydroxide, rubidium hydroxide, cesium hydroxide, strontium hydroxide, barium hydroxide, europyrium (II) hydroxide, and thallium (I) hydroxide), quaternary ammonium hydroxide, an organic base (such as a guanidine derivative, diazabicycloundecene, and diazabicyclononene), a phosphazene base, a proazaphosphatrane base, and a basic amino acid such as lysine and arginine.

Among these, from the viewpoint of safety, sodium hydroxide, potassium hydroxide, calcium hydroxide, or tetrabutylammonium hydroxide is preferable.

<Chelating Agent>

It is preferable that the liquid agent contains a chelating agent. The chelating agent is a component which prevents impurity metal ions that can be contained in the base fabric and the liquid agent components from being precipitated in the base fabric as salts such as carbonate and an oxide salt. In a case where the liquid agent contains a chelating agent, the wiper obtained by impregnating a base fabric with the liquid agent containing the chelating agent less causes uneven wiping and has higher cleaning properties. The chelating agent is not particularly limited, and examples thereof include ethylenediaminetetraacetate such as ethylenediaminetetraacetic acid, calcium disodium ethylenediaminetetraacetate, and disodium ethylenediaminetetraacetate; L-tartrate such as L-tartaric acid, potassium L-tartrate, and sodium L-tartrate; citrate such as citric acid, isopropyl citrate, stearyl citrate, triethyl citrate, calcium citrate, monopotassium citrate, and tripotassium citrate; gluconate such as gluconic acid, calcium gluconate, and sodium gluconate; polyphosphate such as polyphosphoric acid, ammonium polyphosphate, calcium polyphosphate, potassium polyphosphate, and sodium polyphosphate; metaphosphate such as metaphosphoric acid, potassium metaphosphate, and sodium metaphosphate; phosphate such as phosphoric acid, potassium hydrogen phosphate, sodium hydrogen phosphate, potassium phosphate, and sodium phosphate; and the like.

One kind of chelating agent may be used singly, or two or more kinds of chelating agents may be used in combination. In a case where the liquid agent contains a chelating agent, the content of the chelating agent (total content in a case where the liquid agent contains two or more kinds of chelating agents) with respect to the total mass of the liquid agent is preferably 0.01% to 2% by mass, and more preferably 0.02% to 1.5% by mass.

<Other Components>

As long as the effects of the present invention are brought about, the liquid agent may contain components other than the above. Examples of such components include a bactericide, a disinfectant, a fungicide, an emulsifier, a UV absorber, a moisturizer, thickener gelling agents, a pH buffer, a preservative, a fragrance, and a coloring agent

The liquid agent is alkaline.

The pH of the liquid agent is not particularly limited, but is, for example, preferably equal to or higher than 8.0. In view of further improving the antiviral activity of the wiper, the pH of the liquid agent is more preferably 9.5 to 14.0, and even more preferably 10.0 to 12.0.

The pH can be measured using a desktop pH meter “F-72S” (manufactured by HORIBA, Ltd.) using a pH electrode “6337-10D” (manufactured by HORIBA, Ltd.). The pH measurement method will be specifically described later.

In the present specification, pH means a value at 25° C.

<Liquid Agent Manufacturing Method>

The liquid agent can be prepared by appropriately mixing together components. The order of mixing together the components is not particularly limited.

[Base Fabric]

The fibers constituting the base fabric are not particularly limited, and examples thereof include a natural liber, a synthetic fiber, a semi-synthetic fiber, and a regenerated fiber.

As the fibers constituting the base fabric, one kind of fiber may be used singly, or two or more kinds of fibers may be used in combination.

The natural fiber is not particularly limited, and examples thereof include a cellulosic fiber such as a cotton fiber, a linen fiber, and a pulp fiber; wool, and silk.

The synthetic fiber is not particularly limited, and examples thereof include a vinylon fiber; a vinylidene fiber, a polyester fiber such as a polyethylene terephthalate fiber, polybutylene terephthalate fiber, a polytrimethylene terephthalate fiber, and a copolymerized polyester fiber; a polyolefin fiber such as a polyethylene fiber and a polypropylene fiber; a polyamide fiber such as a nylon 6 fiber, a nylon 66 fiber, a nylon 610 fiber, and a nylon 46 fiber; an acrylic fiber such as a polyacrylonitrile fiber, a polyurethane fiber; a polyvinyl chloride fiber, an aramid fiber; a benzoate fiber; a polychlal fiber; a novoloid fiber, a polyfluoroethylene fiber, and the like.

The semi-synthetic fiber is not particularly limited, and examples thereof include an acetate fiber, a triacetate fiber, a promix fiber, and the like.

The regenerated fiber is not particularly limited, and examples thereof include a rayon fiber, a polynosic fiber, a cupra fiber, a lyocell fiber, and the like.

In view of further improving the storage stability of the wiper, the fibers constituting the base fabric preferably contain a synthetic fiber, and more preferably contain one or more kinds of synthetic fibers selected from the group consisting of a polyolefin fiber (preferably a polyethylene fiber or a polypropylene fiber), a polyester fiber (preferably a polyethylene terephthalate fiber), a vinylon fiber, and a nylon fiber.

In the fibers constituting the base fabric, the content of the synthetic fiber with respect to the total mass of the fibers is, for example, equal to or higher than 30% by mass, preferably equal to or higher than 80% by mass, and even more preferably equal to or higher than 95% by mass. The upper limit of the content of the synthetic fiber is, for example, equal to or lower than 100% by mass with respect to the total mass of the fibers.

The fibers constituting the base fabric are preferably synthetic fibers selected from the group consisting of a polyolefin fiber (preferably a polyethylene fiber or a polypropylene fiber), a polyester fiber (preferably a polyethylene teraphthalate fiber), and a vinylon fiber, and more preferably synthetic fibers selected from the group consisting of a polyolefin fiber (preferably a polyethylene fiber or a polypropylene fiber) and a polyester fiber (preferably a polyethylene terephthalate fiber).

In the fibers constituting the base fabric, the content of the cellulosic fiber (total content in a case where the base fabric contains two or more kinds of cellulosic fibers) with respect to the total mass of the fibers is preferably equal to or lower than 70% by mass. In view of further improving the storage stability of the wiper, the content of the cellulosic fiber is preferably equal to or lower than 30% by mass. Particularly, in view of further improving the storage stability of the wiper, it is more preferable that the fibers constituting the base fabric substantially do not contain the cellulosic fiber. Herein, “substantially do not contain” means that the content of the cellulosic fiber with respect to the total mass of the fibers is equal to or lower than 5% by mass. The content of the cellulosic fiber is more preferably equal to or lower than 3% by mass, and even more preferably equal to or lower than 1% by mass. The lower limit is not particularly limited, but is 0% by mass for example.

The cellulosic fiber means a cellulose-containing fiber or a fiber derived from cellulose. Specific examples of the cellulosic fiber include a pulp fiber, a rayon fiber, a polynosic fiber, a cupra fiber, a lyocell fiber, an acetate fiber, a diacetate fiber, a triacetate fiber, a cotton fiber, a linen fiber, and the like.

The type of the base fabric is not particularly limited, and examples thereof include a woven fabric, a non-woven fabric, a knit fabric, and the like. Among these, a non-woven fabric is preferable.

The basis weight (mass per unit area) of the base fabric is preferably equal to or lower than 100 g/m². In a case where the base fabric is impregnated with the liquid agent, the amount of the liquid agent is preferably equal to or larger than the amount of the base fabric in terms of mass.

[Wiper Manufacturing Method]

The method of impregnating the base fabric with the liquid agent is not particularly limited. For example, a method may be used in which a base fabric wound in the form of a roll is put in a bottle container so that the roll surface comes into contact with the bottom portion of the bottle container, and the liquid agent is dropped to the upper roll surface of the base fabric wound in the form of a roll so that the base fabric is impregnated with the liquid agent.

[Use of Wiper]

The use of the wiper is not particularly limited.

The wiper acts to inactivate viruses belonging to the family Caliciviridae, the family Orthomyxoviridae, the family Coronaviridae, the family Herpesviridae, and the like. Therefore, it is preferable to use the wiper for reducing the activity of the above viruses by causing the wiper to act on the viruses. Examples of viruses belonging to the family Caliciviridae include viruses belonging to the genus Norovirus, the genus Sapovirus, the genus Lagovirus, the genus Nebovirus, the genus Vesivirus, and the like. The wiper exerts an excellent inactivating effect on the viruses belonging to the genus Norovirus and the viruses belonging to the genus Vesivirus among the above viruses. That is, the wiper is preferably used as an anti-norovirus wiper, that is, a wiper for reducing the activity of noroviruses by acting on the noroviruses.

In addition, the wiper may be used as an antibacterial wiper against microorganisms such as bacteria and fungi (for example, Escherichia coli, Staphylococcus, Trichophyton, Candida Albicans, Aspergillus, and the like).

### Examples

Hereinafter, the present invention will be more specifically described based on examples. The materials, amounts and proportions of the materials used, details and procedures of treatments, and the like described in the following examples can be appropriately changed as long as the gist of the present invention is maintained. Therefore, the scope of the present invention is not limited to the following specific examples.

By using a liquid agent prepared by the following method, a wiper was prepared, and the antiviral activity of the wiper was evaluated. Feline calicivirus was used for the evaluation of antiviral activity. Feline calicivirus is widely known to be used to demonstrate the inactivation action of drugs on norovirus.

### Preparation of Wiper of Example 1

[Liquid Agent Preparation Method]

Alcohols (73 g of ethanol and 3 g of isopropanol) were added to a glass container containing 4-hydroxy-benzoic acid (corresponding to the compound X (compound having a phenolic hydroxyl group)) and disodium ethylenediaminetetraacetate (corresponding to a chelating agent), and the 4-hydroxy-benzoic acid and the disodium ethylenediaminetetraacetate were dissolved in the alcohols. Then, water and a 1 mol/L aqueous sodium hydroxide solution were added to the glass container so that the total amount of water was 24 g and the pH of the prepared liquid agent was 11.5, thereby obtaining a liquid agent used in Example 1 containing components mixed together in the amount described in Table 1.

The pH was measured by the following method.

<Measurement of pH of Liquid Agent>

pH calibration was performed using a pH standard solution, and then the pH was measured using a pH meter (trade name “pH-water quality analyzer LAQUA F-72S”, manufactured by HORIBA, Ltd.) and a pH electrode (trade name “6377-10D”, manufactured by HORIBA, Ltd.). A sample solution was prepared at a solution temperature of 25° C., the electrode was then immersed in the sample solution and left to stand for about 1 to 2 minutes, and a pH value remain stable on the pH meter was read. The results are shown in Table 1.

[Preparation of Wiper]

A wiper was prepared using the above liquid agent. Specifically, a non-woven fabric composed of 50% by mass of a rayon fiber, 30% by mass of a polyethylene terephthalate (PET) fiber, and 20% by mass of a polyolefin fiber (mixed fiber of a PP fiber and a PE fiber) was impregnated with the liquid agent having mass 400% of the mass of the non-woven fabric, thereby obtaining a wiper of Example 1.

Furthermore, a wiper for preparing a control sample of Example 1 was obtained by the same method except that sterile purified water was used instead of the above liquid agent.

[Various Evaluations]

<Evaluation of Antiviral Activity of Wiper Immediately after Preparation>

Immediately after being prepared, the wiper of Example 1 was used for a wiping test with reference to “Method for testing antibacterial effect of wet wipes (revised on Nov. 16, 2015)” established by the Japan Hygiene products Industry Association.

Specifically, the test protocol is as follows. Based on “Method for testing antibacterial effect of wet wipes (revised on Nov. 16, 2015)” established by the Japan Hygiene products Industry Association, a test carrier (stainless steel plate) was inoculated with a viral solution obtained by culturing feline calicivirus (ATCC VR-782) in a Minimum Essential Media (MEM) and dried. Then, the carrier was wiped with a weight wrapped with the wiper of Example 1. Thereafter, the test carrier was put in 20 mL of an SCDLP medium, and the residual virus was washed off the test carrier, thereby obtaining a viral solution for preparing a sample. In addition, a viral solution for preparing a control sample was obtained in the same manner as described above, except that the wiper for preparing a control sample of Example 1 was used instead of the wiper of Example 1. Subsequently, CRFK cells cultured on an agar medium were inoculated with 0.1 mL of the viral solution for preparing a sample, and the solution was left to be adsorbed onto the cells at 37° C. for 1 hour. Then, the test solution on the CRFK cells was drained, agar media were layered, and the cells were cultured for 2 to 3 days. After culturing, the number of plaques formed on the agar medium was counted, and the infectious titer was calculated and adopted as “infectious titer of a wiper”. Furthermore, the infectious titer was also calculated for a sample prepared in the same manner as described above except that the viral solution for preparing a control sample was used instead of the viral solution for preparing a sample, and the calculated titer was adopted as “infectious titer of a control wiper”. The results are shown in Table 1.

Value of antiviral activity=A−B Equation 2

A in the above equation represents a common logarithm of the infectious titer of a control wiper.

B in the above equation represents a common logarithm of the infectious titer of a wiper.

(Evaluation Standard)

“AA”: The value of antiviral activity is equal to or higher than 4.0.

“A”: The value of antiviral activity is equal to or higher than 3.5 and less than 4.0.

“B”: The value of antiviral activity is equal to or higher than 3.0 and less than 3.3.

“C”: The value of antiviral activity is equal to or higher than 2.5 and less than 3.0.

“D”: The value of antiviral activity is less than 2.5.

<Evaluation of Wiper after 6 Months of Storage>

Immediately after being prepared, the wiper of Example 1 and the wiper for preparing a control sample of Example 1 were put in different airtight containers and stored for 6 months in a dark place.

(Quantification of Content of Active Components and pH Evaluation)

The liquid was squeezed from the wiper of Example 1 after the 6 months of storage, and the content of the active component in the liquid (content of the active component with respect to the total mass of the liquid (% by mass)) was quantified by high performance liquid chromatography (HPLC). In addition, the pH of the above liquid was measured by the method described above. The results are shown in Table 1. “Active component” mentioned herein means the compound having a phenolic hydroxyl group (including a phenoxide anion derivative formed by the dissociation of a hydroxyl group of the phenolic hydroxyl group).

(Evaluation of Antiviral Activity of Wiper after 6 Months of Storage)

By using the wiper of Example 1 and the wiper for preparing a control sample of Example 1 after 6 months of storage, the antiviral activity was evaluated by the same method as that in <Evaluation of antiviral activity of wiper immediately after preparation> described above. The results are shown in Table 1.

### Preparation of wipers of Examples 2 to 22 and Comparative Examples 1 to 3

Wipers were prepared by the same method as that in Example 1 according to the composition and mixing ratio shown in Table 1, and evaluated in the same manner as in Example 1.

Table 1 is shown below.

The abbreviations used in Table 1 stand for the following.

“PET” polyethylene terephthalate

“PP” polypropylene

“PE” polyethylene

“VN” vinylon

“NY” nylon

“Surfactant” used in Table 1 is polysorbate 20 (polyoxyethylene sorbitan monolaurate, “EMASOL L-120V” manufactured by Kao Corporation).

“Chelating agent” used in Table 1 is disodium ethylenediaminetetraacetate.

Furthermore, in Table 1, “Content of active component (% by mass)” in the column of “Formulation of liquid agent” means the content of the active component with respect to the total mass of the liquid agent. In Examples 2 to 9, Examples 11 to 22, and Comparative Examples 1 to 3, the active component is a compound having a phenolic hydroxyl group (including a phenoxide anion derivative formed by the dissociation of a hydrogen atom from the phenolic hydroxyl group). Furthermore, in Example 10, the active component is a compound having a mercapto group (including an anion derivative formed by the dissociation of a hydrogen atom from the mercapto group).

In Table 1, foe method for measuring “pKa of active component” in the column of “Formulation of liquid agent” is as described above. In a case where the compound X as an active component has a plurality of pKa values (that is, in a case where the compound X is an acid which undergoes multi-stage dissociation), at least one of the plurality of pKa values may be 7.0 to 15.0. In Table 1, one of the pKa values within a range of 7.0 to 15.0 is listed. In Table 1, the pKa values in Examples 2 to 9, Examples 11 to 22, and Comparative Examples 1 to 3 correspond to pKa obtained in a case where a hydrogen atom is dissociated from a phenolic hydroxyl group in the compound X which is an active component. Furthermore, the pKa value in Example 10 corresponds to pKa obtained in a case where a hydrogen atom is dissociated from a mercapto group in the compound X which is an active component.

“Fiber composition” in the column of “Base fabric (non-woven fabric)” in Table 1 means the content of each type of fiber with respect to the total mass of fibers. “Content of cellulosic fiber (% by mass)” in the column of “Base fabric (non-woven fabric)” in fable 1 means the content of the cellulosic fiber (% by mass) with respect to the total mass of fibers.

In Table 1, “Content of active component (% by mass)” in the column of “Evaluation” means the content of the active component with respect to the total mass of the liquid.

In Table 1, the weight-average molecular weight (Mw: expressed in terms of polystyrene) of the active component used in Example 5 is 5,000.

In Table 1, “Balance” in the column of “Solvent” means a value obtained by subtracting the content (% by mass) of an active component, a surfactant, a chelating agent, and a pH adjuster (sodium hydroxide) from the total mass of the liquid agent.

TABLE 1

| | Wiper (immediately after preparation) | | | | | | | | | | | |
|---|---|---|---|---|---|---|---|---|---|---|---|---|
| | | | | | | | | | | | Base fabric (non-woven fabric) | |
| | Formulation of liquid agent | | | | | | | | | | | Content of |
| | Active component | | | Solvent | | | | | Chelat- | | | cellulosic |
| | | | Content | Content | Type and content ratio | | | Surfactant | ing agent | | | fiber |
| | | | (% by | (% by | (mass ratio) | | | (% | (% by | | Fiber | (% by |
| | Type | pKa | mass) | mass) | Ethanol | Isopropanol | Water | by mass) | mass) | pH | composition | mass) |
| Example 1 | 4-Hydroxybenzoic acid | 9.9 | 0.20 | Balance | 73 | 3 | 24 | | 0.05 | 11.5 | Rayon fiber: | 50 |
| | | | | | | | | | | | 50% by mass | |
| | | | | | | | | | | | PET fiber: | |
| | | | | | | | | | | | 30% by mass | |
| | | | | | | | | | | | PP fiber/PE | |
| | | | | | | | | | | | fiber: 20% by | |
| | | | | | | | | | | | mass | |
| Example 2 | 4-Hydroxybenzoic acid | 9.9 | 0.20 | Balance | 73 | 3 | 24 | — | 0.05 | 11.5 | Rayon fiber: | 60 |
| | | | | | | | | | | | 60% by mass | |
| | | | | | | | | | | | PET fiber: 20% | |
| | | | | | | | | | | | by mass | |
| | | | | | | | | | | | PP fiber/ | |
| | | | | | | | | | | | PE fiber: | |
| | | | | | | | | | | | 20% by mass | |
| Example 3 | 4-Hydroxybenzoic acid | 9.9 | 0.20 | Balance | 73 | 3 | 24 | — | 0.05 | 11.5 | Rayon fiber: | 20 |
| | | | | | | | | | | | 20% by mass | |
| | | | | | | | | | | | PP fiber/ | |
| | | | | | | | | | | | PE fiber: | |
| | | | | | | | | | | | 80% by mass | |
| Example 4 | 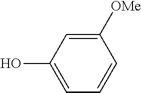 | 9.8 | 0.20 | Balance | 73 | 3 | 24 | — | 0.05 | 11.5 | PP fiber: 100% by mass | 0 |
| Example 5 | 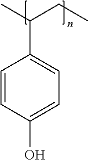 | 9.7 | 0.20 | Balance | 73 | 3 | 24 | — | 0.05 | 11.5 | PP fiber 100% by mass | 0 |
| Example 6 | 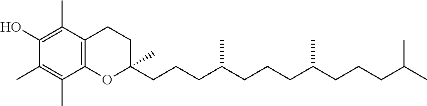 [SMILES: Cc1c(C)c2c(c(C)c1O)CC[C@@](C)(CCC[C@H](C)CCC[C@H](C)CCCC(C)C)O2] | 9.9 | 0.20 | Balance | 73 | 3 | 24 | — | 0.05 | 11.5 | PP fiber: 100% by mass | 0 |
| Example 7 | 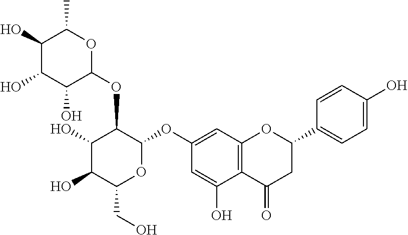 [SMILES: C[C@@H]1OC(O[C@H]2[C@H](Oc3cc(O)c4c(c3)O[C@H](c3ccc(O)cc3)CC4=O)O[C@H](CO)[C@@H](O)[C@@H]2O)[C@H](O)[C@H](O)[C@H]1O] | 9.3 | 0.20 | Balance | 73 | 3 | 24 | — | 0.05 | 11.5 | PP fiber: 100% by mass | 0 |
| Example 8 | 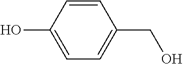 | 9.7 | 0.20 | Balance | 73 | 3 | 24 | — | 0.05 | 11.5 | PP fiber: 100% by mass | 0 |
| Example 9 | 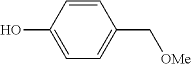 | 9.7 | 0.20 | Balance | 73 | 3 | 24 | — | 0.05 | 11.5 | PP fiber: 100% by mass | 0 |
| Example 10 | 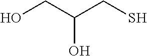 | 14.0 | 0.20 | Balance | 73 | 3 | 24 | — | 0.05 | 11.5 | PP fiber: 100% by mass | 0 |
| Example 11 | 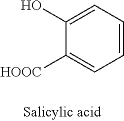 | 13.0 | 0.20 | Balance | 73 | 3 | 24 | — | 0.05 | 11.5 | PP fiber: 100% by mass | 0 |
| Example 12 | 4-Hydroxybenzoic | 9.9 | 0.20 | Balance | 73 | 3 | 24 | — | 0.05 | 11.5 | PP fiber: | 0 |
| | acid | | | | | | | | | | 100% by mass | |
| Example 13 | 4-Hydroxybenzoic | 9.9 | 0.20 | Balance | 73 | 3 | 24 | — | 0.05 | 11.5 | PE fiber: | 0 |
| | acid | | | | | | | | | | 100% by mass | |
| Example 14 | 4-Hydroxybenzoic | 9.9 | 0.20 | Balance | 73 | 3 | 24 | — | 005 | 11.5 | PP fiber/ | 0 |
| | acid | | | | | | | | | | PE fiber: | |
| | | | | | | | | | | | 100% | |
| | | | | | | | | | | | by mass | |
| Example 15 | 4-Hydroxybenzoic | 9.9 | 0.20 | Balance | 73 | 3 | 24 | — | 0.05 | 11.5 | PET fiber: | 0 |
| | acid | | | | | | | | | | 30% by mass | |
| | | | | | | | | | | | VN fiber: | |
| | | | | | | | | | | | 70% by mass | |
| Example 16 | 4-Hydroxybenzoic | 9.9 | 0.20 | Balance | 73 | 3 | 24 | — | 0.05 | 11.5 | PET fiber/NY | 0 |
| | acid | | | | | | | | | | fiber: | |
| | | | | | | | | | | | 100% by mass | |
| Example 17 | 4-Hydroxybenzoic | 9.9 | 0.20 | Balance | 73 | 3 | 24 | — | 0.05 | 13.6 | Rayon fiber: | 50 |
| | acid | | | | | | | | | | 50% by mass | |
| | | | | | | | | | | | PET fiber: | |
| | | | | | | | | | | | 30% by mass | |
| | | | | | | | | | | | PP fiber/ | |
| | | | | | | | | | | | PE fiber: | |
| | | | | | | | | | | | 20% by mass | |
| Example 18 | 4-Hydroxybenzoic | 9.9 | 0.67 | Balance | 73 | 3 | 24 | — | 0.05 | 13.6 | Rayon fiber: | 50 |
| | acid | | | | | | | | | | 50% by mass | |
| | | | | | | | | | | | PET fiber: | |
| | | | | | | | | | | | 30% by mass | |
| | | | | | | | | | | | PP fiber/ | |
| | | | | | | | | | | | PE fiber: | |
| | | | | | | | | | | | 20% by mass | |
| Example 19 | 4-Hydroxybenzoic | 9.9 | 0.20 | Balance | 73 | 3 | 24 | 0.30 | 0.05 | 11.5 | PET fiber: | 0 |
| | acid | | | | | | | | | | 100% by mass | |
| Example 20 | 4-Hydroxybenzoic | 9.9 | 0.20 | Balance | 50 | 3 | 47 | — | 0.05 | 11.5 | PP fiber: | 0 |
| | acid | | | | | | | | | | 100% by mass | |
| Example 21 | 4-Hydroxybenzoic | 9.9 | 0.20 | Balance | 50 | 0 | 50 | — | 0.05 | 11.5 | PP fiber: | 0 |
| | acid | | | | | | | | | | 100% by mass | |
| Example 22 | 4-Hydroxybenzoic | 9.9 | 0.20 | Balance | 50 | 3 | 47 | — | — | 11.5 | PP fiber: | 0 |
| | acid | | | | | | | | | | 100% by mass | |
| Compara- | 4-Hydroxybenzoic | 9.9 | 0.20 | Balance | 73 | 3 | 24 | — | 0.05 | 11.5 | Cotton fiber: | 100 |
| tive | acid | | | | | | | | | | 50% by mass | |
| Example 1 | | | | | | | | | | | Rayon fiber: | |
| | | | | | | | | | | | 50% by mass | |
| Compara- | 4-Hydroxybenzoic | 9.9 | 0.20 | Balance | 73 | 3 | 24 | — | 0.05 | 11.5 | Rayon fiber: | 80 |
| tive | acid | | | | | | | | | | 80% by mass | |
| Example 2 | | | | | | | | | | | PET fiber: | |
| | | | | | | | | | | | 20% by mass | |
| Compara- | 4-Hydroxybenzoic | 9.9 | 0.20 | Balance | 30 | 3 | 67 | — | 0.05 | 11.5 | Rayon fiber: | 50 |
| tive | acid | | | | | | | | | | 50% by mass | |
| Example 3 | | | | | | | | | | | PET fiber: | |
| | | | | | | | | | | | 30% by mass | |
| | | | | | | | | | | | PP fiber/ | |
| | | | | | | | | | | | PE fiber: | |
| | | | | | | | | | | | 20% by mass | |

| | Wiper performance evaluation | | | |
|---|---|---|---|---|
| | Immediately | After 6 months of storage | | |
| | after | Content of | | |
| | preparation | active | | |
| | Ativiral | component | | Antiviral |
| | activity | (% by mass) | pH | activity |
| Example 1 | A | 0.13 | 9.6 | C |
| Example 2 | A | 0.11 | 9.8 | C |
| Example 3 | A | 0.17 | 10.1 | B |
| Example 4 | A | 0.20 | 11.5 | A |
| Example 5 | A | 0.20 | 11.5 | A |
| Example 6 | A | 0.20 | 11.5 | A |
| Example 7 | A | 0.20 | 11.5 | A |
| Example 8 | A | 0.20 | 11.5 | A |
| Example 9 | A | 0.20 | 11.5 | A |
| Example 10 | C | 0.20 | 11.5 | C |
| Example 11 | C | 0.20 | 11.5 | C |
| Example 12 | A | 0.20 | 11.5 | A |
| Example 13 | A | 0.20 | 11.5 | A |
| Example 14 | A | 0.20 | 11.5 | A |
| Example 15 | A | 0.20 | 11.3 | A |
| Example 16 | A | 0.20 | 10.6 | B |
| Example 17 | AA | 0.20 | 11.5 | A |
| Example 18 | AA | 0.20 | 11.5 | A |
| Example 19 | AA | 0.20 | 11.5 | AA |
| Example 20 | B | 0.20 | 11.5 | B |
| Example 21 | C | 0.20 | 11.5 | C |
| Example 22 | C | 0.20 | 11.5 | C |
| Comparative | A | 0.09 | 7.8 | D |
| Example 1 | | | | |
| Comparative | A | 0.09 | 8.2 | D |
| Example 2 | | | | |
| Comparative | D | 0.16 | 9.6 | D |
| Example 3 | | | | |

From the results in Table 1, it has been revealed that the wipers of examples have excellent antiviral activity and excellent storage stability.

Furthermore, from the comparison of Examples 4 to 12, it has been confirmed that in a case where the compound X which is an active component is a compound having a phenolic hydroxyl group, the antiviral properties are further improved.

In addition, from the comparison of Examples 1 to 3 and Examples 12 to 14, it has been confirmed that in a case where the content of the cellulosic fiber is equal to or lower than 30% by mass with respect to the total mass of fibers (preferably in a case where the fibers substantially do not contain the cellulosic fiber), the storage stability is further improved.

Furthermore, from the comparison of Examples 12 to IS and Example 16, it has been confirmed that in a case where the fibers constituting the base fabric are synthetic fibers selected from the group consisting of a polyolefin fiber, a polyester fiber, and a vinylon fiber, the storage stability is further improved. Particularly, from the comparison of Examples 12 to 14 and Example 15, it has been confirmed that in a case where the fibers constituting the base fabric are synthetic fibers selected from the group consisting of a polyolefin fiber and a polyester fiber, the pH of the liquid agent in the wiper is hardly reduced, and the storage stability is further improved.

From the comparison between Example 20 and Example 22, it has been confirmed that in a case where the liquid agent contains a chelating agent, the antiviral activity of the wiper is further improved.

From the comparison between Example 13 and Example 19, it has been confirmed that in a case where the liquid agent contains a surfactant, the antiviral activity of the wiper is further improved.

From the comparison of Example 12, Example 20, and Example 21, it has been confirmed that in a case where the liquid agent contains an alcohol having two or less carbon atoms and an alcohol having three or more carbon atoms, the antiviral activity of the wiper is further improved. In addition, from the comparison between Example 12 and Example 20, it has been confirmed that in a case where the content of an alcohol in the liquid agent is equal to or higher than 60% by mass with respect to the total mass of the solvent, the antiviral activity of the wiper is further improved.

What is claimed is:

1. An antiviral wiper comprising:
a base fabric; and
a liquid agent with which the base fabric is impregnated,
wherein a content of a cellulosic fiber in the base fabric is equal to or lower than 70% by mass with respect to a total mass of fibers constituting the base fabric,
the liquid agent is alkaline and contains a compound X having a pKa of 7.0 to 15.0 and a solvent containing at least an alcohol, and
a content of the alcohol is 40% to 100% by mass with respect to a total mass of the solvent.

2. The antiviral wiper according to claim 1,
wherein the compound X is a compound having a phenolic hydroxyl group.

3. The antiviral wiper according to claim 1,
wherein the content of the cellulosic fiber is equal to or lower than 30% by mass with respect to the total mass of the fibers.

4. The antiviral wiper according to claim 1,
wherein the base fabric substantially does not contain the cellulosic fiber.

5. The antiviral wiper according to claim 1,
wherein the base fabric contains one or more kinds of synthetic fibers selected from the group consisting of a polyolefin fiber, a polyester fiber, a vinylon fiber, and a nylon fiber.

6. The antiviral wiper according to claim 1,
wherein the fibers constituting the base fabric are synthetic fibers selected from the group consisting of a polyolefin fiber, a polyester fiber, and a vinylon fiber.

7. The antiviral wiper according to claim 1,
wherein the fibers constituting the base fabric are synthetic fibers selected from the group consisting of a polyolefin fiber and a polyester fiber.

8. The antiviral wiper according to claim 5,
wherein a content of the synthetic fibers is equal to or higher than 95% by mass with respect to the total mass of the fibers.

9. The antiviral wiper according to claim 1,
wherein the alcohol includes an alcohol having two or less carbon atoms and an alcohol having three or more carbon atoms.

10. The antiviral wiper according to claim 9,
wherein the alcohol having two or less carbon atoms includes ethanol, and the alcohol having three or more carbon atoms includes isopropanol.

11. The antiviral wiper according to claim 1,
wherein the liquid agent further contains a surfactant.

12. The antiviral wiper according to claim 1,
wherein the liquid agent further contains a chelating agent.

13. The antiviral wiper according to claim 2,
wherein the content of the cellulosic fiber is equal to or lower than 30% by mass with respect to the total mass of the fibers.

14. The antiviral wiper according to claim 2,
wherein the base fabric substantially does not contain the cellulosic fiber.

15. The antiviral wiper according to claim 2,
wherein the base fabric contains one or more kinds of synthetic fibers selected from the group consisting of a polyolefin fiber, a polyester fiber, a vinylon fiber, and a nylon fiber.

16. The antiviral wiper according to claim 2,
wherein the fibers constituting the base fabric are synthetic fibers selected from the group consisting of a polyolefin fiber, a polyester fiber, and a vinylon fiber.

17. The antiviral wiper according to claim 2,
wherein the fibers constituting the base fabric are synthetic fibers selected from the group consisting of a polyolefin fiber and a polyester fiber.

18. The antiviral wiper according to claim 15,
wherein a content of the synthetic fibers is equal to or higher than 95% by mass with respect to the total mass of the fibers.

19. The antiviral wiper according to claim 2,
wherein the alcohol includes an alcohol having two or less carbon atoms and an alcohol having three or more carbon atoms.

20. The antiviral wiper according to claim 19,
wherein the alcohol having two or less carbon atoms includes ethanol, and the alcohol having three or mote carbon atoms includes isopropanol.
